(19) United States
(12) Patent Application Publication
(10) Pub. No.: US 2002/0065919 A1
(43) Pub. Date: May 30, 2002

(54) Peer-to-peer caching network for user data

(76) Inventors: Ian Lance Taylor, San Francisco, CA (US); David Henkel-Wallace, Palo Alto, CA (US); Jason Thorpe, San Francisco, CA (US)

Correspondence Address: OPPENHEIMER WOLFF & DONNELLY, P. O. BOX 10356, PALO ALTO, CA, 94303, US

(21) Appl. No.: 09/728,549

(22) Filed: Nov. 30, 2000

(51) Int. Cl. G06F 15/173

(52) U.S. Cl. 709/226

(57) ABSTRACT

A network topology is described which supports the peer-to-peer storage of user-generated applications data at multiple nodes in a virtual private network. In one embodiment, the network supports Application Service Provider applications.

In one embodiment, user data is redundantly stored at multiple locations. If a user logs-in to a location which does not store the user's data, the network automatically causes that data to be downloaded from another node.

In one embodiment, data is stored in a hierarchical file structure which allows the isolation of data on an application, user or enterprise basis, with access to data being governed by mechanisms which limit the ability of a user or application to gain access to data generated by other users or other applications.

In one embodiment, data is synchronized between nodes whenever a user changes data at one node, by causing the data to be downloaded from that node to all other nodes holding the user's data.

In one embodiment, the network includes means to insure that certain critical fields contain the same value across nodes.

### BACKGROUND

The invention(s) described herein relate to an improved methodology for providing ASP (“Application Service Provider”)-type services to end users.

ASP operations are well-known in the art. Examples of ASPs include AtlanticASP.com, Nubase Technologies and Pelion Systems, Inc..

In general, ASPs operate by providing users access to programs over the Internet. Examples of such programs include email programs, databases, calendars and spreadsheets. A user accesses the programs by logging-in to the ASP's web site and entering a user name and password. The application will then run on a computer located at the ASP's site. The user uses his or her own computer to type in information and click on icons. Those inputs are transmitted to the server located at the ASP site, and are used as inputs to the application. The user's data are stored on the ASP's servers, and are provided to the user when the user logs on.

ASPs market their services by claiming that use of an ASP application will be as convenient as use of an application running on the user's personal computer, and will provide certain advantages. The advantages include access to the latest versions of the applications, without the need to download (or purchase) new versions, the ability to run sophisticated programs without the necessity for the user to purchase sophisticated hardware, the ability to pay for applications on a per-use basis, in preference to paying an up-front licensing fee for an application which is purchased and stored on a user's personal computer, the ability to access the application and data using different user computers, which may be located at different locations, and permanent off-site storage of the user's data, such that the data will not be lost even if the user's computer breaks down or is stolen.

Although the ASP model provides certain significant advantages to users, it also suffers from certain disadvantages. The most significant of these is the latency which may be introduced in the use of the applications. This latency may result from a number of causes, including communications delays (e.g., Internet traffic delays), and high usage demand on the ASP's servers, which may cause a particular user's transactions to be delayed pending completion of transactions for other users.

Latency issues are serious problems for ASPs, since users are familiar with applications which run on the user's personal computer and provide immediate feedback. Even if the ASP server is much faster and more powerful than a user's PC, if communications delays and traffic bottlenecks lead to a perceptible slowdown in the application's response time, a user may decide to continue to use stand-alone PC applications rather than undergo the delays inherent in the ASP experience.

Various methods have been devised for minimizing Internet traffic latency. One such method is the use of a caching network, such as the network supplied by Akamai Corporation. A caching network attempts to push content to the “edge” of the Internet, by storing copies of the content at multiple locations, each location chosen so that it minimizes the number of transmission jumps, or “hops” required for a user to access the content. Copies of the content may, for example, be stored at servers located at Internet Service Providers, or “ISPs.” A caching network may, for example, be used by an on-line publication. Rather than have all users log-on to the publication's web site, users are directed to the cache located nearest to the user. Each cache contains a current version of the publication's content, so that all users obtain access to the same content, regardless of which cache they access. Caches are kept up-to-date by periodic downloads of content from a central site.

The caching methodology reduces Internet latency for various types of web sites. Web sites seeking to deliver content to the user may be particularly suited for this methodology.

Caching works best, however, for applications in which the transmission of data is one way: from the provider to the user. Caching does not work well for applications in which the user transmits data back to the provider. A cache ordinarily constitutes a copy of the data provided by the central application, with no ability to store data entered by the user. Even if a cache was designed with the ability to store user data, those data would be isolated at the cache location itself, since the user is communicating directly with that location rather than with a central site. If the user were to log-on a second time, and be routed to a second cache site, the user would have no means of accessing the user data. This might happen, for example, if a user logs on from a different location, or if the caching network routes the user to a different cache in order to even-out traffic flow.

ASP applications require that the user be able to store and access unique data. They are therefore unsuited for a traditional caching network. The invention(s) described below provide the benefits of a caching network, but for applications which require storage of unique and alterable user data, including ASP applications.

### BRIEF SUMMARY

The inventive network described below is designed to allow for redundant storage of user data at numerous locations across a network such as the Internet. It therefore provides for the benefits of caching, since user data may be accessed from multiple locations, including locations which may be located in proximity to the users. In contrast to a pure caching architecture, however, the inventive network includes mechanisms for synchronizing user data across locations, so that changes made by a user at one location are propagated to other locations. This occurs on a peer-to-peer basis, without the need for storing the data at a central site.

The inventive network includes a network operations center, routers and leaves. User data is stored at database servers located at the leaves. User data is accessed using applications servers also located at the leaves. Data is strictly segregated using a variety of techniques, including database partitioning.

User data may be stored at more than one leaf. User log-ins may be routed to the nearest leaf, or to a leaf with relatively low traffic. User updates made at one leaf are transmitted to other leaves when network traffic permits. If a user logs-in to a leaf which does not store a copy of the user's data, that data is downloaded from another leaf on a high-priority basis.

### BRIEF DESCRIPTION OF THE DRAWINGS

FIG. 1 is a block diagram illustrating an overall network.

FIG. 2 shows a packet-based organization of data used for transmission across a VPN.

FIG. 3 shows steps taken in transmitting data through the network across a VPN.

FIG. 4 shows an organization of data into database partitions.

FIG. 5 is a block diagram illustrating certain internal details of a network leaf.

FIG. 6 shows certain details of processes running on application servers.

FIG. 7 shows a hierarchical organization of data into directories and subdirectories.

FIG. 8 shows a prior art database schema.

FIG. 9 shows a user table.

FIG. 10 shows certain details of operation of database servers.

FIG. 11 is a flowchart showing steps involved in direction of a user to a network leaf.

FIG. 12 is a flowchart showing steps involved in user interaction with an application at a leaf.

FIG. 13 is a flowchart showing steps involved in downloading of user data from one leaf to another leaf when the user data is not initially present at the leaf to which the user logged-in.

FIG. 14 is a flowchart showing the process of communicating updates of user data from one leaf to other leaves.

FIG. 15 is a flowchart showing the serialization process.

FIG. 16 shows a global user table.

FIG. 17 is a flowchart showing steps taken when a user logs-in to a network which includes a global user table and global passwords.

FIG. 18 is a flowchart showing steps taken when a user logs-in to a network which includes a global user table but no global passwords.

FIG. 19 shows a user-centric database partition.

FIG. 20 shows an organization of user-centric database partitions.

FIG. 21 shows a user-centric hierarchical organization of data into directories and subdirectories.

FIG. 22 is a flowchart showing steps involved in user interaction with applications using a user-centric network model.

FIG. 23 shows a user-centric hierarchical organization of data into directories and subdirectories, including enterprise-related partitions.

FIG. 24 shows a network including enterprise nodes.

### DETAILED DESCRIPTION

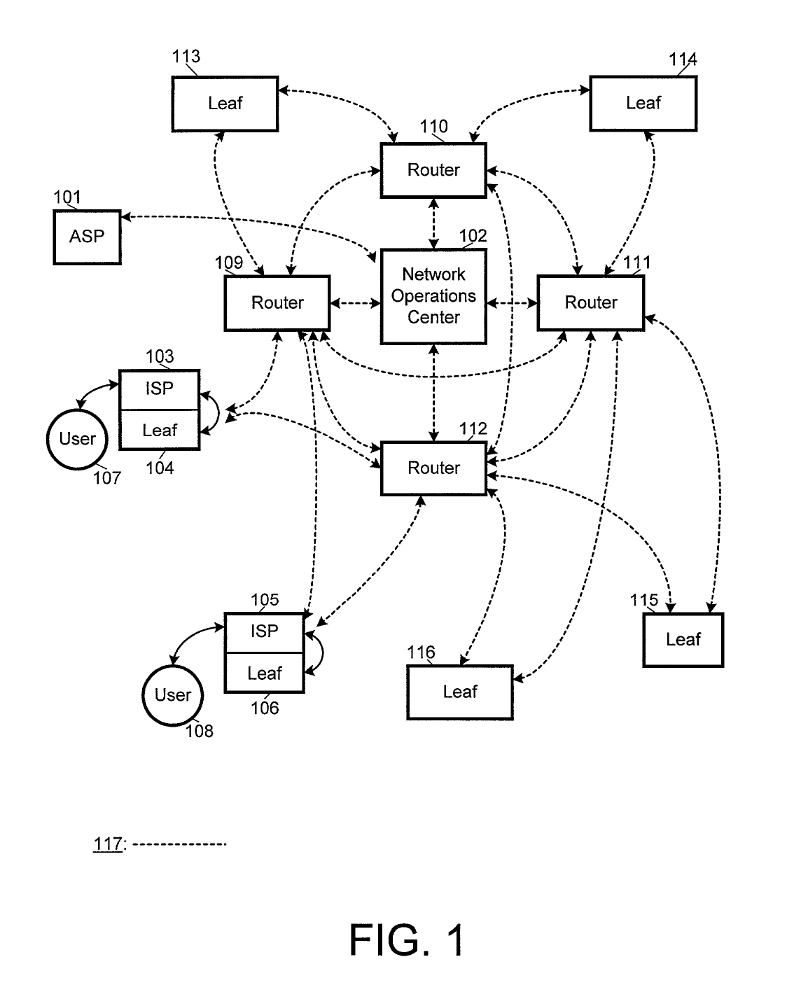

FIG. 1 illustrates the topology of the inventive network in simplified form. This Figure shows Application Service Provider (“ASP”) 101, Network Operations Center (“NOC”) 102, Routers 109, 110, 111 and 112, Internet Service Providers (“ISPs”) 103 and 105, Leaves 104, 106, 113, 114, 115 and 116, and Users 107 and 108. Communications paths between nodes are indicated by lines and arrows. These paths include Virtual Private Network (“VPN”) 117, which is designated by dashed lines.

Network Operations Center 102 is the central administrative site for the entire network. Network Operations Center 102 supports a publishing interface used by ASPs to transmit programs and program updates to network leaves. An ASP may use this interface to update applications or database tables. These updates are transmitted to all leaves, with the switchover to the new version occurring at the same time in all leaves. Such updates will ordinarily occur at low-usage periods (e.g., the middle of the night). If users are logged-on to the application at the time the update is to take place, various approaches may be used, including requiring all users to temporarily log-off, or delaying the update at a particular leaf until users at that leaf have logged off.

Network Operations Center 102 also aggregates billing and usage information, and transmits that information to ASPs. In one embodiment, billing is handled by calculating “CPU equivalents,” which record the amount of usage of the application at the various network sites. In one embodiment, each leaf maintains a record of CPU equivalents, broken down by application. These records are downloaded to Network Operations Center 102 at regular intervals. Network Operations Center 102 then uses the downloaded information to prepare bills for each of the ASPs.

Network Operations Center 102 may also include a test network for testing applications in a simulated network environment. This test network allows ASPs to test new applications, or updates to existing applications, in an environment designed to simulate the overall network, and therefore allows for the discovery of problems or bugs before new applications or updates are provided to users.

Routers 109, 110, 111 and 112 facilitate communications across the network, including accepting communications from source sites and forwarding them to destination sites using a VPN system described at greater length below. As should be understood, the topology shown is relatively simple, and an actual network may have many more routers (or may have fewer routers). In another embodiment, the routers may be eliminated, so that leaves communicate directly with each other and with Network Operations Center 102.

Leaves 104, 106, 113, 114, 115 and 116 store user data and run user applications. The operation of theses leaves is further described below. An actual network may have more or fewer leaves than the six illustrated.

As is illustrated, Leaves 104 and 106 are colocated at ISPs 103 and 105. As a result of this colocation, communication between a user logged in to these ISPs and the leaves is simplified, requiring only a single communications link, or “hop.” This reduces the latency imposed by such communications and speeds-up the transmission of information in both directions. Leaves may also be located at colocation centers (e.g., Exodus); network aggregation points (e.g., phone companies, DSL providers), wireless base stations, or any other suitable location.

For the sake of clarity, Leaves 113, 114, 115 and 116 are illustrated with no accompanying ISPs. It should be understood that these leaves might be located at ISPs, or at any other suitable site.

Leaves, routers and Network Operations Center 102 communicate using VPN 117, which is illustrated in FIG. 1 using dashed lines. Note that each of these nodes is connected to the Internet, and VPN communications proceed over the Internet, using protocols which are described below. Thus, although VPN 117 is shown as directly connecting various nodes (e.g., Router 109 is directly connected to Router 110), in fact these are not dedicated, hardwired connections, but communications over the Internet, which may involve transmission through a number of intermediate points (“hops”). The connections shown in FIG. 1 represent paths for communication which are valid using VPN 117, but are not intended to represent actual hardwired connections.

ASP 101 communicates directly with Network Operations Center 102. In one embodiment, these communications use VPN 117. In another embodiment, ASP 101 is not present on VPN 117, but instead communicates with Network Operations Center 102 using a different method, e.g., a standard Internet connection, or physical transmission of information, such as hand-delivered disks or tapes.

Network Operations Center 102 communicates directly with ASP 101, and also with Routers 109, 110, 111 and 112. In the embodiment shown in FIG. 1, Network Operations Center 102 does not communicate directly with any of the leaves, and any such communications must take place through one of the routers. In an alternate embodiment which does not include routers, Network Operations Center 102 may communicate directly with both leaves and routers. In yet another embodiment, routers are not present, and Network Operations Center 102 communicates directly with the leaves.

Routers 109, 110, 111 and 112 are fully meshed, so that each router may communicate directly with each other router. Each router is also directly connected to Network Operations Center 102.

Routers 109-112 are also directly connected to one or more leaves. In the simplified topology shown, each router is connected to between two and four leaves. In one embodiment of an actual network, each router may be connected to between three and five leaves. If the number of leaves in such a network increases beyond such a ratio, additional routers may be added.

Each leaf is directly connected to two routers. Communications between leaves must therefore be routed through at least one router (if both leaves are connected to the same router), and often will require routing through two routers.

In general, a leaf only requires a connection to a single router in order to communicate with other nodes on the network. The connection between each leaf and two routers is intended to provide redundancy in the event that a particular router becomes unavailable. This requirement may also be used to balance the traffic load among routers by, for example, preferentially choosing the least busy router for communications. In another, somewhat simpler embodiment, each leaf may be connected to only one router. In a more complex embodiment, each leaf may be connected to more than two routers.

Users 107 and 108 have an existing relationship with ISPs 103 and 105, respectively, and communicate directly with those ISPs when the users log-on to the Internet. The details of those communications are not germane to the present invention, and are well-known to those of skill in the art.

As is illustrated, there are no direct connections between Users 107 and 108 and Leaves 104 and 106. Communications between User 107 and Leaf 104, for example, must take place through ISP 103. As is noted above, because Leaf 104 is colocated at ISP 103, such communications require only a single hop, and therefore introduce relatively low latency into the user-leaf communication.

In another embodiment, users may communicate directly with leaves, with no requirement of any intervening ISP.

In FIG. 1, NOC A2, Routers 109-112 and each of leaves are addressable on VPN 117. FIG. 1 therefore represents a single unitary network. In another embodiment, the overall system may include more than one network, each with its own VPN, such that nodes present on one network are not addressable or reachable from nodes present on the other network. In such an alternate embodiment, one network might run a first set of applications, and a second network might run a second set of applications, with users being automatically routed to the appropriate network upon log-in. NOC 102 might be present on both networks, but without allowing communications from one network to travel to the other network.

In a multiple network environment, nodes from different networks could be present at the same physical location (e.g., two nodes at the same ISP). Such an implementation could even be designed so that a single leaf includes elements from two different networks. For example, a leaf with multiple database servers could have some database servers present on one VPN and others present on a second VPN. The servers would be located at the same physical location, but each server would only know about (i.e., have the capability of addressing) other servers on the same VPN.

The VPN protocol used for communications over VPN 117 is based on a number of standard Internet protocols, including the following IETF RFCs: 2401 (overall IPSec security architecture), 2104 (HMAC RFC describing method for ensuring data integrity using a hashing algorithm), 2412 (Oakley key determination protocol), 2451 (“ESP CBC Cypher Algorithms”), 2406 (IP encapsulating security payload protocol), 2407 (ISAKMP (“Internet Security Association and Key Management Protocol”) DOI), 2408 (ISAKMP), 2409 (Internet Key Exchange (“IKE”) protocol) plus a draft standard: “A GSS-API Authentication Method for IKE.”

In one embodiment, VPN routing is performed in accordance with a standard routing protocol known as Routing Information Protocol Version 2 (“RiPv2”). Each gateway on the network (e.g., gateways present at the leaves, routers and NOC 102) runs a RiPv2 daemon. In a different embodiment, a different routing protocol may be used, such as BGP. A protocol other than RiPv2 may be particularly suited for larger networks, since the RiPv2 protocol may be insufficiently scalable for larger networks.

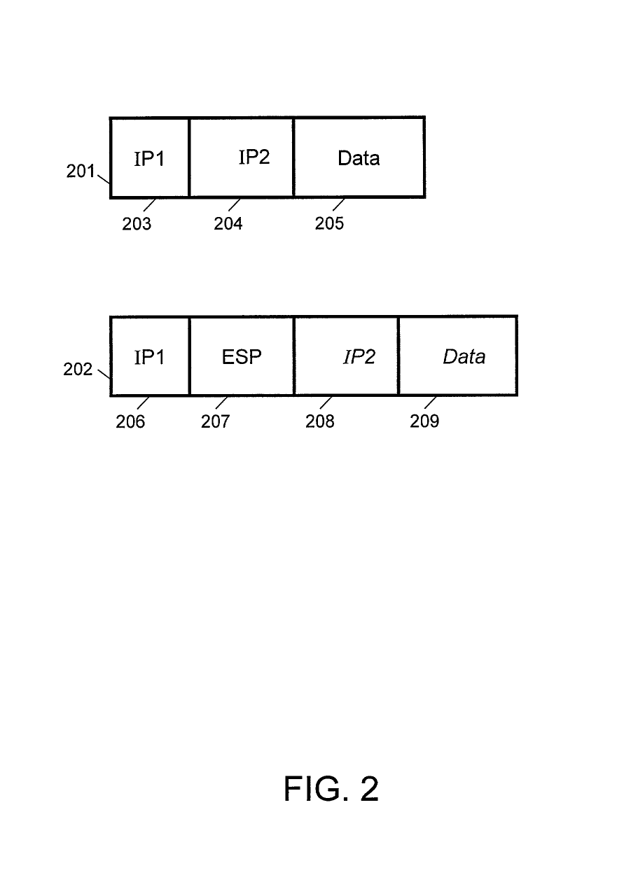

Communications over VPN 117 use V4-in-V4 tunnels. Packets encoded using this protocol have the form shown in FIG. 2, Packet 201:

IP1 (Field 203) includes two Internet addresses, one for the source gateway and one for the destination gateway. As is described further below, each leaf includes a gateway which communicates directly with the Internet. Each gateway has an address on the Internet. These addresses are publicly accessible, so that any party may communicate directly with a gateway using standard Internet protocols.

IP2 (Field 204) includes a private address for an addressable resource located within a leaf. As with IP1, IP2 actually consists of two addresses: a source address and a destination address. IP2 addresses are not publicly available on the Internet. Instead, these are private addresses, known only to the network. Typically, these may be addresses for database servers located at the source and destination leaves. Database servers are described more fully below.

In one embodiment, the IP2 addresses contain information sufficient to identify not only a particular DB server, but also the leaf at which the server is located. In one embodiment, this address may be made up of multiple fields, with one field indicating the leaf and another indicating the server. The leaf information may not be necessary for the routing of communications between one leaf and another (since such communications may be routed using the IP1 addresses), but IP2 addresses may also be used for other purposes, including identifying DB servers in user tables (described below), and, for these other purposes, having information identifying the leaf may be valuable.

The IP1 addresses may be known as “outside” addresses, whereas the IP2 addresses may be known as “inside” addresses.

The data portion of the V4-in-V4 tunneling protocol (Field 205) consists of information which is not directly relevant to addressing, such as TCP information.

The combination of the two IP addresses allows the network to use the Internet for communications between resources within leaves, without allowing third parties to directly access such resources. As should be understood, Internet addresses may be relatively easy for third parties to discover, since such addresses may be generally available. Thus, it should be assumed that third parties will have access to the outside addresses, but this only allows communication with each leaf's gateway. The inside addresses, which are necessary for sending messages to resources located within each leaf, are not published or otherwise made available to third parties.

A third party could, however, discover the inside addresses by intercepting and examining a packet transmitted from one leaf to another. In order to avoid this possibility, in one embodiment the network encrypts the inside addresses and the data portion of the packet, using the ESP transport mode protocol which is described in the IETF RFCs listed above. The ESP transport protocol defines a method of encrypting VPN communications. Encryption and decryption are handled by software running on the source and destination gateways. In another embodiment, ESP tunneling protocol may be used for this process.

When a V4-in-V4 packet is encrypted using ESP transport protocol, the resulting packet has the form shown in Packet 202:

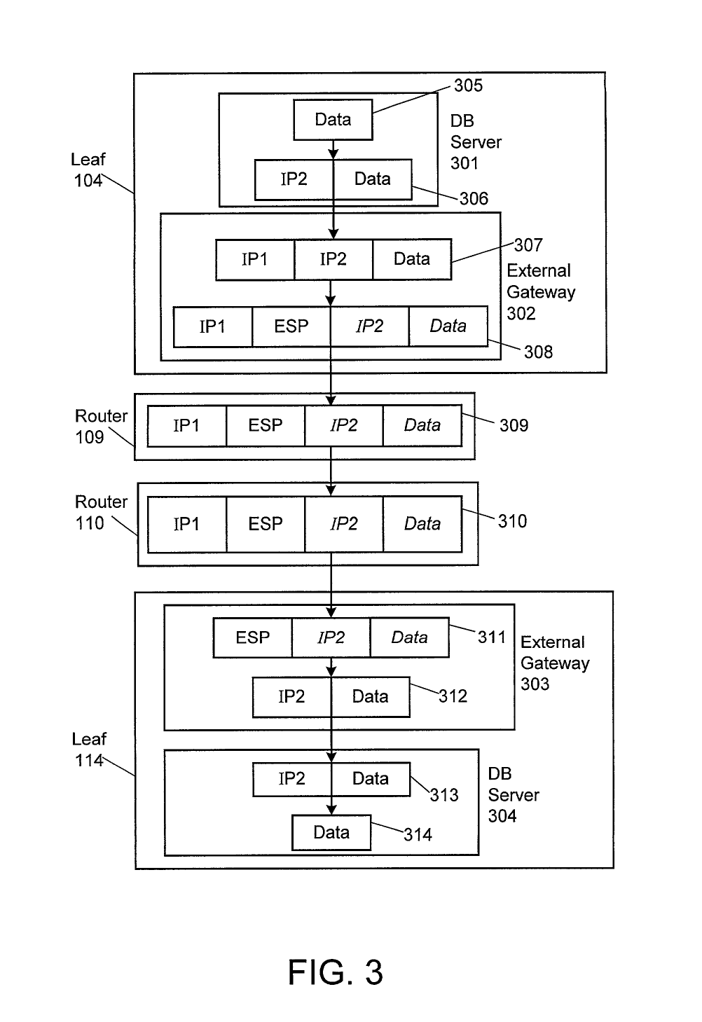

IP1 (Field 206) constitutes the outside source and destination addresses. ESP (Field 207) is a header which contains or references an index into a table of keys, which are used for encryption and decryption of messages. A subset of the table is located at each gateway in the network, such that each gateway contains those keys necessary for communication with other nodes to which that gateway is directly connected (e.g., Leaf 104 includes keys for communication with Routers 109 and 112, Router 109 includes keys for communications with Leaves 104 and 113, Routers 110 and 112 and NOC 102, Router 110 includes keys for communications with Leaves 113 and 114, Routers 109 and 111 and NOC 102, etc.). The use of these keys for communications purposes is further described below in connection with FIG. 3. In the current embodiment, the encryption algorithm used is symmetric, but in another embodiment an asymmetric algorithm could be used (e.g., PK).

The key referenced in the ESP header is used to encrypt the information to the right of the ESP header, including the IP2 (Field 208) and data segments (Field 209), the encrypted nature of which is indicated by italics.

When a DB server located within a leaf generates a communication targeted at a DB server located in a remote leaf, the process illustrated in FIG. 3 is used. FIG. 3 shows a simplified version of the network illustrated in FIG. 1, and is intended to illustrate the process whereby a transmission is sent from DB Server 301, located at Leaf 104, to DB Server 304, located at Leaf 114. In FIG. 3, arrows indicate either internal processes or communication from one device to another. The internal functioning of DB servers and external gateways is more fully described below.

A simplified version of Leaf 104 is shown at the top of FIG. 3, including DB Server 301 and External Gateway 302. DB Server 301 begins the process by generating data (Step 305). The data may, for example, include updated user information being sent to remote DB servers for synchronization purposes (see below for a description of this process).

DB Server 301 prepends field IP2 to the data field (Step 306), resulting in a packet with the following form:

IP2|Data

IP2 represents the VPN address of DB Server 304, which is the recipient for the transmission. IP2 also contains the VPN address of DB Server 301. The combination of these two addresses is sometimes referred to herein as the “inside” address.

The packet is then sent to External Gateway 302, a step illustrated by the arrow between DB Server 301 and External Gateway 302.

External Gateway 302 prepends field IP1 onto the packet (Step 307), resulting in a packet with the following form:

IP1|IP2|Data

IP1 represents the Internet address for External Gateway 303, which is the gateway for Leaf 114, the receiving leaf, and the Internet address for External Gateway 302. The combination of these two addresses is sometimes referred to herein as the “outside” address.

External Gateway 302 then adds the ESP header after the IP1 field, and encrypts the IP2 and Data fields, using a key referred to by the ESP header (Step 308). Note that this key is a key shared between Leaf 104 and Router 109. As before, the encryption is illustrated by italics. The resulting packet has the following form:

IP1|ESP|IP2|Data

External Gateway 302 then sends the packet, over the Internet, to Router 109 (Step 309). As is shown in FIG. 1, Router 109 is one of the two routers to which Leaf 104 is connected. The packet (IP1|ESP|IP2|Data) is transmitted using standard IP routing. The IP layer in External Gateway 302 uses the key referenced in the ESP field to decrypt the transmission (as described above, this key is shared between Leaf 104 and those nodes which communicate directly with Leaf 104, including Router 109). Router 109 then examines the address IP1, and uses local routing information to determine that packets with address IP1 should be sent to Router 110. This routing information is managed using RiPv2, as is further described above, although any other suitable routing protocol can be used.

Router 109 reencrypts the IP2 and Data fields, using a key shared between Router 109 and Router 110, and stores the table offset identifying that key in the ESP field. Router 109 then sends the packet to Router 110 (Step 310). As is shown in FIG. 1, Router 110 is one of two routers to which Leaf 114 (the receiving leaf) is attached. This transmission is handled in a manner similar to that used for the transmission from External Gateway 302 to Router 109. The IP layer in Router 109's gateway (not shown) examines the address IP1, and uses local routing information to determine that packets with address IP 1 should be sent to Router 110.

As is shown by the arrow between Router 110 and External Gateway 303, Router 110 sends the packet to External Gateway 303. (As is the case with the communication between Leaf 104 and Router 109, Router 110 first decrypts the communication using the key shared between Router 109 and Router 110, and then reencrypts the IP2 and Data fields using a key shared between Router 110 and Leaf 114.) External Gateway 303 is the gateway for Leaf 114, the leaf at which the receiving DB server is located. The transmission between Router 110 and External Gateway 303 is governed by IP1, which specifies the Internet address for External Gateway 303.

Once it receives the packet, External Gateway 303 examines the destination IP address contained in IP1, and recognizes that this is the address for External Gateway 303, meaning that External Gateway 303 is the intended recipient for the packet.

External Gateway 303 then strips off the IP1 field, (Step 311), leaving the following field:

ESP|IP2|Data

Next, External Gateway 303 uses the ESP field to locate the key necessary for decryption of the remainder of the packet. It uses that key to decrypt the IP2 and data fields, and removes the ESP header from the packet (Step 312). The packet now has the following form:

IP2|Data

The IP2 header includes the VPN address for DB Server 304. External Gateway 303 uses this address to send the packet to that DB server. DB Server 304 reads the recipient address from the IP2 packet and determines that it is the proper recipient (Step 313). It then strips out the IP2 header, leaving the data (Step 314). The transmission is now complete.

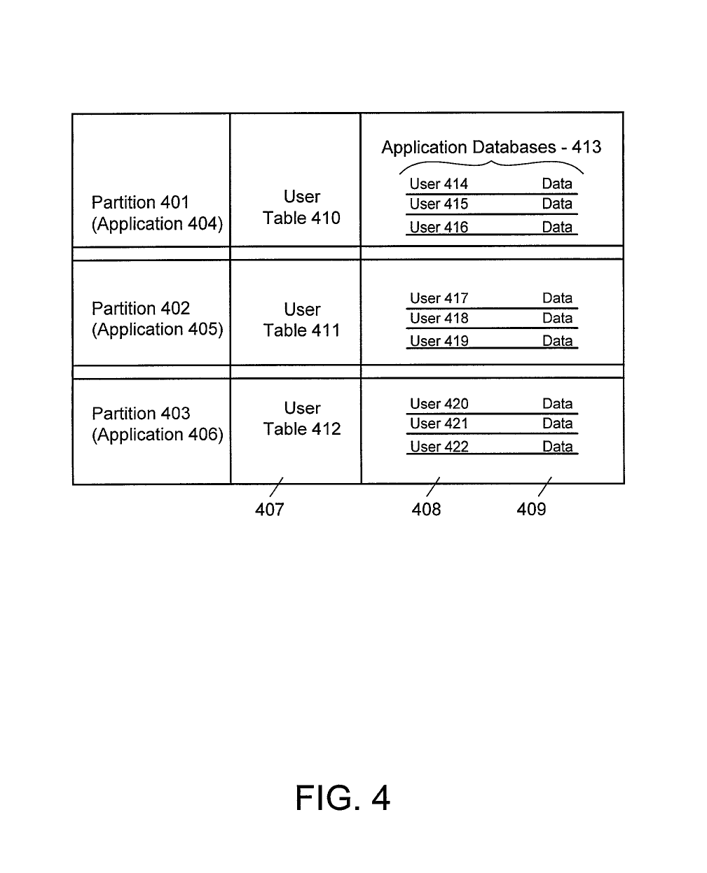

FIG. 4 illustrates the overall organization of the inventive database. This database is made up of data from the various applications supported by the system. For purposes of illustration, the overall database is shown with data for only three applications (Applications 404-406), though it should be understood that the database may include data for a large number of applications.

In one embodiment each application database is supported by Oracle database software, and the system uses Oracle software to manage and administer the overall database. In other embodiments other database software may be used.

Each application is assigned a single partition in the overall database (e.g., Partitions 401, 402 and 403). As is further described below, assignment of a single application to a single partition provides security for user data.

Each partition includes a user table (Column 407), which stores information regarding each user whose data is stored in the partition. Thus, User Table 410 stores data for Partition 401, User Table 411 stores data for Partition 402 and User Table 412 stores data for Partition 403. The organization and use of the user tables are further described below.

Each partition further includes data generated by the application assigned to that partition (Application Databases Column 413). This data will generally take the form of a database, organized in accordance with the application's architecture.

Ordinarily, each application's database is organized by user, with data associated with each user being stored in an addressable unit. This is illustrated in simplified fashion with User Name Column 408 and Data Column 409. Note that the same user may have data in several different partitions. Thus, User 414 may be the same individual as User 417. In the embodiment described, however, neither the overall system, nor the applications, has any way to know that User 414 and User 417 are the same individual. In other embodiments, which are described below, users are assigned global identities, and the system is therefore able to identify the same user across applications.

The system is able to locate data associated with a particular application (e.g., data for Application 404 is located in Partition 401), and, within the data for a particular application, is able to locate data for a particular user (e.g., User 414's data within Partition 401). In one embodiment, however, the system is not able to further parse the application databases (i.e., the system cannot retrieve a particular record associated with a particular user; such retrieval requires use of the application).

In one embodiment, every partition is present in at least one DB server at each leaf. Ordinarily, however, each DB server will include only a portion of the data in a partition. Thus, Partition 401 may include data for User 414 in a first leaf, data for User 415 in a second leaf and data for User 416 in a third leaf. Partition 401 in a fourth leaf might contain no user data. In the embodiment described, however, the user table is present in the partition at every leaf. Thus, although Partition 401 might contain no user data at a particular leaf, it will contain a copy of User Table 410.

In addition, user data may be stored redundantly. Data for a particular user may be stored at a number of leaves (e.g., five). Thus, in a first leaf Partition 402 may include data for User 417 and User 418, in a second leaf Partition 402 may include data for User 417 and User 419, and in a third leaf Partition 402 may include data for Users 417, 418 and 419.

In another embodiment, there may be no requirement that each leaf include each partition. In such an embodiment, for example, Leaves 113, 114 and 115 may store Partition 401, Leaves 104 and 106 may store Partition 402, and Leaves 106 and 113 may store Partition 403. In such an embodiment, a user log-in for a particular application is routed to a leaf containing the partition associated with that application. For example, a user logging-in to Application 404 would be routed to Leaf 113, 114 or 115, but would not be routed to Leaf 104 or 106.

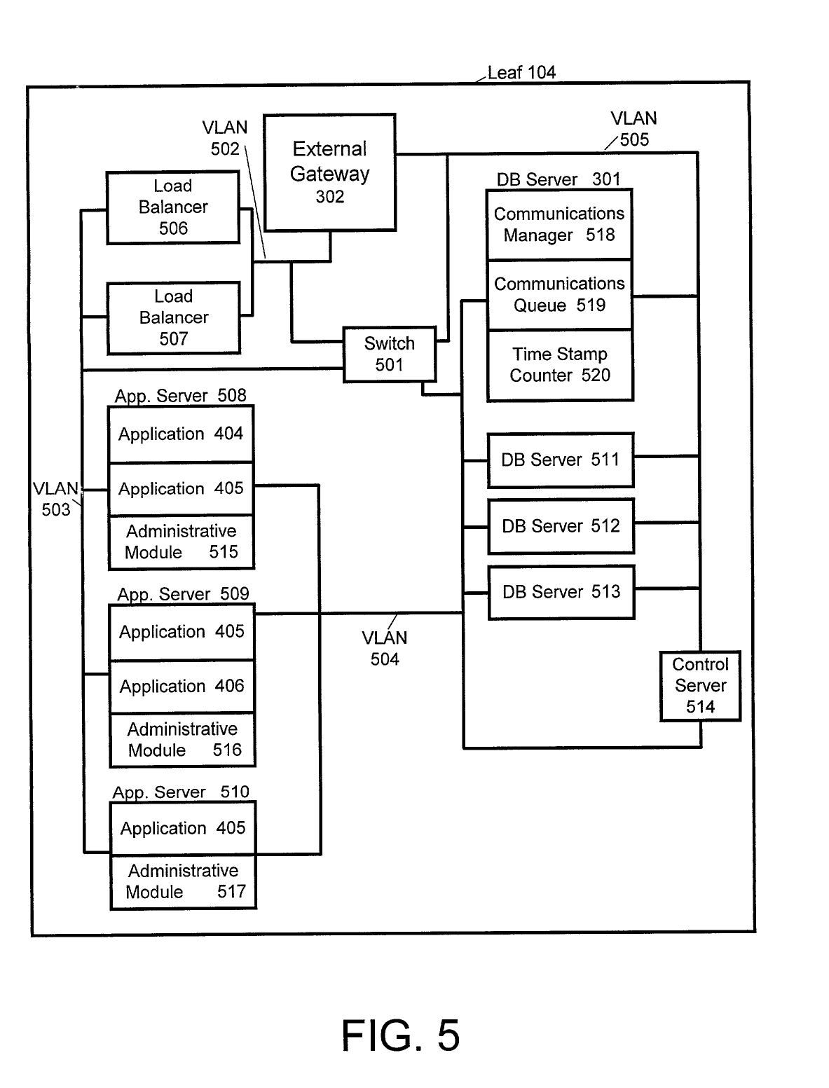

FIG. 5 illustrates certain details of Leaf 104 from FIG. 1. Details not germane to the present invention are not shown. In addition, it should be understood that different leaves need not contain identical configurations.

Leaf 104 includes External Gateway 302, certain functions of which were described above in connection with FIG. 3. External Gateway 302 handles communications with entities external to Leaf 104. External Gateway 302 may include conventional communications devices, such as modems. External communications addressed to Leaf 104 may be transmitted through ISP 103, which then transmits them in a single “hop” to Leaf 104 through External Gateway 302. External communications originating at Leaf 104 may proceed in an opposite course.

As is described above, External Gateway 302 uses VPN 117 for external communications. External Gateway 302 runs a RiPv2 routing daemon, and uses ESP transport mode for handling communications with remote leaves (see above). Among other functions, External Gateway 302 is responsible for encrypting and decrypting VPN communications, as is further described above.

Leaf 104 also includes Switch 501, which controls the routing of communications from device to device within Leaf 104. Switch 501 may be of conventional design, e.g., a Cisco 2924 switch.

Switch 501 controls four Virtual Local Area Networks (“VLANs”), which are designated as 502, 503, 504 and 505.

As is conventional, VLANs 502-505 do not constitute separate physical transmission paths. Instead, each VLAN is formed by connections configured within Switch 501. Thus, while Load Balancer 506, for example, is shown as connected to VLAN 502 and VLAN 503, in fact Load Balancer 506 is connected directly to Switch 501, as is every other module shown in FIG. 5. Switch 501 routes communications to and from Load Balancer 506 as if VLANs 502 and 503 were hardwired physical networks.

VLAN design is well-known in the art and will not be further described herein. For purposes of clarity, VLANs 502-505 have been drawn as if they constituted separate networks, and the discussion will proceed as if that were the case. In a different embodiment, VLANs 502505 could constitute actual hardwired physical connections.

As is conventional, various internal resources are attached to and addressable through each VLAN. As illustrated in FIG. 5, the elements attached to VLAN 502 are External Gateway 302, Load Balancer 506 and Load Balancer 507. Elements attached to VLAN 503 are Load Balancer 506, Load Balancer 507, App. Server 508, App. Server 509 and App Server 510. Elements attached to VLAN 504 are App. Server 508, App. Server 509, App Server 510, DB Server 301, DB Server 511, DB Server 512, DB Server 513 and Control Server 514. Elements attached to VLAN 505 are External Gateway 302, DB Server 301, DB Server 511, DB Server 512, DB Server 513 and Control Server 514. As is described above, Switch 501 is attached to all four of the VLANs.

As is conventional in a VLAN design, elements attached to a VLAN may communicate directly with each other. Elements which are attached to two different VLANs (and are not also attached to the same VLAN), may only communicate through modules which are present on both VLANs, which route the communication from one VLAN to another. Again, note that this diagram demonstrates logical connections, and that all of modules within Leaf 104 are connected directly to Switch 501, so that all communications must travel through that switch. “Direct” communications between one module and another means that each of the two modules can directly address the other, so that communications from one to another travel directly through Switch 501 with no requirement of translation.

Load Balancers 506 and 507 are responsible for balancing the load on App Servers 508, 509 and 510. As is further described below, App Servers 508, 509 and 510 run application programs at the request of users. Load Balancers 506 and 507 parcel out such requests so that the load on each of the app. servers is approximately equal.

Load Balancers 506 and 507 may operate in any appropriate manner. For example, when a user request is received for access to an application, Load Balancers 506 and 507 may first check whether that particular application is already running on one of the app. servers. If so, the request may be routed to that particular app. server. If the application is not currently running on any of the app. servers, Load Balancers 506 and 507 may use an algorithm to assign the user to one of the three app servers. This may be a random or pseudo-random algorithm, which assigns such requests in a random or pseudo-random manner. Alternatively, the algorithm may assign incoming requests based on the current workload of the app servers. In one embodiment, Load Balancers 506 and 507 may constitute a commercially available load balancer, such as the Big IP load balancer from F5 Networks, Inc.

Leaf 4 also includes application servers (“App. Servers”) 508, 509 and 510. In one embodiment, each of the app. servers has the capacity to run any of the applications which can be handled by the system, i.e., each app. server has access to memory storing the application, and the ability to load the application into the app. server's main memory, and each app. server has sufficient memory and other physical resources necessary to run every application. As illustrated, App. Server 508 is currently running Applications 404 and 405, App. Server 509 is currently running Applications 405 and 406, and App. Server 510 is currently running Application 405. Additional details of operation of the app. servers are described below.

In another embodiment, each of the app. servers may be capable of running only a subset of the applications which can be handled by the overall system. In one such embodiment, requests for a particular application would be routed by Load Balancers 506 and 507 to the app. server(s) capable of running that application. In another such embodiment, which is described above, all of the app. servers at a particular leaf may be capable of running only a subset of the applications which are supported by the overall network. As is described above, in such an embodiment, users logging-in to a particular application would be routed to a leaf containing app. servers capable of handling that application.

Each app. server is also running an administrative module (e.g., App. Server 508 is running Administrative Module 515, App. Server 509 is running Administrative Module 516 and App. Server 510 is running Administrative Module 517. The functioning of the administrative modules is described below.

The app servers operate using data from Database Servers (“DB Servers”) 301, 511, 512 and 513. DB Servers 301, 511, 512 and 513 include data from one or more users. In general, this data will take the form of a database. In one embodiment, each application uses Oracle database software to set up the database, and the system uses Oracle software to administer the data.

DB Servers 301, 511, 512 and 513 also include user tables (described below), and various types of system software (or software/hardware) modules, including Communications Manager 518 (shown only in DB Server 301, but also present in the other DB servers). Communications Manager 518 may accomplish the following tasks:

Send user data to a different DB server. Communications Manager 518 queries a user table (described below) to make sure the local data is current, then sends the data to the other DB server.

Update user data locally. Communications Manager 518 receives user data from a different DB server, and updates user data stored in DB Server 301.

Update time stamp data locally: Communications Manager 518 receives updated time stamp information from a different DB server, then updates the time stamp information in a user table stored on DB Server 301. Time stamp information is further described below.

The DB servers also include communications queues, such as Communications Queue 519, which is shown as part of DB Server 301 (other DB servers also have communications queues, which are not shown). Communications Queue 519 stores requests for communications to be sent from DB Server 301 to other DB servers. These communications may be prioritized depending on the type of communication. Communications may be prioritized as follows:

Obtain user data from another DB server: Highest priority.

Update time stamp tables in other DB servers to reflect changes made to data at DB Server 301: High priority.

Update user data in other DB servers to reflect changes made to data at DB Server 301:

Low priority.

Requests relating to obtaining user data from a different server are assigned the highest priority because latency involved in these communications may translate directly to delays perceived by the user. For this reason, the system attempts to handle such requests in real-time, or as close to real-time as is possible. Requests relating to updating time stamp tables in other DB servers may be necessary in order to make sure that another DB server does not attempt to make changes to the data without taking into account the changes made locally. Although such requests are important, they are unlikely to translate directly into user-observable latency. They are therefore handled in “near real-time.” Requests relating to sending locally updated user data to other DB servers may be handled when system traffic permits. As long as the time stamp tables in other DB servers have been updated, the absence of updated user information in the other servers will not create a major problem, since the other servers will know that updated user information must be obtained if the user logs-in. The process of using time stamp tables and updating user information is explained below in further detail.

The prioritization scheme described above is used in one embodiment. In another embodiment, time stamp updates are not sent ahead of data. Instead, data updates are sent out with a relatively high priority, and the time stamp updates accompany the data. In this embodiment, the time stamp information is used for purposes of determining prioritization if two changes are made to the same data in a near simultaneous manner, as may happen, for example, if two users are simultaneously accessing a multi-user database. In this embodiment the time stamp information is not used for purposes of determining whether locally stored information is or is not valid, since all data is assumed valid.

Because each DB server includes its own communications queue, some mechanism must be used to arbitrate access to External Gateway 302. Any suitable mechanism may be used, including token-based, FIFO, and arbitration based on priority of the requests (e.g., a higher-priority request on Communications Queue 519 would take precedence over an earlier-posted but lower-priority request on the communications queue associated with DB Server 511).

DB Server 301 also includes Time Stamp Counter 520, which contains a current “time stamp.” This time stamp does not track “clock” time, but is instead based on an approximation of the number of seconds elapsed since Jan. 1, 1970. This is a standard time measurement used in Unix systems. This value increments on a second-by-second basis.

Each communication from one DB server to another includes the current value of the sending DB server's time stamp counter. This includes communications within a single leaf, as well as communications from one leaf to another. Upon receipt of the communication, the receiving DB server checks its time stamp counter against the information received regarding the sending server's counter. If the receiving server's counter is lower than the sending server's, the receiving server's counter is adjusted to match the sending server's. In this way, the time stamp values in the various servers remain in rough synchronization. Again, it should be understood that the time stamp values are not intended as an approximation of clock time, but are intended only to reflect ordering. For this reason, a receiving server's time stamp may be updated based on the sending server's time stamp value, even if the receiving server is keeping more accurate time.

A malfunctioning time stamp counter in a single DB server could throw off the entire system, if the malfunctioning counter were “stuck” on a very high time stamp value. In such a case, the malfunctioning counter could cause all other servers to repeatedly reset to the higher value. If the value were close to or equal to the highest possible counter value, this could cause the entire system to become “stuck” at the top end of the range expressable in the counter (i.e., although normally functioning counters would correctly roll-over to the lowest value, the malfunctioning counter would quickly cause them to reset to the highest value, so that the counters would move in a very narrow range).

In order to avoid such a situation, DB servers may include circuitry which checks for a time stamp discrepancy which exceeds a particular threshold, and sends a warning message to NOC 102 if the threshold is exceeded. This would allow administrators at NOC 102 to identify and repair the malfunctioning time stamp counter.

Control Server 514 handles certain control functions for Leaf 104. Control Server 514 controls an intelligent power supply for Leaf 104, which may be of conventional design. In one embodiment, the intelligent power supply may be the Pulizzi IPC 3302FS. Control Server 514 may also include a serial connection to each of the other devices present at Leaf 104.

Control Server 514 is present on VLAN 505. External Gateway 302 is also present on VLAN 505. For this reason, Control Server 514 is directly accessible from External Gateway 302. This accessibility allows for an external reset of the power supply for Leaf 104, which causes a hard reboot of the entire leaf.

In addition, Control Server 514 can cause a reset of any of the other devices at Leaf 104 through its control of the intelligent power supply, which controls the power for each device. This allows for an external reboot of any of the individual devices.

In addition, the serial connection between Control Server 514 and other devices allows Control Server 514 to contact the other devices if they become inaccessible through the VLANs. This may occur, for example, if an application problem causes an app. server to disable its network interface, or if there is a network card failure.

The control server's ability to reboot any device through the intelligent power supply may be combined with the serial connection to enable the control server to reboot a device which has lost its connection with the VLAN, then use the serial interface as the machine console, and control and examine the device at a very low level without requiring it to boot up enough to enable the network interface.

The ability to externally access Control Server 514 allows NOC 102 to reset Leaf 104 or any of Leaf 104's components in the event of a hardware or software problem. This can reduce the necessity for service visits to Leaf 104, which is designed to operate with a minimum of human intervention.

External Gateway 302 is attached to VLAN 502 and VLAN 505. This allows every device attached to either of these VLANs to be addressable on VPN 117, since communications on VPN 117 flow into External Gateway 302. Thus, using VPN 117, it is possible to route a communication directly from any DB server to any other DB server. Communications can also be routed to Load Balancers 506 and 507 (e.g., user log-in requests to use a particular application) and to Control Server 514.

Modules present at Leaf 104 which are not directly attached to VLAN 502 or VLAN 505 are not directly accessible through VPN 117. Instead, communications addressed to such modules must proceed indirectly. Thus, communications for App. Servers 508, 509 or 510 must proceed through Load Balancer 506 or 507, or through Switch 501. Certain types of communications for App. Servers 508, 509 or 510 may also proceed through Control Server 514 (e.g., external reset commands). It is therefore impossible to directly address App. Servers 508, 509 and 510 through VPN 117. This provides additional protection against hackers who may wish to gain control of the applications or the app. servers.

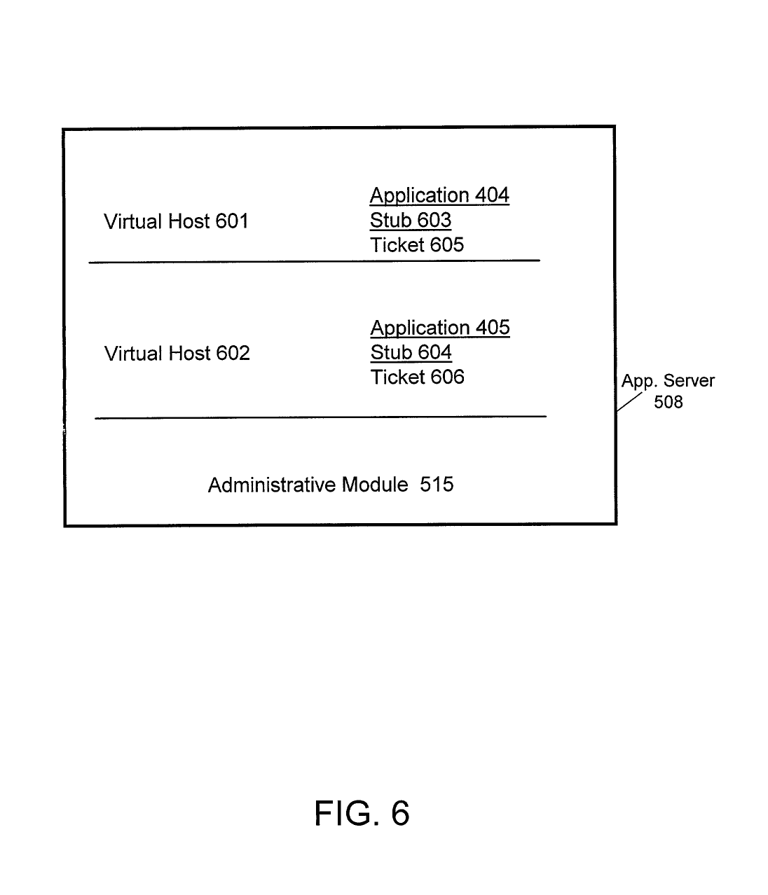

FIG. 6 contains additional information regarding the internal organization of the app. servers (e.g., App. Server 508). This illustration has been simplified for purposes of explanation, and extraneous detail has been deleted (e.g., each app. server may be a computer and contain various processing elements which are not shown).

Administrative Module 515 represents programming running on each app. server. The function of this programming will be further described below.

As shown, App. Server 508 is running Applications 404 and 405. In general, these are ASP programs, which are designed to be used by users who interact with the programs through the Internet. Examples of ASP programs include word processors, email programs, database programs, spreadsheets, etc.

App. Server 508 includes Virtual Hosts 601 and 602, within which the applications are running. The virtual hosts provide a complete environment to the applications, such that the applications may operate as if they were the only applications running on App. Server 508. Among other processes, the virtual host virtualizes the file system, so that each application has access to its own copy of the file system using a standard Unix call known as chroot.

As is well-known in the art, the Unix chroot call changes the root directory. The root directory represents the top of the file hierarchy.

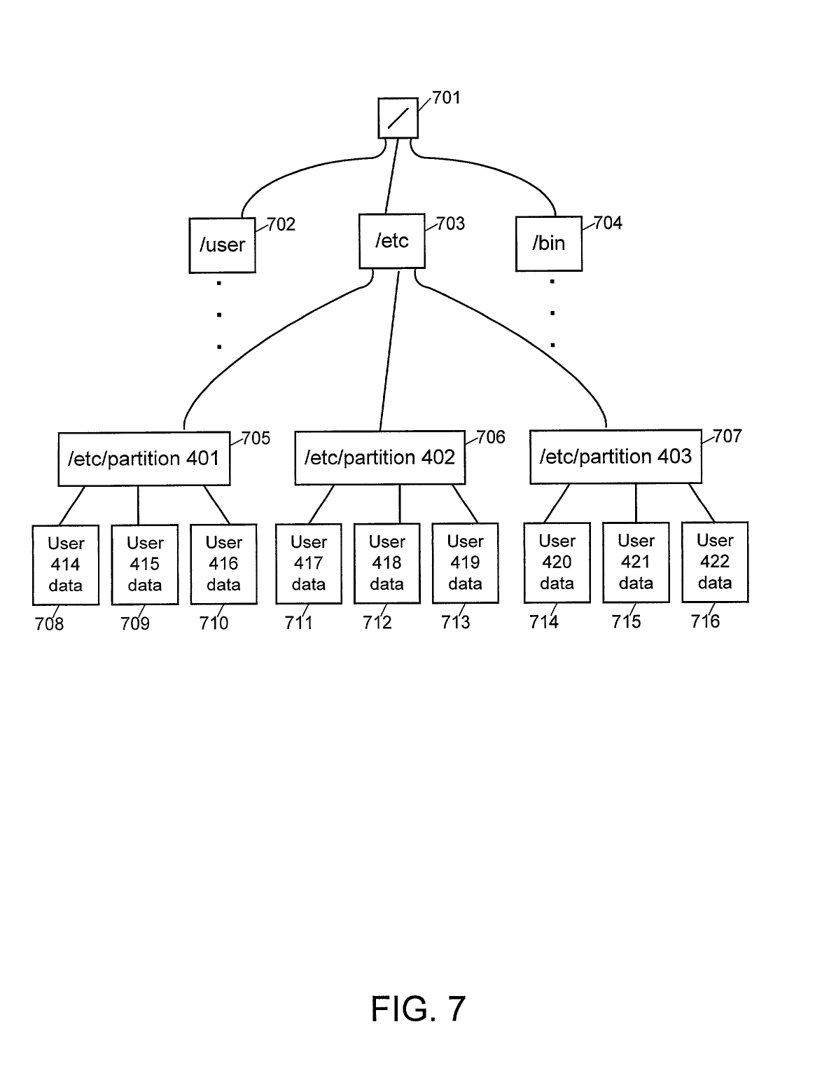

The operation of the chroot call is illustrated in FIG. 7, which shows a highly simplified version of the overall network file structure. As is conventional in Unix file systems, the top-level directory is “/”, which is shown as Directory 701. Beneath this top-level directory are three subdirectories: “/usr”, (Directory 702), “/etc” (Directory 703) and “/bin” (Directory 704). Additional subdirectories may exist below /usr and /bin, but are not germane to the present discussion and are therefore omitted from FIG. 7

Three subdirectories are shown below Directory 703: /etc/partition401 (Directory 705), /etc/partition402 (Directory 706) and /etc/partition403 (Directory 707). Each of these contains a partition, e.g., Partitions 401, 402 and 403, as are described above. Each of these partitions in turn has its own subdirectories, each of which is designated as data for Users 414-422. (Directories 708-716). The user data subdirectories store data for particular users; e.g., Directory 708 stores User 414's data in Partition 401, Directory 711 stores User 417's data in Partition 402, etc. As should be clear, the directory structure shown in FIG. 7 corresponds to the partition structure shown in FIG. 4.

A process may access the root directory and any directories (or files) which are hierarchically located below the root directory. Thus, a process which has access to the “/” directory (Directory 701) may access files in Partitions 401, 402 and 403. By default, the“/” directory is the root directory, so that any process may gain access to any file. The chroot call is used to change the root directory, so that a process will have access to only a portion of the file structure.

For example, suppose data for Application 404 is stored in Partition 401. When Application 404 is initially invoked, the virtual host software running on the app. server will issue a chroot call, which will change the root directory for Application 404 so that the root directory is /etc/partition401 (Directory 705). This will allow Application 404 to access all data in the Partition 401 directory, and all data in directories which are hierarchically located below that directory, including Directories 708-710. Because Application 404 recognizes /etc/partition401 as the root directory, however, it will be unable to access Directories 711-716, since these are hierarchically located in Partitions 402 and 403 (Directories 706 and 707).

If Application 405 is then invoked on the same app. server, a second virtual host will be set up, and this virtual host software will issue a chroot call relating to Application 405, so that the root directory for Application 405 is changed to etc/partition402 (Directory 706). In that case, Application 405 would have access to user data stored in Directories 711-713, but not to user data located in Directories 708-710 or 714-716. In this way, Applications 404 and 405 can run on the same app. server, and can have physical access to the same DB servers, but can be limited to accessing only that data which is present in the partition assigned to that particular application. Note that, in this embodiment, each chroot call relates only to a single application, and that different applications may simultaneously have different root directories.

Virtual hosting therefore provides each application with its own version of the overall file system. Virtual hosting may also “virtualize” the various physical devices present at App. Server 508, e.g., the processor, memory, etc. The virtualization process allows each application to make calls on physical resources as if no other applications were running, and therefore avoids the possibility of conflicts (e.g., conflicts which may arise if two applications each believe they are running in the same memory space).

The concept of virtual hosting is well-known in the art, and will not be described herein in detail. Virtual hosting may be provided, for example, by the ServerXchange product sold by Ensim Corp.

Virtual hosting provides two benefits in the context of the overall network. First, each app. server has the capacity to run multiple applications at the same time, and to run multiple instantiations of the same application. The ASP applications running on the app. servers may not have been designed for such multi-tasking. Virtual hosting eliminates the possibility of resource conflicts between applications (or between multiple instantiations of the same application), by providing the application running within the virtual host with a complete set of resources, and masking the fact that other applications (or other instantiations of the same application) are also using those resources.

Second, virtual hosting increases security, since a hacker who attacks an app. server and uses a weakness in an application to take over operation of that application, cannot use the subverted application to gain access to the operations of or data stored by other applications. This is a result of the chroot call, which ensures that different applications running on the same server have no ability to communicate with or influence the data associated with other applications, and of the virtualization process, which ensures that one application is not aware of the operation of another application and cannot influence that operation.

Virtual hosting is generally most useful if user traffic requires multiple applications running simultaneously on the same server, and particularly if multiple instantiations of the same applications are running. In one embodiment, virtual hosting may not be used if traffic demands do not require it. In such an embodiment, each app. server may only run a single application at a time.

Returning to FIG. 6, Virtual Hosts 601 and 602 are set up under the control of Administrative Module 515, when a request is forwarded from one of the load balancers for invocation of a new application (or when a new request for an already running application requires that a new instantiation of the application be invoked).

When Administrative Module 515 sets up Virtual Host 601, Administrative Module 515 starts up Stub 603 within Virtual Host 601. The operation of stubs is further described below.

In addition, Administrative Module 515 causes Application 404 to start running within Virtual Host 601. In general, when an application commences operation, the application has to be initialized with information regarding the location of the application's data. Administrative Module 515 supplies this information by passing to Stub 603 address information for the partition associated with Application 404 (e.g., the DB server containing data for Partition 401, and the address within that DB server at which the data is located).

Administrative Module 515 is also responsible for generating “tickets,” (e.g., Tickets 605 and 606) which authorize communication between the application (e.g., Application 404) and its database (e.g., Partition 401).

Each ticket may consist of a randomly generated string of bits. Communication between an application and a partition may require that a copy of the same ticket, with the same value, be held by both sides of the communication. Because each ticket is only valid for a single partition, the use of tickets ensures that a particular application will only be able to access the partition holding that application's data, and will not be able to access data for other applications, since data for other applications is stored in other partitions.

Thus, if a flaw in Application 404 provides a means for an unauthorized intruder to gain control of the application, that intruder will be limited to access to the data associated with Application 404, and will not be able to access data associated with Application 405. This is so because Application 404 only has access to the ticket for a single partition, and therefore cannot gain access to data stored in any other partitions.

If a particular application is flawed, an attacker may be able to gain control over that application, and therefore gain control over that application's data. This would also be true if the application were running on an ASP's central server.

The ticket system, however, ensures that flaws in a particular application do not create greater vulnerability than would exist if that application were running on the ASP's central server. Such greater vulnerability could exist, for example, if flaws in a particular application allowed an attacker to gain access not only to the data associated with that application, but also to gain access to data associated with other applications. In such a case, the network architecture would have magnified the destructive consequences of an application flaw. Ticketing limits the possibility for such an outcome.

Tickets increase the security provided by partitions. In a different embodiment, one or the other of these protections might be dispensed with, though with some decrease in overall data security.

Administrative Module 515 generates tickets at regular intervals (e.g., one ticket an hour for each partition), using a conventional methodology (e.g., Kerberos, which is described in RFC 1510). Each ticket is only valid for a specified period (e.g., one hour). In another embodiment, tickets could be usable on a one-time basis. This embodiment would require the generation of tickets each time the application requires access to the user's data, and would also require frequent transmissions of tickets into the virtual hosts and to the DB servers.

Use of “one-time” tickets may increase security, since the virtual hosts and DB servers would discard each ticket once a use had occurred. A hacker gaining access to a ticket would therefore only be able to engage in a single transaction. “One-time” tickets do, however, increase the burden on the system, since the tickets must be generated and communicated frequently. In addition, the one-time system may not increase overall security by a significant amount, since a hacker who has gained control of an application may well be able to gain access to each ticket as it is generated.

Administrative Module 515 sends a copy of each ticket to the stub running in each virtual host, and another copy to the DB servers, which store a copy of the ticket for each partition. Thus, in the case of App. Server 508, Administrative Module 515 will generate Ticket 605 for Partition 401. A copy of that ticket is sent to Stub 603. Another copy of that ticket is sent to each DB server on Leaf 104 which contains data for Partition 401.

In order to increase security, the ticket sent to the DB servers may be encrypted prior to sending that ticket across the VLAN, so that an attacker who has access to VLAN traffic will have greater difficulty in gaining access to the tickets.

When Application 404 attempts to communicate with its database, the application generates a request for such communication, using its own internal protocol. This request is intercepted by Stub 603, which adds Ticket 605 to the request. The request, plus Ticket 605, is then communicated across the VLAN to the DB servers. The ticket may be encrypted prior to such communication.

Each DB server then matches Ticket 605 with the ticket currently stored at each partition, and accepts the communication only if Ticket 605 matches the ticket already stored for a partition. If a communication is accepted based on a ticket, the application is only allowed to access the partition associated with that ticket. Thus, a communication with Ticket 605 will only be accepted at a DB Server storing Partition 401, the partition which contains the data for Application 404, and will only allow for access to that partition.

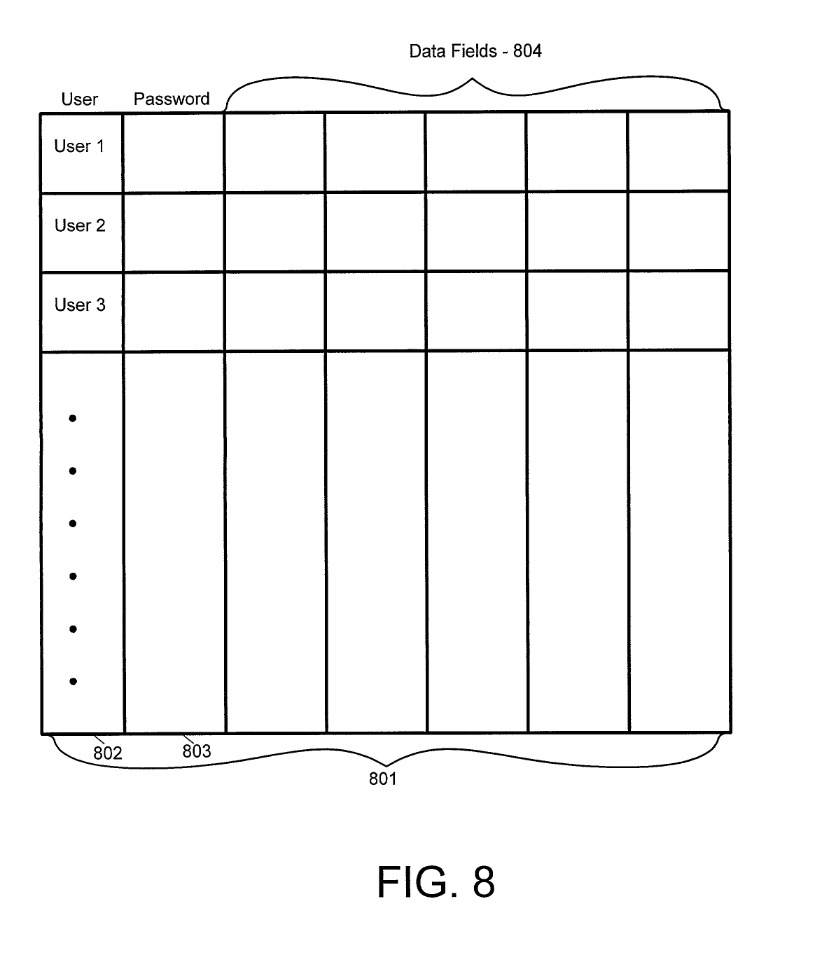

FIG. 8 illustrates a prior art database schema used by a hypothetical ASP. This schema has been simplified for purposes of illustration, and it should be noted that different ASPs have different database schemas, some of which may differ significantly from that illustrated in FIG. 8.

Database 801 is an SQL database, which may be generated by any of a number of commercially available applications (e.g., Oracle). In Database 801, User Column 802 contains names or other identifiers corresponding to users who have data stored in the database. Password Column 803 contains a password for each of the users listed in User Column 802. Data Fields 804 contain data, also corresponding to the user listed in the corresponding field in Column 802. Again, Database 801 is simplified for purposes of illustration, since multiple records of data might be associated with each user.

When a user invokes the application which generated Database 801, the application may initiate an applications log-on module, which prompts the user to supply a user identifier and password. The application then generates a query to Database 801. As is common in SQL databases, this query may use a standard protocol (e.g., ODBC, OCI). The query will generally include both the user name and the password, and may take a form similar to the following:

“Select Password from Database where User ID=x.”

In this query, “x” is the ID entered by the user. Based on this query, the application searches User Column 802 for User ID x. If that user ID is not found, the application returns an error message (e.g., “Login Incorrect.”) If the user ID is found, the database returns the associated password from Password Column 803, and compares that with the password supplied by the user. If the passwords match, the application allows the user to access those records associated with that user ID. If the passwords do not match, the application returns an error message (e.g., “Password Incorrect.”).

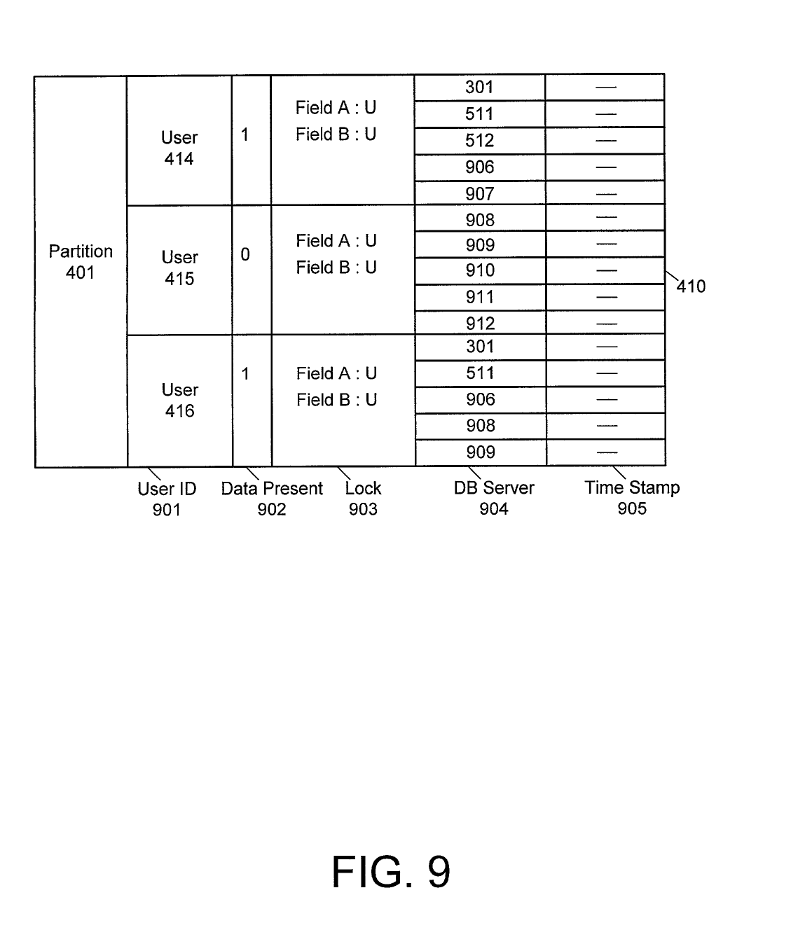

FIG. 9 provides further details of User Table 410, which is also described above in connection with FIG. 4. User Table 410 contains User ID Column 901, Data Present Flag 902, Lock Column 903, DB Server Column 904 and Time Stamp Column 905.

As is described above, User Table 410 contains information relating to Partition 401, which contains data generated by Application 404. In general, one user table will be present at each leaf for each application supported by the system. The user table for a particular partition will generally be stored in each DB server which contains a copy of at least a portion of that partition. As is described above, a DB server may only contain a subset of a partition, or may contain no user data at all for a particular partition. Regardless of the amount of user data present for a particular partition at a DB server, however, in one embodiment the user table for a partition must be present if that DB server supports that partition.

In one embodiment, each DB server may include at least a subset of the overall user table for every partition. This subset includes the complete entry for all users whose data is stored at that DB server (e.g., for each such user, a full entry for User ID Column 901, Data Present Column 902, Lock Column 903, DB Server Column 904 and Time Stamp Column 905). For users whose data is present in the partition, but not stored at this particular DB server, the DB server includes only the information from User ID Column 901 and DB Server Column 904.

In another embodiment, the user table may include the information from User ID Column 901 plus a subset of the information from DB Server Column 904, with only a single DB server identified. In yet another embodiment, the user table stored at a DB server which does not store the data for that user may contain only information from User ID Column 901.

The alternate embodiments described above involve storing less information than is stored in the initially-described embodiment. It is also possible to store additional information, in which every DB server which contains any data from the partition stores the entire user table for that partition, including all of the information from User ID Column 901, DB Server Column 904 and Time Stamp Column 905.

These various embodiments involve different sets of performance trade-offs. If the full user table is stored at every DB server, including all of the information in DB Server Column 904 and Time Stamp Column 905, the user tables for a particular partition must be updated whenever a user's data is updated at any one of the DB servers. This update includes user tables at DB servers which store data from that partition, but do not include the data for that particular user. This update is required because the user tables at all DB servers include time stamp information relating to the most recent update of the user's data (i.e., Time Stamp Column 905). Thus, even if a particular DB server does not include a user's data, a change to that data requires a change to at least the time stamp column of the user table at that DB server.

Other changes to the user's data may require other changes to user tables present at all DB servers which store data from that partition. These may include changes to DB Server Column 904. Again, a change to values in this column at any DB server will require a change to the user table values for all DB servers with data from the partition, including DB servers which do not store that user's data. (Note, however, that changes to Data Present Column 902 or Lock Column 903 are not propagated to other servers, since these relate only to the data present at the local server.)

Depending on the number of leaves present in the network, these updates may cause significant additional traffic. If, for example, the network includes fifty leaves, each of which has data for each partition (and therefore a user table for each partition), a change to the user data at one DB server would require not only that the user data be updated at every other DB server holding a copy of the data for that user, but also that the user table be updated at every DB server. In a typical case, a copy of the user data may be held at five leaves. Thus, if the entire user table for a partition is stored at each leaf, an update to user data at one leaf will require an update to the user table at forty-five leaves which do not contain a copy of the user's data.

Although user table updates do not involve a large amount of information, the number of communications required may become burdensome, particularly if a large number of users are updating information at the same time. The burden of such communications may be reduced by sending only “incremental” updates, in which the update contains only limited information. This may be limited to a copy of the information for the particular user whose data has been changed (e.g., if User 414's data have been changed, transmit the information from all columns, but only for that user). The transmitted information may be further limited to only those fields which have been changed (e.g., if the only information which has changed for the user table entry for User 414 is one value in Time Stamp Column 905, then transmit only the user ID and the changed time stamp value).

Reducing the size of the user table update transmissions does not, however, reduce the volume of such transmissions, and such volume may have a significant effect on overall performance.

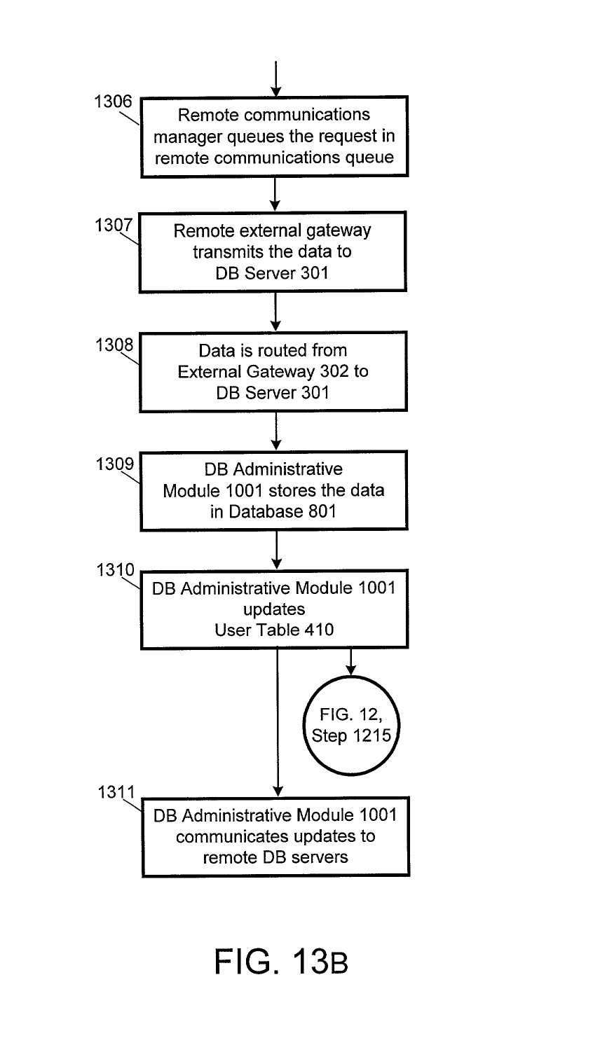

The initially-described embodiment is intended as a trade-off between transmission volume over the network and the latency created when full user table information is not present. In particular, additional time may be required when a user logs on to a DB server which does not contain a copy of that user's data. This is so because the user table information is used in the process of downloading the user's data from one of the DB servers which stores it. (The downloading process is described below in connection with FIG. 13).

If the user tables at all DB servers contains the full set of information for all users, when a user logs-on to a DB server which does not contain that user's data, the DB server can use DB Server Column 904 to identify each of the other DB servers which does contain the user's data, and can attempt to obtain the data from the particular DB server which is closest, in terms of time required for the communication.

The DB server can also use Time Stamp Column 905 to determine whether one of the DB servers with the user's data appears to have data which is more current than the others, and can preferentially download from that DB server. Note that this technique may only be used in embodiments in which the time stamp information is propagated to all servers, including servers which do not have a copy of the user's information.

If user tables contain only limited information for users whose data is not stored at that DB server, additional time may be required to download data for a user logging-on to a DB server which does not contain data for that user. If the user table contains information from DB Server Column 904, but does not contain time stamp information in Time Stamp Column 905, the DB server may initially attempt to download the user's information from a DB server which does not contain a current copy of the information, thereby requiring that the download request be redirected to another DB server. If the user table entries for users whose data is not stored at this DB server contains only the user ID plus one DB server entry in DB Server Column 904, a DB server attempting to obtain the user's data will be forced to attempt to obtain the data from a single DB server. This has the disadvantage stated above of creating the possibility that the DB server initially contacted will not have the most current version of the data. In addition, the DB server listed may be relatively “far” in terms of the communications time required to download the data (i.e., the number of hops involved in the transmission). Moreover, that DB server may have become unuseable because of problems at that leaf or because of a communications breakdown.

Similar latency problems may be created if the user table entries for users whose data is not present at a DB server contain only the user ID. In such cases, if a user logs on to a DB server which does not contain that user's data, the DB server will be able to determine that the user is a valid user for the particular application, but will have no information regarding where the user's data is stored. In one embodiment, the DB server could obtain that information by making a request to a central server (e.g., NOC 102). In another embodiment, the DB server could send a query to one or more other DB servers seeking the user's data, with those DB servers sending the query on to still other DB servers if they do not themselves store a copy of that data.

Returning to FIG. 9, User ID Column 901 contains a list of user names or identifiers.

Data Present Flag 902 may contain a single bit for each user. This bit indicates whether valid data is present for this user at this DB server. If data is not present for this user, Data Present Flag 902 is set to zero. If the user logs-on to this DB server, thereby causing data to be downloaded from a remote server, Data Present Flag 902 is set to one for this user. Data Present Flag 902 is reset to zero when a communication is received from a remote server containing an indication that the user's data has been updated at that remote server. As is more fully described below, in such a case the local DB server will receive a time stamp from the remote server, indicating the time of the update, but updated data may not be received until a later time. In order to avoid any use of non-updated data during the interval between the remote update and receipt of the updated data, Data Present Flag 902 is reset to zero, so that, if the user logs on to the local server during the interval, this will be treated as if no user data is present. When updated user data is received at the local server, Data Present Flag 902 is reset to one.

In one embodiment, Time Stamp Column 905 contains time stamp information reflecting the most recent time stamp received relating to this user's data from each of the DB servers listed in DB Server Column 904. In another embodiment, Time Stamp Column 905 may contain valid data only if the local DB server is listed in DB Server Column 904, indicating that the user's data is present at this DB server. In this embodiment, if the local DB server is not listed in DB Server Column 904, Time Stamp Column 905 does not contain valid data, and is not used.

The use of Data Present Flag 902 may simplify processing, since it provides a simple mechanism for checking whether data is current or needs to be updated. It should be understood, however, that this mechanism may not be necessary. Instead, in a different embodiment, the system may determine if valid data is present by checking the values in Time Stamp Column 905. As is described above, Time Stamp Column 905 contains information regarding when data was updated in each of the DB servers which has a copy of the data, including the local DB server. The local DB server may, therefore, determine whether the local copy of the user's data is valid by checking the time stamp values, since, if one of the other servers indicates a later time stamp than the time stamp associated with the most recent local update, the local data may be invalid, and valid data will have to be obtained from that other server.

Description will proceed as if Data Present Flag 902 is in use, but it should be understood that the function of this flag may actually be replaced by a check of the time stamp values.

It should also be understood that, in an even simpler embodiment, Time Stamp Column 905 may also be dispensed with. In this embodiment, data is presumed valid at each site, and time stamp information is not used. This embodiment requires that data updates be sent to all DB servers as soon as possible, since the system has no way to check whether the data present on a particular DB server is valid. This embodiment therefore simplifies processing, but at the cost of requiring that data updates be handled at a higher priority, and also leaving open the possibility that a user may encounter stale data, particularly if a user logs off one machine and relatively quickly logs onto another machine at another site, or in cases in which multiple users may have access to the same database.

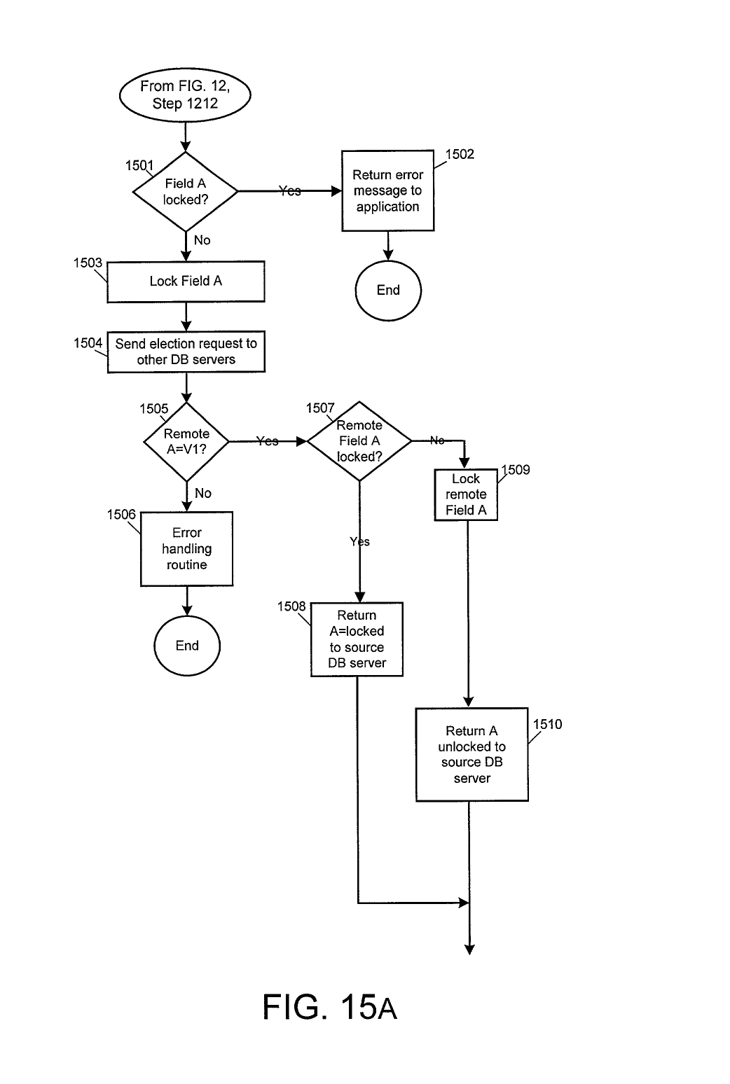

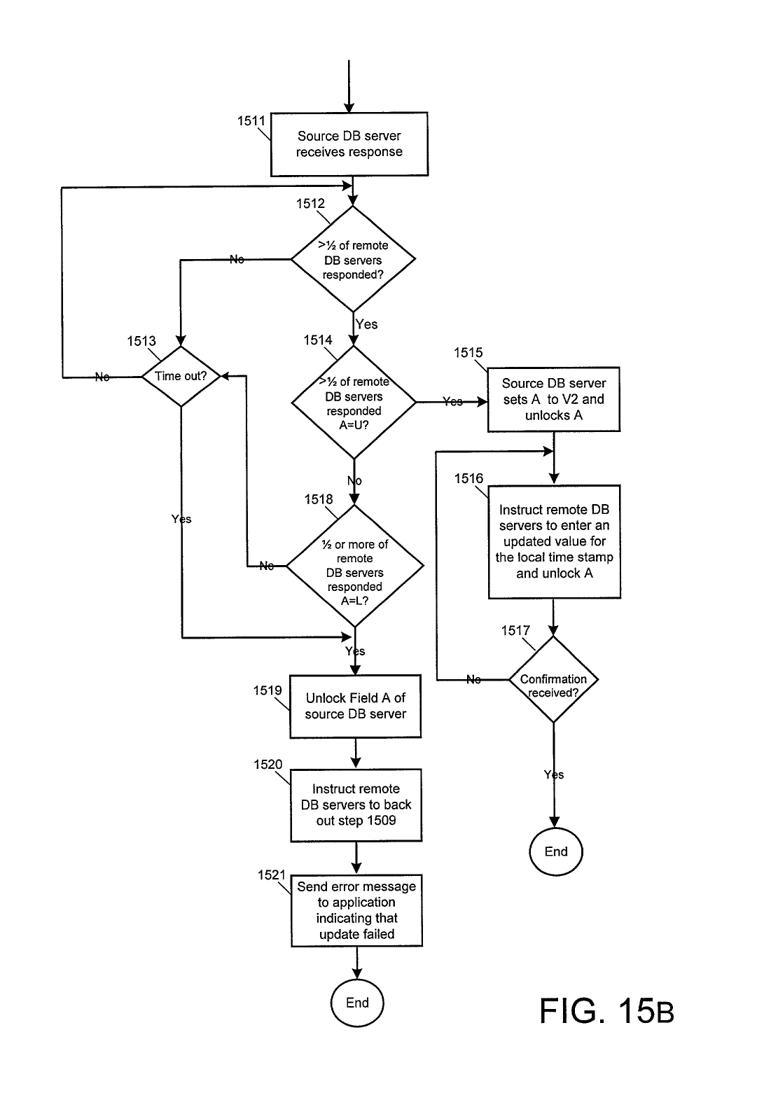

Lock Column 903 contains a list of fields and an indication as to whether each field is locked (“L”) or unlocked (“U”). The use of locking is described below in connection with FIG. 15.

DB Server Column 904 contains a list of those DB servers at which the data for the associated user is found. For example, data for User 414 is found at DB Servers 301, 511, 512, 906 and 907, data for User 415 is found at DB Servers 908, 909, 910, 911 and 912, etc. The information in DB Server Column 904 constitutes the VPN IP address for each of the servers. This corresponds to information contained in IP2 address 204 described above. As is described above, this address includes the identity of the leaf at which the DB server is located. This information may be used to redirect queries to another server at the same leaf. For example, if a partition is stored on DB Server 301 and DB Server 51 1, a particular user's information may be found on only one of those servers, e.g., DB Server 301. If the application is originally directed to DB Server 51 1, a search on the user table located at DB Server 511 will reveal that the data is not present on that server. By examining the addresses of the DB servers listed for this user's data, the system can determine that one of those servers (DB Server 301) is located at the same leaf as DB Server 511. This allows the system to redirect the application to use DB Server 301, rather than requiring that the user's information be downloaded from a remote leaf to DB Server 511.

Time Stamp Column 905 contains an entry for each entry in DB Server Column 904. Each entry in Time Stamp Column 905 constitutes an indicator of the time at which the user's data was updated in the associated DB server.

When a user updates the user's data on DB Server 301, a new time stamp entry is placed into the slot in Time Stamp Column 905 which corresponds to DB Server 301 and to this particular user. Thus, if User 414 updates information stored in DB Server 301, the Time Stamp Column 905 entry for DB Server 301 in the user table stored at DB Server 301 will be replaced with the time stamp value current as of the time of the update.

This update is handled by a DB administrative module running on DB Server 301. As is further described below, this DB administrative module intercepts and evaluates all communications from an application running on an app. server (e.g., App. Server 508) to a database stored on a DB server (e.g., DB Server 301). In the case of a communication confirming an update to the database (e.g., the user has modified data), the administrative module identifies the transaction as involving a database update and updates the appropriate entry in Time Stamp Column 905 accordingly. This update is handled by replacing the existing value in Time Stamp Column 905 with the current value contained in the DB server's time stamp counter (e.g., Time Stamp Counter 520).

Time Stamp Column 905 may also contain values for other DB servers at which the user's data is stored. In such cases, these values may be updated by communications received from the remote DB servers. Such communications may indicate that the user's data has changed, and include a time stamp associated with that change. In one embodiment, such communications may be received before the updated version of the user's data is received.

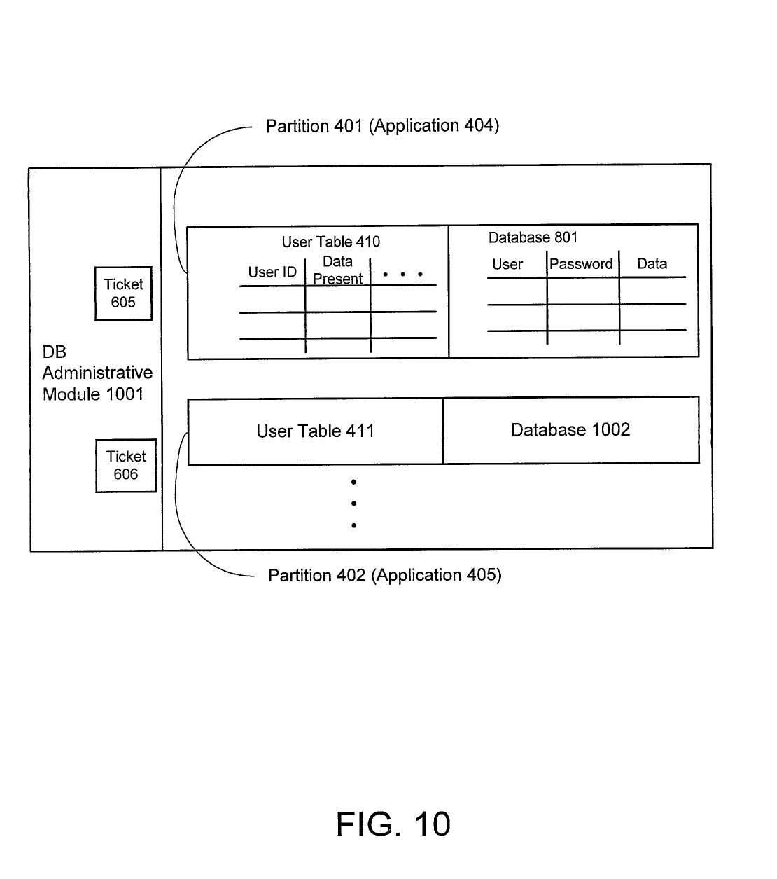

FIG. 10 illustrates some of the software and data stored on a typical DB server, e.g., DB Server 301. Each DB server includes a DB administrative module (e.g., DB Administrative Module 1001). The DB administrative module is responsible for intercepting communications between an application (e.g., Application 404), and the application's database. In the example shown, DB Server 301 includes Partitions 401 and 402, which store data for Applications 404 30 and 405. Communications from app. servers running those applications are routed to DB Server 301, where they are intercepted and evaluated by DB Administrative Module 1001, in a manner described more fully below.

DB Server 301 includes a user table for each of the partitions, organized as is illustrated in FIG. 9. Thus, User Table 410 contains user, leaf and time stamp data for Partition 401, corresponding to Application 404, and Database 801 contains data for that application. Note that some of this information is not shown in FIG. 10 for purposes of clarity. DB Server 301 also stores User Table 411 and Database 1002 for Partition 402, though these are illustrated with less detail.

DB Server 301 also stores Ticket 605, which corresponds to Partition 401 and Ticket 606, which corresponds to Partition 402. As is further described above, these tickets contain a value which is used by DB Administrative Module 1001 to determine if a communication from an application running on an app. server is authorized to gain access to the partition.

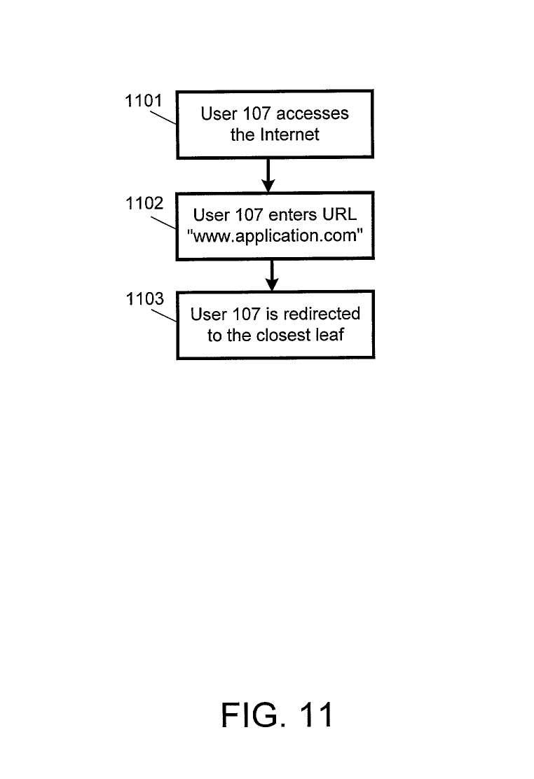

FIG. 11 illustrates the manner in which a user request is routed through the Internet to an appropriate leaf. The manner in which Internet addressing and routing is conventionally handled is well-known to those in the art and will not be described in detail herein.

As is described in connection with FIG. 1, User 107 accesses the Internet through ISP 103 (Step 1101). This log-on occurs in a conventional manner. User 107 then attempts to invoke an ASP application, e.g., an application supplied by ASP 101. The manner in which User 107 invokes the application may vary from ASP to ASP, but one conventional manner includes User 107 entering a URL associated with either the application or the ASP, e.g., “www.application.com” (Step 1102).

In the ordinary course, the URL entered by User 107 is received by ISP 103, and is translated into an IP address associated with the URL. The process of translating between the URL and the IP address is handled by the Domain Name Server (“DNS”) system, which consists of a hierarchical organization of servers containing a distributed database of URLs and associated IP addresses. The operation of the DNS system is well-known in the art and will not be further described herein.

In one embodiment, the routing process for the network described herein uses Global Dispatch from Resonate for routing user log-ons. This product may determine which leaf is “closest” to the user, in terms of number of hops required, and insert the IP address for that leaf into the DNS server, so that the DNS server will use that IP address for routing the user's communication, instead of using the address which is ordinarily associated with the URL entered by the user (e.g., “www.application.com” will end up addressing a network leaf instead of the ASP's central site).

The Global Dispatch product may store the IP addresses of received requests for several hours, so that new requests from the same location may be automatically routed to the same leaf. The log-on process could also make use of cookies stored on the user's browser, since cookies could contain information regarding the most recent leaf used.

In one embodiment, the user is routed to the closest leaf (Step 1103). Note that the user's data will ordinarily be present at that leaf, since, unless the user has changed location, the user will be routed to the same leaf each time (unless routing is changed depending on current usage patterns). If the user does change location, the leaf to which the user is routed may not contain the user's data, though, if the user logs on a second time, that data will be present at that leaf.

The embodiment described above assumes that each leaf is capable of running every application supported by the overall system. In a different embodiment, some or all of the leaves may run only a subset of the supported applications. In such cases, users will be routed only to those leaves which support the user's application.

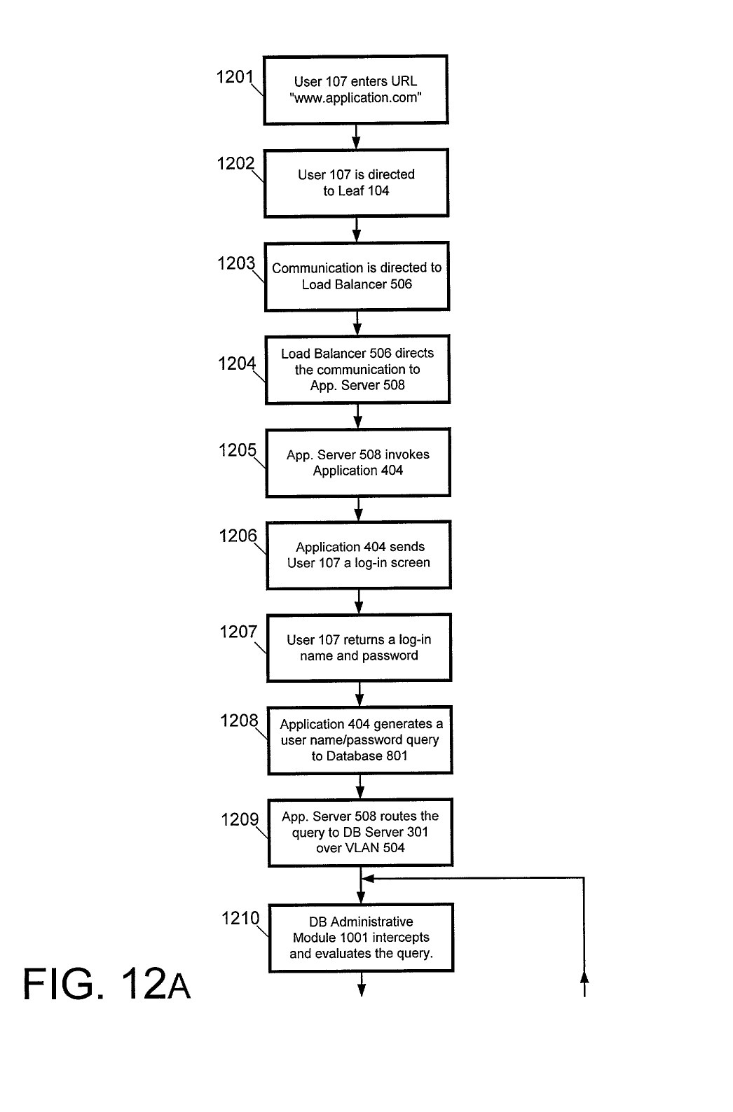

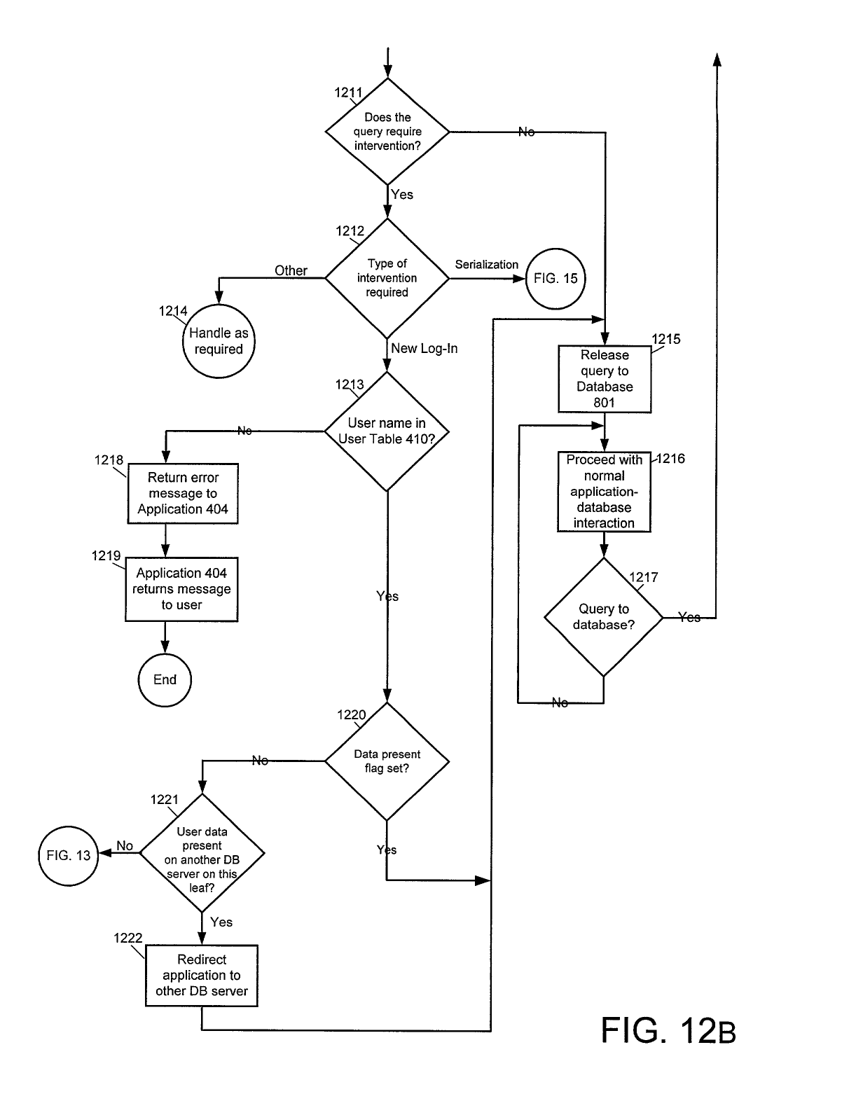

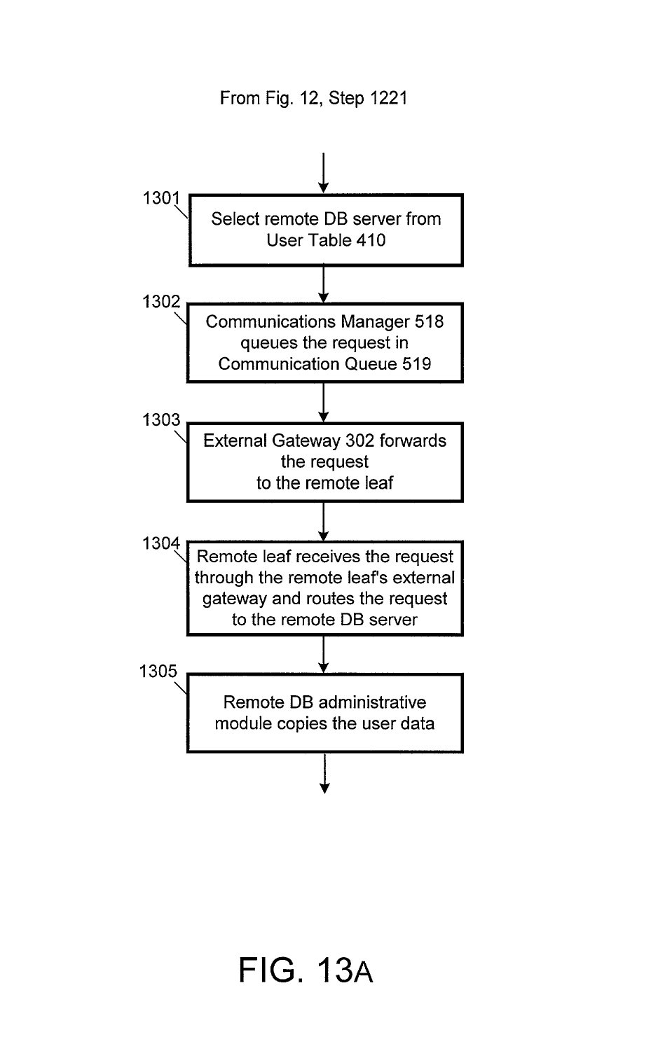

FIG. 12 is a flowchart which illustrates the operation of the system when data for a particular user are present at the leaf to which the user logs in. FIG. 12 builds on earlier figures, and elements given common numbers in multiple figures are intended to represent the same things. FIG. 12 illustrates operations taking place on Leaf 104 as illustrated in FIG. 1.

In the first step shown in FIG. 12 (Step 1201), User 107 enters a URL for the ASP application into a browser. This may be handled by typing in a URL (e.g., “www.application.com”), by clicking on a hyperlink, or in any other suitable manner. The URL may be specific to a particular application (e.g., Application 404), or it may be a general URL for multiple applications supported by the ASP.

In one example, the user might be attempting to access a spreadsheet application, along with spreadsheet data previously entered by the user. The user may do this by entering the following hypothetical URL: “www.applicationprovider.com/spreadsheet.”

In the manner described above in connection with FIG. 11, User 107 is directed to Leaf 104, since this leaf includes data for User 107 for Application 404, and since this leaf is geographically closest to User 107 (Step 1202). Alternatively, User 107 may be directed to a leaf which has the lowest latency, one which is relatively underused at present, the last leaf User 107 used, or a leaf chosen randomly or through some other method.

In Step 1203, Leaf 104 directs the request to Load Balancer 506.

In Step 1204, Load Balancer 506 determines that Application 404 is currently running on App. Server 508 and directs the request to that app. server.

In Step 1205, App. Server 508 invokes Application 404, based on the application identified in the URL typed in by the user. If the URL is associated with multiple applications, the user may be provided with a selection screen allowing the user to select among the applications.

In Step 1206, Application 404 sends User 107 a standard opening screen. This opening screen (or a screen which follows it) will generally include a location for the user to type in a user name and a password, though these may be stored in the user's computer (e.g., as “cookies”) and downloaded when needed with no intervention from the user.

Note that the user experience is no different than if the user had logged-in to the ASP's own web site. This will generally be true throughout the entirety of the user transaction.

Step 1206 may be logged by Administrative Module 515, for billing or other administrative purposes.

In Step 1207, User 107 responds with a log-in name and password.

In Step 1208, Application 404 generates a database query to determine whether User 107 is an authorized user (e.g., a query to Database 801). This database query may take the form of the query described above in connection with FIG. 8. In one embodiment, Application 404 may have been designed under the assumption that it would be running on a central ASP server, with the user data present on a database server present at the same site. The application may therefore assume that one of three responses will be received: (a) the user's data is present and the password entered by the user matches the stored password; (b) the user's data is present but the password entered by the user does not match the stored password; or (c) the user's data is not present (e.g., the user ID is not found). The application may further assume that response (a) will lead to the user being logged-in, response (b) will lead to the user being prompted for another password, and response (c) will lead to a message that the user name cannot be found. Note that responses (b) and (c) may be treated as the same case, with the user being prompted to enter another user name and password.

In Step 1209, App. Server 508 routes the query to DB Server 301 over VLAN 504. DB Server 301 includes Partition 401, which stores Application 404 data.

In Step 1210, DB Administrative Module 1001 running on DB Server 301 intercepts the application query. This interception is necessary because, as is described above, the application expects that, if the user ID and password are valid, the data will be present locally, whereas in the described network, the user ID and password may be valid, but the data may not be locally available.

In Step 1211, DB Administrative Module 1001 determines whether the intercepted query requires intervention.

If intervention is required, processing continues to Step 1212, in which DB Administrative Module 1001 evaluates the query to determine the type of intervention needed. If the query is a new log-in, processing continues to Step 1213. If the query relates to a field which requires serialization, processing continues to the flowchart illustrated in FIG. 15, which is further described below. If the query requires another type of intervention, processing continues to Step 1214, which represents processing appropriate to the type of intervention required.

In this case, intervention is required because the query is an initial user log-in, so processing continues to Step 1213. As is described above, Application 404 expects to query its local database for the user name and password, and to return an error message (e.g., “Log-in incorrect”) if the supplied name or password do not match entries in the database. In the described network, however, the user data may be present at a remote database. For this reason, DB Administrative Module 1001 holds the query while it proceeds, meaning that the query is not yet released to Database 801. Note that, if the query had not required intervention (a “No” response in Step 1211), DB Administrative Module 1001 would have immediately released the query to Database 801 (Step 1215), and the interaction between Database 801 and Application 404 would have proceeded under the control of the application (Step 1216). This is true of the vast majority of database queries. As normal processing continues, each query triggers the same overall intervention process (Step 1217).

For example, after User 107 successfully logs-in to the application, he or she may call up a spreadsheet by choosing it from a list of available files. That operation would cause Application 404 to send a request to download the spreadsheet (or a portion) into main memory and send data to the user's computer for display. In Step 1217, DB Administrative Module 1001 would identify this request as a query to the database. Processing would then continue to Step 1210, at which DB Administrative Module 1001 would intercept and evaluate the query, and, in Step 1211 DB Administrative Module 1001 would determine that the query does not require intervention, so that the query would be released to Database 801 as per Step 1215. The request would then complete without further involvement by DB Administrative Module 1001.

User 107 might then alter a field in the spreadsheet by typing in a new value and hitting “enter.” This would cause Application 404 to send a request to overwrite the existing value in that field with the new value received from User 107. In Step 1217, DB Administrative Module 1001 would identify this as a query to the database, sending processing to Step 1210, at which DB Administrative Module 1001 would evaluate the query. Processing would then continue with Step 1211, at which DB Administrative Module 1001 would determine whether the query requires intervention. Because a data change can require serialization, DB Administrative Module 1001 would determine whether this particular field is subject to serialization (see below in connection with FIG. 15). If serialization is required, processing would continue as per FIG. 15. If no serialization is required, the request would be sent on to Database 801 as per Step 1215.

Returning to the original log-in process, in Step 1213, DB Administrative Module 1001 checks User Table 410 for the user name supplied by the query.

If the user name is not found in User Table 410, DB Administrative Module 1001 returns an indication to Application 404 that the user name is not present (Step 1218). This indication matches the indication that Application 404 would have received directly from Database 801. Application 404 then returns an error message to the user (Step 1219). This error message might, for example, prompt the user to re-enter the user name, or might ask whether the user is a new user, which would trigger a new user log-in process.

If the user name is found in User Table 410, DB Administrative Module 1001 then checks to determine if the user's data is stored on DB Server 301 (Step 1220). In one embodiment, this is handled by checking whether the flag is set in Data Present Column 902. In other embodiments, which are described above, this may be handled by checking Time Stamp Column 905, or this step may be omitted if all locally stored data is presumed valid or if the process by which User 107 was initially routed to DB Server 301 was designed to select a DB server which has currently valid data for User 107.

If the data present flag is set (the “yes” path from Step 1220), processing continues to Step 1215, resulting in the query being released to Database 801, and Step 1216, in which Application 404 and Database 801 proceed with normal processing. Because this query is an initial log-in, normal processing will ordinarily involve comparing the password supplied by User 107 with the password stored for this user in Database 801.

Assuming the password matches, processing proceeds through several loops. Operations which do not involve a database query do not require any intervention by DB Administrative Module 1001, and therefore loop between Step 1216 and Step 1217. Operations which involve a database query proceed from Step 1216 back to Step 1211, with the processing path from 1211 dependent on whether the query requires intervention. If no intervention is required, processing will proceed back to Step 1215. If intervention is required, processing proceeds to Step 1212. Processing continues in these loops until the user terminates the session.

Returning to the initial log-in scenario, the “No” path from Step 1220 is chosen if User 107's data is not present at DB Server 301. In this case, DB Server Column 904 from User Table 410 is examined to determine which other DB servers have the user's data, and in particular to determine if one of the listed servers is located at Leaf 104 (Step 1221). As is described above, the IP addresses listed in DB Server Column 904 include information regarding the leaf at which the DB servers are located, so that an evaluation of those addresses will reveal whether any of those servers is located at Leaf 104.

If data is present at another DB server at Leaf 104 (the “Yes” path from 1221), DB Administrative Module 1001 returns a message to Stub 603, informing the stub that the data are present at a different local DB server. Stub 603 then specifies that different DB server as the destination for communications from Application 404. (Step 1222). Processing then continues from Step 1215.

The case in which data is not present at another DB server at Leaf 104 (the “No” path from Step 1221) is described below in connection with FIG. 13.

FIG. 13 illustrates the operation of the system when data for a particular user are not present at the leaf to which the user logs in, e.g., the “No” path from FIG. 12, Step 1221.

In Step 1301, DB Administrative Module 1001 performs a look-up in User Table 410 to select one of the remote DB servers containing the user's data.

Ordinarily, User 107's data for Application 404 will be present on a number of leaves (e.g., five). Selection of the particular leaf from which the data will be downloaded may be handled in a number of ways. For example, the leaf may be selected at random, or it may be selected based on proximity (e.g., leaf identifiers may be assigned so that leaves with similar identifiers (e.g., close numbers) are closer than leaves with less similar identifiers), or based on current usage (e.g., each leaf could periodically post information regarding its current usage, with such information stored in a table at each leaf, with selection based on the remote leaf which is currently least used), or any other suitable selection method may be used.

In Step 1302, Communications Manager 518, running on DB Server 301, adds an external communication request to Communications Queue 519. Because this is a request for a download of user data, it is assigned the highest priority in the queue (assuming no other similar requests are already present in the queue, in which event the requests may be prioritized in the order received).

In Step 1303, External Gateway 302 sends the communication on to the remote leaf, using VPN 117.

In Step 1304, the remote leaf receives the request and routes it to the remote DB server identified in the request.

In Step 1305, the DB administrative module running on the DB server to which the request was routed identifies the request as an external request for user data. In response, the remote DB administrative module copies that portion of the database which contains data for the identified user. In one embodiment, this process does not involve programming from the application which created the database. In another embodiment, the application's import/export logic may be used. This alternative could, however, introduce complexity and latency, since different applications may handle import/export requests in differing manners.

In Step 1306, the DB administrative module on the remote DB server queues the external communication request with a high priority, since the request relates to a download of user data.

In Step 1307, the remote external gateway sends the data (using the VPN protocol) addressed to DB Server 301.

In Step 1308, the data is received by External Gateway 302 and is routed to DB Server 301.

In Step 1309, DB Administrative Module 1001 stores the user's data in Database 801. As is discussed above, this process may be handled by programming in DB Administrative Module 1001, rather than by the application's import logic.

Note that the transfer of user data may occur in stages, with a higher priority assigned to the data required by the specific request (e.g., the password/user name). Such prioritization may introduce additional complexity, since it requires the system to identify the particular data which is needed and to provide that data out of order. In a simpler embodiment, the system simply identifies all of the data associated with the user and provides all of the data in one “chunk.”

In Step 1310, DB Administrative Module 1001 updates User Table 410 to indicate that data for User 107 is present on DB Server 301, including updating the time stamp and setting the data present flag for this user (in embodiments in which the data present flag is used).

From Step 1310, processing proceeds both to FIG. 12, Step 1220 (resulting in the “Yes” path from Step 1220, because the data is now present), and to Step 1311.

In Step 1311, DB Administrative Module 1001 causes a communication to be sent to every other DB server which contains Partition 401. This communication updates each other user table to indicate that this user's data is now present at DB Server 301.

In one embodiment, there is no maximum number of DB servers at which a user's data can be present. This may, however, result in a large amount of unnecessary data being stored, since, if a user logs on once from a particular location (e.g., a California-based user logs on once from New York), the data is maintained at the server that is closest to that location. Unless there is some mechanism to remove that user's data from that server, a single log-on from a distant location may force the system to maintain the user's data at that location, including updating that data whenever it changes at another server.

In another embodiment, a user's data may be stored at a maximum number of servers. In such an embodiment, at Step 1311 (or at some later point), the system would be required to determine if the addition of the user's data to DB Server 301 had caused the maximum to be exceeded. This could be done by DB Administrative Module 1001 examining DB Server Column 904 of User Table 410 to determine if the maximum number of servers had been exceeded. This, in turn, could trigger a command from DB Administrative Module 1001 that would cause one of the other DB servers to set the data present flag for that user to zero, thereby invalidating that user's data at that server (or, in the alternative, at the other server, updating the time stamp shown for DB Server 301 so that it shows a more recent entry than the time stamp for the other server, which would also have the effect of invalidating the user's data at that server). Simultaneously, DB Administrative Module 1001 could send a command to all other DB servers specifying that the selected server should be removed from the DB server column entry for this user at all user tables. Removal of the server from the user tables would mean that updates would not be sent to that server, and, if the user were to log-in at a new server which did not contain the user's data, that new server would not look to the deleted server for a download of the data.

The selection of which remote DB server to choose for the invalidation of the user's data could be handled in a number of different ways. The simplest way to handle this would be to choose one of the other servers at random. This would create the possibility, however, that data would be deleted from a server which the user ordinarily uses, thereby creating latency the next time the user logs-in to that server.

An alternative method would be to include information in the user table indicating the most recent log-in at each DB server listed in Column 904. Note that this information might be different from the information in Time Stamp Column 905, since the time stamp information is updated whenever the user's data is updated. Such updates can occur when the user logs-in to that server, but can also occur when the user logs-in to another server, and makes a change which is then sent to all other servers with the user's data.

If the user table contained the time of the most recent user log-in for each server listed in DB Server Column 904, the least-recently used server could then be selected as the server from which the user's data would be removed.

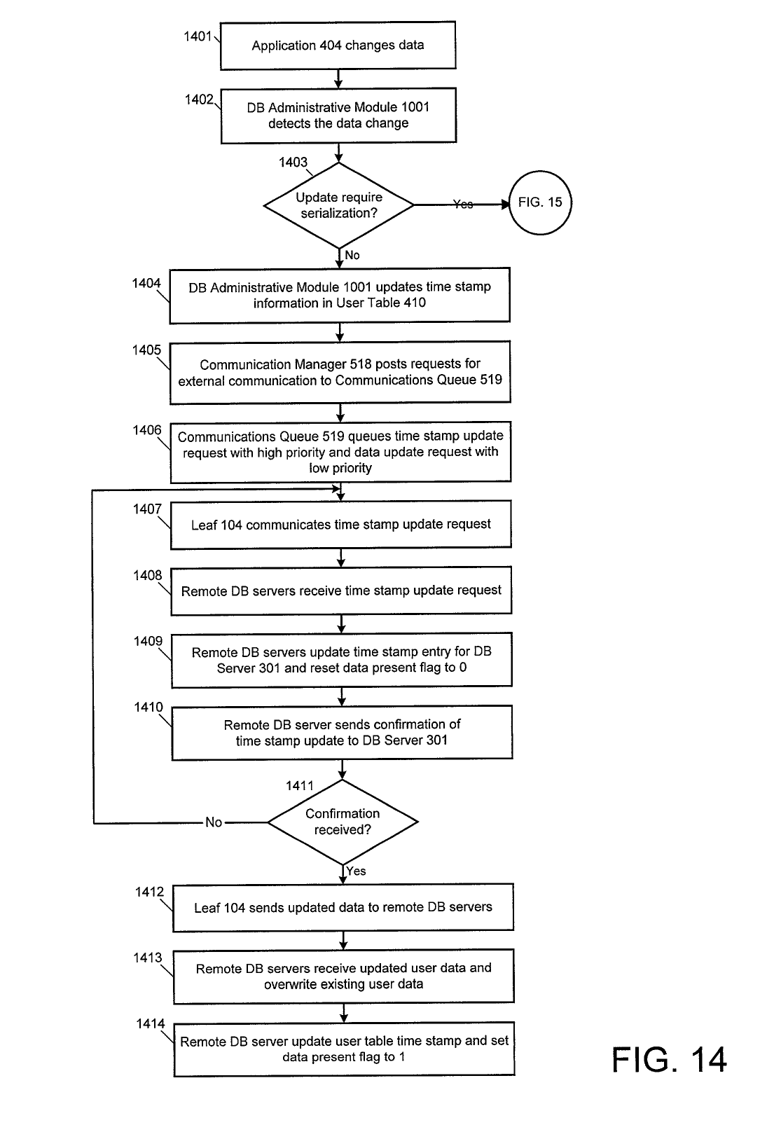

FIG. 14 contains a flowchart illustrating the process of updating user data and time stamps in remote sites. For the sake of clarity, certain steps which are described in connection with FIGS. 12 and 13 are omitted in FIG. 14 (e.g., details of the communication path).

In Step 1401, Application 404 causes a change to the user's data.

In Step 1402, DB Administrative Module 1001 detects the application-database communication which causes the change to the database.

In Step 1403, DB Administrative Module 1001 checks User Table 410 to determine if the change affects a field which is subject to serialization. Serialization is described below in connection with FIG. 15. If no serialization is required, processing continues to Step 1404. If serialization is required, processing continues to the flowchart illustrated in FIG. 15.

In Step 1404, DB Administrative Module 1001 updates the time stamp information for the current user in User Table 410, so that the time stamp information matches the current time stamp from Time Stamp Counter 520. This update is accomplished immediately.

In Step 1405, DB Administrative Module 1001 causes Communications Manager 518 to post two requests for external communication to Communications Queue 519. Each communication is directed at each other DB server which contains a copy of the same user's data in the same partition (e.g., each other DB server listed for this user in DB Server Column 604).

In Step 1406, these requests are queued in Communications Queue 519. The first request is for a communication updating the time stamp information in each other DB server. This request is posted with a high priority, and should therefore be handled relatively quickly. This request includes the time stamp value used by DB Server 301 when User Table 410 was updated to reflect the changes in the user's data.

The second request is for a transmission of the updated user data. This request is posted with a low priority, so that it might be delayed for a significant period while other traffic takes precedence.

Note that queuing the communication request does not cause the data to actually be copied. This occurs only when the request reaches the top of the communications queue, at which point the user's data is copied for transmission to other DB servers. If the user makes a second change prior to the data actually being copied and transmitted, there is no need to add a second request for a transmission of the updated user data to the queue, since the original request will pick up all of the changes made. Thus, if a user makes multiple changes to the database (e.g., if the user is using a spreadsheet or word processor and enters a large amount of data), those changes will not force a separate communication every time a change is recorded in the database (e.g., every time the user saves changes or the application automatically triggers a save). If the user is logged-on for a long period of time, multiple communications may occur, since an update request which is triggered by the user's first change may reach the top of the communications queue while the user is still logged-on and entering changes. Such cases increase the amount of traffic necessary (since a single user session may give rise to multiple updates), but increase redundancy, since if the user's machine crashes, or if the leaf the user is logged-on at crashes, the user will at least be able to retrieve any changes made as of the time the last update was communicated to other DB servers.

In one embodiment, these two requests are sent only to the other DB servers which are listed in the user table for this partition as including data for this user. In an alternative embodiment, in which every user table includes time stamp information for every user, including user tables at DB servers which do not have that user's data, the time stamp update communication may be sent to every DB server which supports this partition.

In Step 1407, Leaf 104 sends the time stamp update request to all other DB servers containing data for this user in this partition.

In Step 1408, the time stamp update communication is received at the remote DB servers.

In Step 1409, the DB administrative modules running on the remote DB servers update the user table for the relevant partition. The update causes the time stamp associated with DB Server 301 to be reset to the time stamp sent out with the communication from DB Server 301. The remote DB administrative modules also reset the data present flag for this user's data in this partition to zero. As is described above, in another embodiment no data present flag may be present. In such embodiments, the time stamp may serve the function of indicating that data has changed in another server. In yet another embodiment, data may be presumed valid at all servers.

In Step 1410, the remote DB servers send DB Server 301 a confirmation that the updated time stamp information was received. This information is necessary, since remote DB servers may have temporarily lost the ability to externally communicate (e.g., if the associated ISP had gone down), and DB Server 301 must send out additional time stamp updates if no confirmation is received.

In Step 1411, DB Administrative Module 1001 determines whether confirmation has been received. If no confirmation is received from a particular DB server in some reasonable time (the “No” path out of Step 1411), processing loops back to Step 1407, and the time stamp update request is resent. If confirmation is received, processing proceeds to Step 1412. Note that Step 1412 may proceed while DB Administrative Module 1001 is waiting for receipt of confirmation, though it will have to be cancelled if no confirmation is received. Note also that the loop between Steps 1411 and 1407 may relate to only one of the remote DB servers, and that processing may continue on to Step 1412 for other remote DB servers.

In Step 1412, Leaf 104 communicates the updated user data to the remote DB servers.

In Step 1413, the remote DB servers receive the updated user data and overwrite the existing user data with the new data.

In Step 1414, each remote DB server updates the user table present in the relevant partition. The update includes changing the time stamp value associated with the data in that server to the value current as of the time the update is performed. The update also includes setting the data present flag to one, since the most recent version of the data is now present (as is described above, in a different embodiment, the updated time stamp value may be used to determine if the local data is valid, so that no data present flag is necessary).

In one embodiment, a user's data is associated with a single time stamp, and is treated as a unit. Thus, even a relatively minor update to the user's data causes the entire database associated with the user to be copied to all remote DB servers having that user's data. This embodiment does not require DB Administrative Module 1001 to understand the details of each application's database. Instead, DB Administrative Module 1001 need understand only where the user's data begins and ends, since no other information is needed to copy the entirety of the user's data to remote sites.

In most cases, however, a user change will affect only a small percentage of that user's data. By copying and transmitting all of the user's data every time a change is made, this embodiment may require the transmission of a large amount of unnecessary information.

In another embodiment, DB Administrative Module 1001 is capable of sending out “incremental” updates, constituting only those portions of the user's data which have actually changed. Many applications already support incremental updating, e.g., for backup purposes. DB Administrative Module 1001 could be designed to compare the state of the user's data before and after the changes, and transmit only those portions which have changed. Alternatively, if the underlying application already supports incremental updating, DB Administrative Module 1001 can be designed to formulate a query designed to cause the application to output the incrementally changed data, which can then be transmitted to the remote sites and integrated with data at those sites, using logic native to the applications. This embodiment has the advantage of minimizing transmissions of information, but requires additional complexity, since DB Administrative Module 1001 is required to either identify incremental changes or to use incremental update capability in the applications, thereby requiring DB Administrative Module 1001 to understand such capability in each of the applications.

In another embodiment, each user's data may be broken into divisions, with a time stamp associated with each division. For example, each user's data may be broken into four divisions, or data may be broken into divisions of equal sizes. In this embodiment, communication of new information is limited to those divisions which have actually changed. This embodiment does not require identifying the exact portions of the database which have changed, and therefore does not require any actual understanding of that database. Instead, DB Administrative Module 1001 is required only to keep track of which divisions have been altered. If an division has been altered, the entirety of that division is then copied and communicated to remote DB servers.

As is described above, in another embodiment updated time stamp information accompanies the updated data, and is therefore not available before the data is present. In such an embodiment, data stored locally is presumed valid, and the time stamps are used only for purposes of determining prioritization between two apparently simultaneous updates (e.g., updates occurring as a result of two users who are logged-on at the same time to a multi-user database).

FIG. 15 illustrates the serialization process, which is used for cases in which it is essential that consistency be maintained in data stored in different leaves. Because a user's data may be stored on multiple leaves, when a user updates data at a single leaf, data at other leaves are no longer current. The process described above for updating data at remote leaves will generally be sufficient for most types of data.

This update process, however, does not occur in real-time, but instead involves some delay prior to updates being provided to remote leaves. Thus, for certain cases in which absolute consistency of data is required, the general updating process is not sufficient.

For example, a banking application may provide a user with his or her bank balance and the ability to transfer the balance to other accounts. The balance information constitutes user data, stored in the appropriate partition. If a user were to log-in and transfer the balance to another account, a delay in synchronizing that balance data in remote leaves could be disastrous, since such a delay could allow the user (or an accomplice) to log in a second time in such a way that the log-in would be routed to a second DB server with an old copy of the balance data, thereby allowing the user to deplete the balance a second time. This could happen, for example, if an accomplice logged-in using the user's name and password from a location across the country (assuming the system routes log-ins to nearby leaves). This could also happen if the initial leaf were to temporarily lose contact with the rest of the system, thereby rendering it impossible for that leaf to update other leaves for some period, during which the user could login to another leaf.

To take another example, a database might be shared by a number of users This could happen, for example, if the database constituted data for a sales organization, and numerous salespeople were given access to it. Multi-user databases are common, and generally include some mechanism to avoid plural users making simultaneous changes to key data fields. For example, if the sales organization database keeps track of the number of widgets available for sale, with software designed to accept an order only if a sufficient quantity of goods is in stock, two salespeople might simultaneously enter orders which cannot both be filled. In such a case, the database must have some mechanism for deciding which of the two orders to accept. This can be done, for example, through record locking, in which the first user to access the data is given exclusive use of that data until he or she logs off, so that simultaneous alterations cannot occur.

The described system requires a different mechanism for maintaining consistency among key data fields, since an application running on one app. server will ordinarily have no mechanism by which it can understand that other instantiations of the same application may be running on other servers, with other users accessing the same data. The serialization process is designed to handle such cases.

In overview, the serialization process operates by identifying data fields which must be maintained at a single value across all servers. An attempt to change data in one of those fields results in the field being locked at the local server, so it cannot be changed again. An “election” is then held involving other servers which have a copy of the same field. If the field is unlocked in more than half of the other servers, the change is accepted and the field's value is immediately changed in the local servers, with the user's data invalidated in all other servers (e.g., the data present flag may be set to zero).

If, on the other hand, at least half of the remote servers reply that the field is already locked, this indicates that another simultaneous attempt is being made to alter the field, and that this attempt has already resulted in changes to at least half of the servers. In such a case, the other attempt to change the field has “won” the election. The local server backs out its change and unlocks the field, and causes any other servers which locked the field changed based on the local server's request to unlock. This frees those servers to accept the other change.

The serialization process is described in detail in connection with the flowchart shown in FIG. 15.

Use of the serialization process requires that the ASP identify those fields which require serialization. Those fields are then listed in Lock Column 903 of User Table 410, as shown in FIG. 9. Note that the same fields are listed for each user (e.g., Field A and Field B), since User Table 410 relates to a single partition, which stores data for a single application. Each user's data for that application will have the same fields requiring serialization. Data in other partitions are created by other applications, and will have different serialization fields (in many cases an application will not require any serialization fields at all).

FIG. 15 illustrates the processing which follows the “Serialization” path out of Step 1212 from FIG. 12, or from FIG. 14, Step 1403. As is described above, FIG. 12 shows processing which occurs at Leaf 104 during a database transaction. The Serialization path out of Step 1212 is followed if DB Administrative Module 1001 determines that the query requires a change to a database field which has been identified on Lock Column 903 from User Table 410 (FIG. 9) as requiring serialization. In this case, Lock Column 903 lists two hypothetical fields: Field A and Field B. When DB Administrative Module 1001 identifies a query which requires an alteration to a database field, it then compares the field specified in the query to Lock Column 903 to determine whether a listed field is affected. If so, processing continues as specified in FIG. 15.

In this example, it will be assumed that a user has entered a request to change Field A. In Step 1501, DB Administrative Module 1001 examines Lock Column 903 to determine if Field A is locked. If Field A is already locked, the query does not have the right to alter the field, and an error message is sent to the application (Step 1502), following which the serialization process terminates. This will ordinarily occur if an attempt to alter the field has already been received from a remote leaf. In such a case, the local DB server is already participating in the remote server's attempt to alter the field, so that a local attempt to alter the same field cannot be accepted.

If Field A is not locked, DB Administrative Module 1001 locks Field A by changing the value in Lock Column 410 from “U” to “L.” (Step 1503.) Once Field A is locked, the local DB server will no longer be able to participate in a remote server's attempt to modify the field.

As should be understood, a variety of mechanisms may be used to indicate that a field is locked or unlocked, including listing the locked fields in Lock Column 903 and removing fields when the fields are unlocked. In another embodiment, Lock Column 903 may list those fields which are capable of being locked, with a flag for each field which is set or cleared to indicate whether the field is currently locked or unlocked.

In Step 1504, DB Administrative Module 1001 sends an election request to each of the other DB servers listed for this user's data in DB Server Column 904. The election request asks each of the remote DB servers to determine whether Field A has value V1, and whether Field A is unlocked. Value V1 represents the value stored in Field A at the local server (DB Server 301) prior to the user request to change the field.

In Step 1505, each remote DB server receives the election request over VPN 117, and the DB administrative module present on each remote DB server queries the remote database to determine if field A has the value V1. If remote field A does not have that value (“No” path out of Step 1505), this is an indication that a serious problem has occurred, since field A is a serialization field, which should have the same value in all databases. The serialization process is designed to insure that this field cannot change in one database without forcing the same change on all other databases containing the same field.

The “No” path from Step 1505 therefore leads to an error handling routine (Step 1506). The details of this routine may vary depending on the nature of the application and the type of data involved. In some cases, the application may already have some mechanism to deal with cases in which two supposedly synchronized fields do not have the same value. That mechanism may or may not be compatible with the overall system architecture.

In one embodiment, this error handling routine may issue a distress call to NOC 102, indicating that different values have been encountered in the serialization process. The error handling routine may then automatically instruct all DB servers with data for this user to freeze processing on that data, so that administrators at NOC 102 will have time to determine what has occurred and how it will be rectified.

If the remote Field A has the expected value of V1 (“Yes” path from Step 1505), the remote DB administrative module examines the remote user table to determine if Field A is locked. (Step 1507.) In one embodiment, each remote DB administrative module first examines the data present flag to determine if the user's data is currently valid on that server. If the data is not valid, the remote DB server would return a message indicating that it does not have a valid copy of the user's data and removing itself from the election. As is described above, in another embodiment this check can be done by comparing time stamps to determine if another DB server stores a more up-to-date version of the user's data.

If Field A is locked in the remote user table (“Yes” path out of Step 1507), the remote DB server returns a message to DB Administrative Module 1001 indicating that Field A is locked (Step 1508). Processing relating to that remote DB server then continues with Step 1501. This condition will ordinarily only exist if the remote DB server is already participating in an attempt to change the field which was initiated by a DB server other than DB Server 301.

If the remote Field A is not locked (“No” path out of Step 1507), the remote DB administrative module locks field A in the remote database (Step 1509), and returns an indication to the originating server that remote field A was originally unlocked (Step 1510).

In Step 1511, DB Administrative Module 1001 (located at the originating server) receives responses from remote DB servers. As should be understood, those responses may be received at different times, so that the process shown in FIG. 15 may be at multiple points at the same time, e.g., Step 1511 may have been reached for one remote DB server while another remote DB server is still at Step 1505.

In Step 1512, DB Administrative Module 1001 determines whether more than half of the remote DB servers listed in DB Server Column 904 have responded. If not (“No” path from Step 1512), DB Administrative Module 1001 determines whether the operation has “timed out,” indicating that an unreasonable amount of time has passed without a sufficient number of responses (Step 1513). This may be a result of a breakdown in communications, problems with other servers, or some other unanticipated difficulty. In such a case, (“Yes” path out of Step 1513), processing continues to Step 1519, which is described below.

If the operation has not timed out (“No” exit from Step 1513), processing loops back to Step 1512.

If DB Administrative Module 1001 determines that more than half of the remote DB servers have responded (“Yes” path out of Step 1512), it then determines if more than half of the remote DB servers responded that Field A was originally unlocked. (Step 1514). This evaluation requires that half of all of the queried remote servers responded affirmatively, rather than that half of the respondees were affirmative. Thus, if DB Server Column 904 indicated that data for this particular user was held at five remote servers, a “Yes” result from Step 1512 would require that at least three of the remote servers responded, and a “Yes” result from Step 1514 would require that at least three of the responses were affirmative.

If DB Administrative Module 1001 determines that more than half of the remote DB servers originally had field A unlocked (“Yes” path out of Step 1514), this indicates that the DB Server 301 has “won” the election, meaning that more than half of the DB servers which contain this user's data are able to participate in the change initiated by DB Server 301. That change will therefore be entered throughout the network.

DB Administrative Module 1001 then releases the application command from the app. server to the database, so that Field A is changed from its initial value (V1) to its new value (V2), and also causes Field A to be unlocked (Step 1515). The transaction is now complete on the local server.

DB Administrative Module 1001 also sends instructions to all of the remote DB servers listed in DB Server Column 904 (Step 1516.) Those instructions cause each remote DB server to unlock field A and to update the user table so that the time stamp for the user data of which field A is a part will indicate that this data has been updated at the source DB server. Once the time stamp has been updated, any attempt to access the data at the remote server will cause the remote server to recognize that newer data is present at the source DB server, thereby causing the remote server to download the updated data. In this way, the remote DB server will necessarily receive a correct copy of the data for field A. As should be understood, the remote DB server may also receive a correct copy of the data for field A in the normal synchronization process, if that occurs before a user attempts to access that data at the remote server. In embodiments which include a data present flag, the updated time stamp may cause each of the remote DB servers to reset the data present flag for this user's data to zero, thereby indicating that the data is invalid.

DB Administrative Module 1001 then waits to receive confirmation from the remote DB servers that the new time stamp has been received (Step 1517). If confirmation is received (“Yes” path out of Step 1517), processing ends, at least as far as the interaction between DB Administrative Module 1001 and that particular remote DB server is concerned. If confirmation is not received (“No” path out of Step 1517), processing loops back to Step 1516, and DB Administrative Module 1001 resends the command. If no reply is received from a particular DB server after a reasonable period of time, DB Administrative Module 1001 may invoke an error-handling routine, which may include notifying NOC 102 of a potential serialization problem.

If DB Administrative Module 1001 determines that more than half of the remote DB servers did not respond that field A was unlocked (“No” path out of Step 1514), it then determines whether half or more of the remote DB servers responded that field A was originally locked (Step 1518). If the answer is “no,” this indicates that, although half or more of the remote DB servers have responded, the number of responses in the “yes” category does not yet exceed half of the remote DB servers, and the number of responses in the “no” category does not yet equal half of the remote DB servers. In such a case (“No” path from Step 1518), processing returns to Step 1513 for a time-out determination.

If half or more the remote DB servers have responded that field A was locked (the “Yes” path from Step 1518), this means that another DB server has initiated an attempt to change Field A, and that at least half of the relevant DB servers are already participating in that process. It is therefore impossible for DB Server 301 to “win” the election. Processing proceeds to Step 1519, in which DB Administrative Module 1001 unlocks Field A, thereby reversing Step 1503. This allows DB Server 301 to participate in the change which is being attempted by the other DB server.

As should be understood, if DB Server Column 904 includes an even number of servers, it is possible that two simultaneous election attempts will each lock the field in half of the available servers. In such a case, neither election will ever reach the “Yes” result from Step 1514, so that neither election will complete successfully. In such a case, the flowchart shown in FIG. 15 would ultimately result in both elections “timing-out,” so that neither is successfully completed.

A result in which two elections each fails may not be unacceptable, since this means that the original value for the field remains in place at all servers, and a new attempt to change that field will initiate a new election. It is unlikely that repeated election attempts would eventually result in one attempt gaining more than half of the servers, thereby “winning” the election.

If a “tie” result is deemed unacceptable, Step 1521 can include the transmission of an error message to NOC 102, which could track such messages to determine if multiple attempts to change the same field have simultaneously failed. NOC 102 could initiate an error-handling protocol in such a case, the details of which might depend on the particular application. In one embodiment, this error-handling routine might intervene in the elections to mandate that the election which started first (e.g., has the earliest time stamp), is declared the winner.

In Step 1520, DB Administrative Module 1001 instructs remote DB servers to reverse Step 1509, thereby causing them to unlock field A. Note that this only affects those remote DB servers which reached Step 1509 in the first place, and therefore only affects those remote DB servers which reported that field A was originally unlocked.

In Step 1521, DB Administrative Module 1001 sends an error message to the application indicating that the requested update to field A did not occur. Error handling from that point depends on the details of the particular application.

In another embodiment, the serialization process does not include the election shown in FIG. 15, but is instead controlled by a DB server which is designated as the “owner” of the relevant field. In this embodiment, the owner of the field is the DB server which has most recently made a successful change to the field, with the initial owner being the DB server at which the user initially entered information into the field. The identity of the DB server which constitutes the current owner of a serialization field may be stored in Column 903 of User Table 410.

In this embodiment, when a DB server wants to change a field which requires serialization (i.e., a field listed in Column 903), the DB server sends to the owner an indication that it intends to change the field, along with a time stamp reflecting the time of the change. The owner compares that time stamp to the time stamp entered by the owner at the time of the most recent change to the field (as is described above, the owner constitutes the DB server which made the most recent change). If the time stamp which accompanies the request to change the field is more recent than the time stamp held by the owner, the owner authorizes the change, and relinquishes control of the field. Control is relinquished by the owner changing the identification of the DB server listed in Column 903 to the identity of the DB server which requested authorization for the change. The DB server which requested authorization to change the field then enters the change and sends out a new time stamp and the new ownership information to all other DB servers listed in DB Server Column 904.

In this embodiment, if the old owner receives a second request to change the field prior to the new ownership information being sent to all relevant DB servers, the old owner redirects that request to the new owner.

In this embodiment, the election described in FIG. 15 is carried out only if the DB server which has requested authorization to change the field is unable to communicate with the existing owner. This can occur if communications have been interrupted or if the DB server which constitutes the existing owner is not operating correctly.

In such a case, the DB server attempting to change the field would first attempt to contact the owner. When this attempt fails, the DB server would then initiate the election process described in FIG. 15. Step 1515 would include the source DB server altering the ownership information in Column 903 so that it identifies the source DB server rather than the original owner. In Step 1516, that information would be sent to remote DB servers listed in DB Server Column 904. The original owner would not immediately receive the new ownership information, of course, since the election is only held if the original owner is out of communication with the DB server seeking to change the field. Since the original owner would be listed in DB Server Column 904, it would eventually receive the new ownership information, since that information is repeatedly sent out until confirmation is received (i.e., the loop between Steps 1516 and 1517).

In yet another embodiment of the serialization process, control over the serialization process may be exercised by NOC 102. In this embodiment, NOC 102 stores the time stamp associated with the most recent successful change to the field. If a DB server wants to change the field, that server first contacts NOC 102 for permission. That communication includes a first time stamp, which is associated with the change requested by that DB server, and a second time stamp, which is the time stamp held by the DB server for the most recent prior change to the field known to the DB server. NOC 102 compares the second time stamp with the time stamp information held by NOC 102. If the two match, this means that the DB server requesting the change has already recorded the most recent change to the field which is known to NOC 102. The value of that field at that DB server is therefore up-to-date, and NOC 102 authorizes the change. NOC 102 then updates the time stamp information it has recorded, so that the time stamp information now reflects the new change. The DB server enters the change and, in the normal course, sends out information about that change to other servers.

This embodiment relies upon NOC 102 to control the serialization process, and therefore does not require any election. This process will ordinarily take place more quickly than the election process described in FIG. 15, since it does not require multiple communications among DB servers. The NOC-oriented process, however, contains a single point of failure, since if NOC 102 becomes unavailable, either because of communications problems or because of internal technical problems, it is impossible to change any serialization fields.

UNIVERSAL LOG-IN EMBODIMENTS

The embodiments described above rely upon the log-in procedures of each application. Thus, each time a user logs-in to an application, the user is required to comply with the application's log-in procedures (e.g., entry of a user ID and password). If a user wants to use a second application, this requires a second log-in.

These embodiments are designed to make maximum use of existing ASP applications, so that no change to the application log-in process is required. The only system intervention in the log-in process concerns looking up the user in User Table 410 and downloading data from a remote leaf, if necessary (e.g., FIG. 12, Steps 1213, 1220, 1221, 1222, FIG. 13). This process does not require any alteration to the normal application log-in procedure, other than a pause in that procedure, which should be invisible to the application (except for the possibility that a “time-out” parameter may have to be increased).

Use of the existing application log-in procedures does, however, create certain disadvantages. First, the log-in process is necessarily cumbersome, since a user first invokes an application web-site, is then redirected to a nearby system leaf which serves up the application's log-in screen, then must enter a user ID and password, and then must wait while the ID and password are validated. While these steps are necessary, the burden created may be magnified if the user wants to log in to a second application. In general, it would be advantageous to encourage users to use multiple applications, since this will increase system usage. It would therefore be useful to streamline the log-in process, particularly where a user has already logged-in to one application, and therefore established his or her identity and authorization.

A second consequence of the application log-in model concerns the inability of the system to identify individual users and to track individual users across multiple applications. Each application has the ability to identify particular users and, if desired, to track the activities of those users. Applications are able to do this because a user is required to log-in using a unique user ID. The overall system, however, has no mechanism for determining whether a user who is attempting to log-in to an application is the same user who is already logged-in to a different application. This is a consequence of the fact that user IDs are assigned by individual applications, so that a different ID may be assigned by two different applications to the same user, or the same ID may be assigned by two different applications to two different users. This has no negative consequences in the single application model, but does render it impossible for the system to track users as unique individuals.

Having the ability to track users as individuals could provide significant benefits to the overall system. Such information could, for example, be used for marketing purposes, as the system could know which applications the user uses, and could suggest to the user additional applications which might complement those already in use. The system could also use such information to pre-load the user's data, so that if a user logs in to a new leaf using one application, the system could automatically download the user's data from other applications to that leaf, even before the user invokes those other applications.

In one embodiment, a system designed to avoid the limitations of the single application model may make use of a “universal log-in,” in which, once a user is logged-in to a single application, the user is also provided access to some or all of the other applications available on the system. Access to the other applications does not require a separate log-in.

One embodiment of the universal log-in model uses a global user ID and a global password, each of which is used for all applications. In one embodiment, the global user ID may be assigned to a user when the user initially logs-in to any of the applications supported by the system.

The assignment of the global user ID may be handled in several different ways. In one embodiment, the system may control all initial user log-ins. In this embodiment, when a user initially logs-on to an application, the redirection process initially takes the user to a system screen, rather than to a screen associated with the application. That initial system screen serves as a log-in to the entire system, rather than as a log-in to the particular application the user is attempting to invoke. The system screen asks the user to enter his or her global user ID. This allows the system to identify the user across applications.

The user's log-in to the application may be handled in one of several different ways. In one embodiment, the user's initial log-in to the system may serve to log the user in to all applications available on the system. In this embodiment, the initial system log-in screen may also ask the user for a global password. Entry of the global user ID and the global password then allow the user to invoke any of the applications without any additional log-in being required.

This embodiment would require some alteration to existing application log-in procedures, since such procedures are effectively being bypassed. In one embodiment, these modifications may be relatively minor, with existing application log-in logic being modified so that, instead of accepting the user ID and password as typed by the user, such information would be passed to the application by the network software which accepts the global user ID and global password from the user. In this embodiment, the applications would store the global user ID and global password in the application database (e.g., as is shown in FIG. 8, Columns 802 and 803). That storage would occur when the user logged-in for the first time. At such time, the system would assign a global user ID and global password and would provide those to the application, which would store them in the database as if they had been directly entered by the user. Then, when an already-registered user attempts to log-in, the system global log-in application would pass the global password and global ID to the application, which would perform a normal database check and would identify the user as an authorized user. This would, however, proceed in the background, without any interaction between the user and the application. The user would merely be required to enter the information once, at the global system log-in screen, and all further application log-ins would be handled by interaction between the system and the application, without the user being required to take any action or enter any information.

In a second embodiment, applications could be rewritten to remove the log-in procedure, so that, once an application is invoked, no ID or password would be required. Instead, user authorization would be handled by the system, on a global basis. The system would then provide the user ID information to the application, so that the application could identify which data corresponds to that particular user.

In another embodiment, once the user enters the global user ID, he or she is handed off to the standard application log-in screen. As is described above, the standard application log-in screen will generally require the user to enter a user ID and a password. In one embodiment, the user ID is the global user ID. In one embodiment, this field is automatically filled-in by the system, which uses the global user ID entered by the user in the system log-in screen, and copies that global user ID to the application log-in screen. Certain applications will allow information to be imported in this manner. Other applications may require some minor rewriting to allow the user ID field to be filled in from data imported from the system log-in screen, rather than from data entered directly by the user.

In this embodiment, the user uses the global user ID as an identifier to the application (which may be entered automatically or may be typed in by the user), but then separately enters a password for the application.

Use of a single user ID and a single password across all applications is more convenient for users, who only have to remember a single ID and password, rather than separate IDs and passwords for each application. In addition, since the necessary log-in information is gathered once, at the user's initial log-in, the effort required to log-in to a second application is reduced. This may encourage users to use more than one application.

Using a single user ID and a single password will, however, reduce the security of the user's data, since an attacker who gains access to one user ID and password (through spying on the user's communications, guessing, brute force attacks, etc.) will thereby have access to all of the user's data. In the real world, it is not clear that this would have a significant effect on overall security, since user IDs tend to be similar across applications, and tend to be easily guessable (e.g., the user's first initial and last name). Although users are supposed to choose unique, arbitrary strings for application passwords, in fact this puts a significant burden on users, who find it difficult to remember multiple arbitrary passwords. For this reason, a high percentage of users use the same password across applications, or very similar passwords. Therefore, while a global password would theoretically provide less security, it is not clear that the reduction in security would be all that significant.

Use of a global password might, however, create another security vulnerability. Because the global password is used across applications, there must be some mechanism for applying it not only to the first application the user uses, but also to all subsequent applications used by the user in the same session. If the global password is saved by the system during the user's session, an attacker who gains access to the system may be able to access the storage area at which the global passwords are being saved, and thereby gain access to the passwords themselves. The risk of such an outcome can be reduced by carefully protecting that storage location, including storing the passwords at a storage location which is not addressable over the Internet. In addition, since a user's global password need never be transmitted to any other leaf, each leaf can be designed so that the storage location temporarily holding the global passwords can only transmit those passwords to that leaf's DB servers, which need the passwords in order to log the user on to a new application. Transfers to any location other than a local DB server can be blocked, even if these transfers are the result of a request from another leaf.

The requirement that a global password be temporarily stored is a function of a system in which the same password is used across applications, but each application requires that the password be entered, and the entry is done automatically. This disadvantage can be eliminated under various circumstances, including the following: (a) a true universal log-in, in which the password is entered once and used once, providing the user with automatic access to all applications; or (b) a system in which the user is required to separately enter a password at each application.

It should also be understood that use of a universal log-in, with a single global user ID and a single global password, would require that the applications' normal log-in processes be bypassed. This would require a redesign of most ASP-type applications, since such applications are generally designed to require the user to enter a user ID and password prior to opening the application. ASPs may resist rewriting applications, particularly if the consequence of the change is to allow users to more easily invoke other applications, which other applications may be products from the ASP's competitors.

The universal log-in may therefore be best suited for a system which is dedicated to applications from a single ASP. A single-ASP system could include a suite of applications, all of them from the same ASP. In such a system, the ASP would have a strong incentive to encourage users to use as many of the applications as possible. A universal log-in would contribute to this.

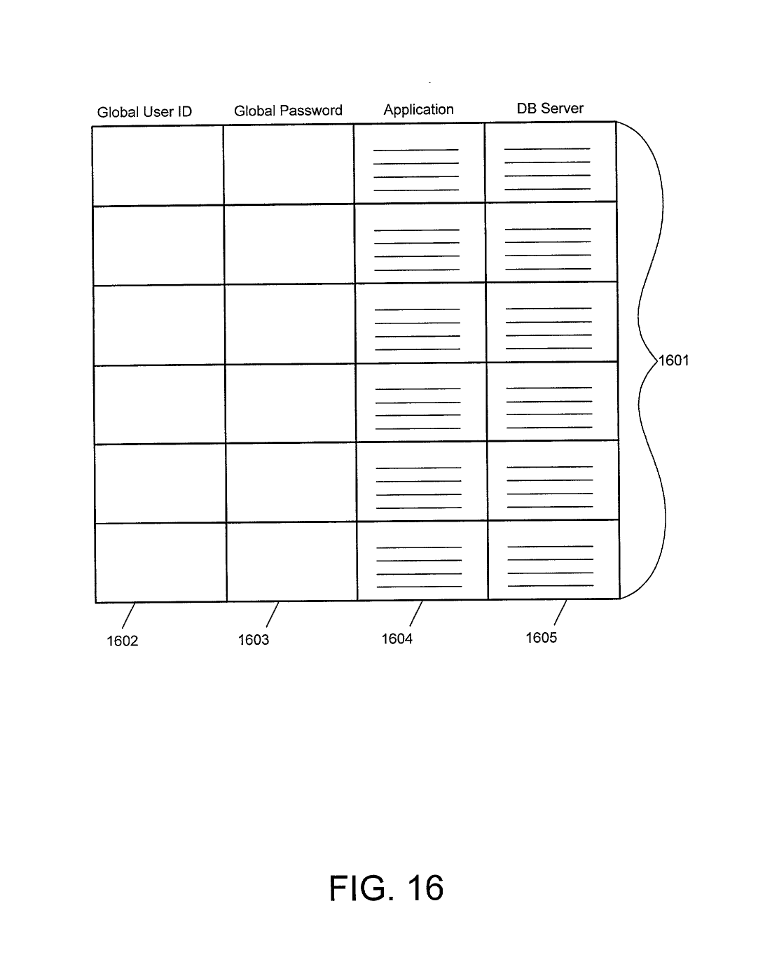

In one embodiment, the universal log-in system uses a global user table, such as that illustrated as Global User Table 1601 in FIG. 16. Global User Table 1601 includes Global User ID Column 1602, which includes a global user ID for every user registered with the system. Global Password Column 1603 includes a password for every user. Application Column 1604 lists each application for which the user has data stored somewhere in the network. An application is not listed unless the user has stored data which was generated by that application. Thus, if a user has previously used an application, but has no stored data, that application will not appear in Application Column 1604.

DB Server Column 1605 lists each D13 server at which the user's data is present. In one embodiment, the entirety of a user's data is stored on every DB server which contains any of that user's data. Thus, if a DB server contains a user's data for Application 404, it will also contain that user's data for Application 405, 406, etc. (e.g., if any portion of a partition is stored at a DB server, the entirety of that partition must be stored). In this embodiment, DB Server Column 1605 lists the DB servers which contain the entirety of the user's data.

In another embodiment, a DB server may include a user's data for one application, but not other applications. In this embodiment, DB Server Column 1605 must list DB servers on an application-by-application basis, e.g., the Column 1605 entry for User 107 must list those DB servers which store the user's data for Application 404, but must also separately list those DB servers which store the user's data for Application 405, etc. This alternate embodiment reduces overall storage, since downloading a user's data for one application does not require that the user's data be downloaded to the same DB server for all other applications. This alternate embodiment does not, however, make full use of the user-centric organization, since it may be more difficult and time-consuming to invoke multiple applications or to share data among applications if the user's data for different applications are not all stored on the same DB server.

The global user table may be stored at any appropriate location in the system, e.g., it may be stored at app. servers and/or DB servers.

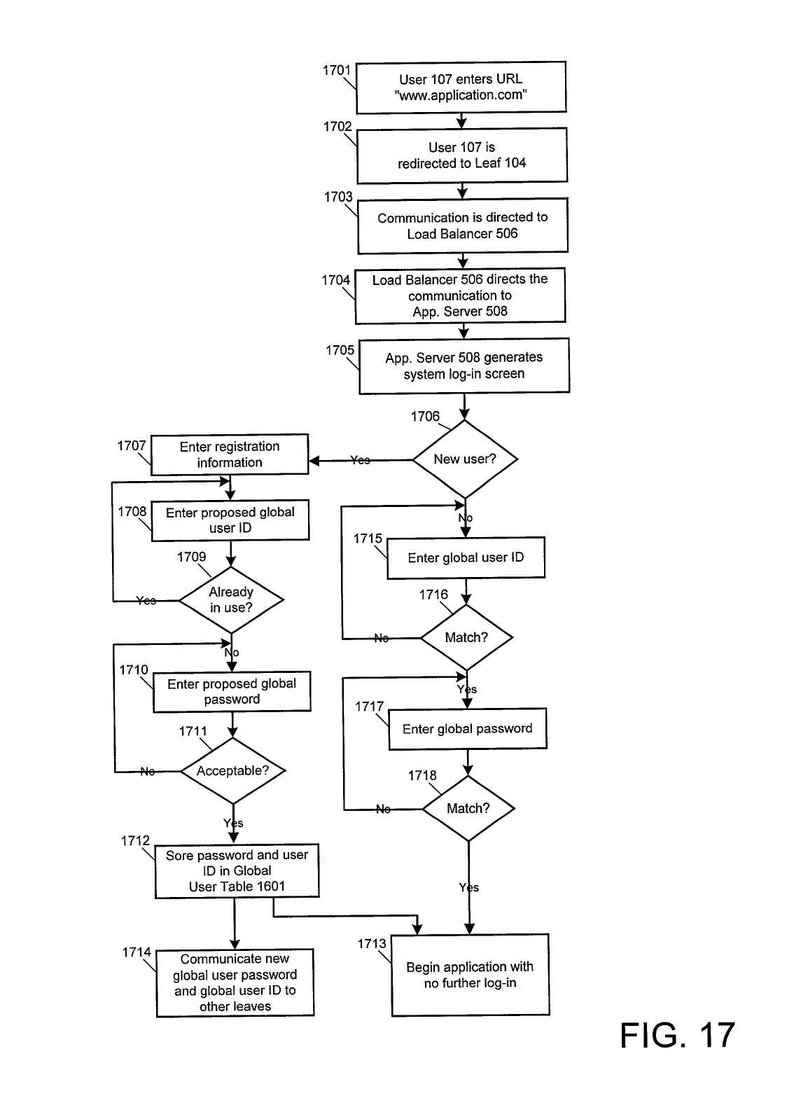

A flowchart demonstrating one embodiment of a universal log-in system is illustrated in FIG. 17. This flowchart shows the log-in process when the system handles all log-ins, and an initial log-in to the system allows the user to invoke any application supported by the system, with no additional log-in required.

In Step 1701, User 107 points his or her browser to a web site associated with the application. Note that, in a different embodiment, with a more centralized model, the user might instead invoke a web site associated with the overall system, with a choice of applications then being made based on selections provided by a system screen.

In Step 1702, User 107's browser is redirected to one of the system leaves (e.g., Leaf 104). This is the same process as is described above as Step 1202 in FIG. 12.

Steps 1703 and 1704 are the same as Steps 1203 and 1204 from FIG. 12. In the embodiment shown, the app. servers generate the system log-on screen and check the global password and global user ID. Thus, in this embodiment, the system-level programming necessary for these functions is stored on the app. servers. In addition, in this embodiment, a copy of the global user table is stored on each app. server. In other embodiments, either the programming, or the global user tables, or both, could be stored elsewhere on the leaf (e.g., the global user tables could be stored on the DB servers, with the app. servers making calls to the DB servers to obtain the information).

In Step 1705, App. Server 508 generates a system log-in screen, which comes up on the user's computer. This screen is not generated by the application, but is instead generated by the system. This log-in screen will ordinarily ask whether the user is a new user or a user who has already registered for the system, and will also ask for a user ID and password. This process may involve several screens.

In Step 1706, the user indicates whether he or she is a new user, or a user who has already registered.

If the user is a new user (“Yes” path out of Step 1706), the user then enters registration information (Step 1707). The system may, for example, ask for the user's name, address, email address, and other information which the system may find useful.

In Step 1708, the user is prompted to enter a proposed global user ID. In another embodiment, the system may automatically assign a global user ID, possibly based on registration information entered by the user during Step 1707.

In Step 1709, the system determines whether the proposed ID is already in use. It may do this by comparing the entered information to Global User Table Global User ID Column 1602.

If the proposed ID is already in use, processing loops back to Step 1708, and the user is prompted to enter another proposed ID (“Yes” path out of Step 1709).

If the proposed ID is not already in use (“No” path out of Step 1709), the user is prompted to enter a proposed global password (Step 1710).

In Step 1711, the system determines if the proposed global password is acceptable, based on system-specific criteria (e.g., there may be a requirement that a password include a certain number of characters, that it include both numbers and letters, that it not be a word found in the dictionary, etc.)

If the system determines that the proposed password is unacceptable (“No” path out of Step 1711), processing loops back to Step 1710, and the user is prompted to enter a different proposed password.

If the system determines that the proposed password is acceptable (“Yes” path out of Step 1711), the proposed global user ID and global password are accepted, and are stored by the system in Global User Table 1601 (Step 1712).

At this point, the user has been logged-in, and is able to initiate any application with no further log-ins required (Step 1713). Note that this is true for the initial application invoked by the user and for any later applications invoked during the same user session.

In Step 1714, the leaf communicates the new global user ID and global password to other leaves, in a manner similar to that described above in connection with user table updates (e.g., the description accompanying Step 1311 from FIG. 13, except that the communication would be initiated by the app. server rather than the DB server). This communication should be handled in a highly-secure manner, so that it may, for example, be encrypted.

Returning to Step 1706, if the user is a returning user, rather than a new user (“No” path out of Step 1706), the system asks the user to enter his or her global user ID (Step 1715).

App. Server 508 then checks the entered information against Global User ID Column 1602 in Global User Table 1601 (Step 1716). If no match is found (“No” path out of Step 1716), processing loops back to Step 1715, and the user is prompted to re-enter the global user ID. App. Server 508 may keep track of the number of entries attempted, and disconnect the user if the number of failures exceeds a preset number.

If the entered global user ID matches an entry in Global User ID Column 1602 (“Yes” path out of Step 1716), the user is then prompted to enter a global password (Step 1717).

In Step 1718, App. Server 508 checks the entered information against Global User Table 1601, checking to determine if the entered password matches the entry in Global Password Column 1603 which is associated with (e.g., on the same row as) the global user ID entered by the user.

If the entered password does not match (“No” path out of Step 1718), processing loops back to Step 1717, and the user is prompted to enter another password. As before, App. Server 508 may include a maximum number of attempts, following which the user is disconnected. Steps 1715-1718 may be consolidated into two steps, in which the user first enters both the ID and password, and both are checked, after which the user is either logged-in or receives a prompt asking for re-entry of the ID and password.

If the password entered by the user matches the entry in Global Password Column 1603 (“Yes” path out of Step 1718), the user is logged-in, and is allowed to invoke the application (Step 1713). As is described above, this step requires no additional log-in, and no additional log-in is required for any additional applications invoked by the user during the same session.

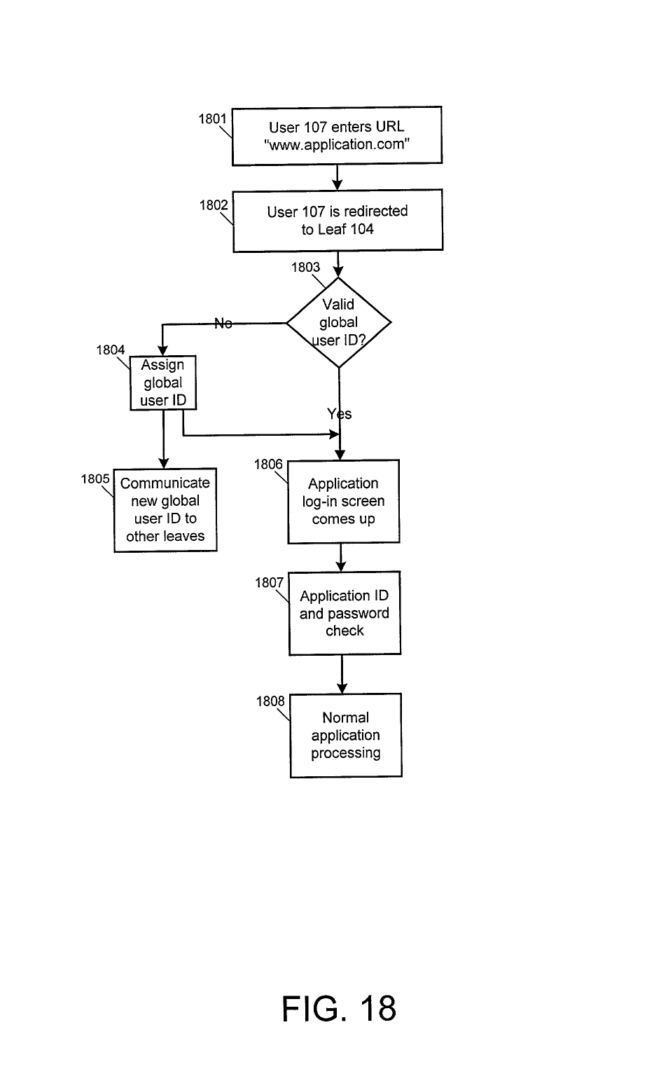

FIG. 18 illustrates an alternative embodiment, in which users log-in to individual applications, but the system has the ability to identify each user across applications.

Steps 1801 and 1802 are the same as steps 1701 and 1702 illustrated in FIG. 17.

In Step 1803, the leaf to which the user has been redirected determines whether the user has a valid global user ID. In one embodiment, this check is done by an app. server, after the initial communication has been routed to the app. server by a load balancer.

In one embodiment, the global user ID may be stored as a “cookie” on the user's computer, which may be accessed and read by an app. server. This embodiment has the advantage that the user is not required to remember or enter the global user ID. This embodiment, however, has the disadvantage that the cookie will not be available if the user logs-in through another computer. This problem can be resolved by prompting for a global user ID if no cookie is found.

In another embodiment, there may be no use of stored ID data on the user's computer, and the user may be prompted to enter a global user ID without any check for stored data.

If no global user ID is returned (“No” path from Step 1803), this indicates that the user has not previously used the system. Processing proceeds to Step 1804, in which the system assigns a global user ID. In one embodiment, this information may be stored on the user's computer as a cookie or in another form. In another embodiment, the global user ID may be disclosed to the user but not stored on the computer.

In one embodiment, the system may use a combination of stored global user IDs and entered global user IDs. In this embodiment, in Step 1803 the system first checks to determine whether a global user ID is stored as a cookie, or in some other form. If a stored global user ID is found, processing continues to Step 1806, which is described below. If a stored global user ID is not found, the user is prompted to either enter a global user ID or indicate that he or she is a new user.

In the case of a new user, processing proceeds to Step 1804, but this step also includes storing the global user ID as a cookie or in some other manner.

In the case of an existing user who enters the global user ID, the system can then ask the user whether the current computer should be treated as the user's “home” computer. If the answer is “no,” then processing continues to Step 1806. If the answer is “yes,” the entered global user ID is stored as a cookie (or in some other manner), and processing continues.

This embodiment allows for the use of cookies or other stored information, while still taking into account the fact that users may log-in from various computers, some of which may be used by other people (e.g., a public kiosk, a hotel room computer, etc.) In such a case, it would be disadvantageous to automatically store the global user ID as a cookie, since this would then be used for the next user, though it would not constitute that user's identifier. This embodiment avoids that problem by not storing the information if the global user ID was entered, unless the user indicates that the current computer should be treated as the “home” computer, in which case it makes sense to store the global user ID.

It should be understood that the global user ID may not serve any significant security purpose. As is described below, users are required to complete the normal application log-in, including an entered password, before they can access any data. Thus, even if storage of the global user ID on a computer results in another user being able to use an improper global user ID, the misidentification will be inconvenient, but will not result in improper access being provided to user data.

Under either of the embodiments described above, in the case of a new user, processing continues to Step 1805, in which the local leaf communicates the new global user ID to other leaves, which use the information to update their copies of the global user table. The user is also allowed to continue with the log-in process (Step 1806).

If the system finds a valid global user ID on the user's system, or if a valid global user ID is entered by the user, (“Yes” path from Step 1803), processing proceeds to Step 1806, in which the application log-in screen comes up on the user's computer. Note that this may be the first screen that the user sees, since all earlier steps may be invisible to the user. Note also that Steps 1803, 1804 and 1805 may happen in parallel with Step 1806, since these steps may not require user involvement (unless the user is required to enter the global user ID).

Step 1806 constitutes a standard application log-in, in which the user is prompted to enter an identifier for the user and a password. That identifier and password are then checked in Step 1807, with normal processing proceeding in Step 1808. (For the sake of clarity, certain processing steps are not shown, including the processing which will occur if an invalid ID or password are entered.)

The application identifier and password checked in Step 1807 will be unique to the particular application. If the user decides to invoke a second application, the user will have to complete the log-in process for that application, including entering the user ID and password expected by that second application.

In the scenario described in FIG. 18, therefore, the user is required to log-in to applications in the normal manner, and the global user ID is not used in that process (indeed, the global user ID may be completely invisible to the user). Each leaf will, however, maintain a list of global user IDs for those users currently logged-in, and will be able to identify when the same user logs-in to a second application. The system may use this information to determine the applications which the user has previously used (e.g., those applications for which the user has data), and the leaves at which the user has data stored. This may be done through a modified version of Global User Table 1601, which would include Global User ID Column 1602, Application Column 1604 and DB Server Column 1605, but would not include the Global Password Column 1603, since, in this embodiment, no global password exists.

User-Centric Model

The embodiments described above are based on a single-application model. A user does not log-in to the system as a whole, but instead logs in to an individual application. Applications are strictly isolated from each other, through the use of the chroot call, tickets and partitions. From the point of view of the users and the applications, the system resembles not a single integrated network supporting multiple applications, but a series of networks, each dedicated to a single application.

The single-application model is designed to promote security. It also resembles the existing ASP models, and may be attractive to ASPs, who may require that their applications and data be entirely isolated from applications and data generated by competitors.

A disadvantage to the single application model concerns data sharing. Modern user applications are generally designed to encourage users to move data between applications. For example, a user may input numerical data in a spreadsheet, export results from the spreadsheet to a word processor for incorporation into a document, then export text from the word processor for use in a graphical presentation application.

The ability to share data among applications is a significant benefit for users. Such data sharing is impossible in the single application model, since applications and data are isolated from each other. In order to move data from one application to another, a user would have to work around the system's limitations, e.g., by copying data from an application to the user's personal computer, then invoking a second application, then copying data from the user's personal computer to that second application. Such processes are cumbersome.

A “user-centric” file system may avoid these disadvantages, particularly if combined with the universal log-in process described above. In one embodiment of a user-centric file system, database partitions are not organized around applications, since such an organization defeats the purpose of a user-organized system. Instead, in one embodiment a user-based system includes database partitions, but each partition is associated with a single user, rather than a single application.

In one embodiment of a user-centric file structure, the overall system file structure is divided into partitions similar to that shown as Partition 401 in FIG. 9. In the user-centric file structure, however, each partition stores data for a particular user, rather than data for a particular application.

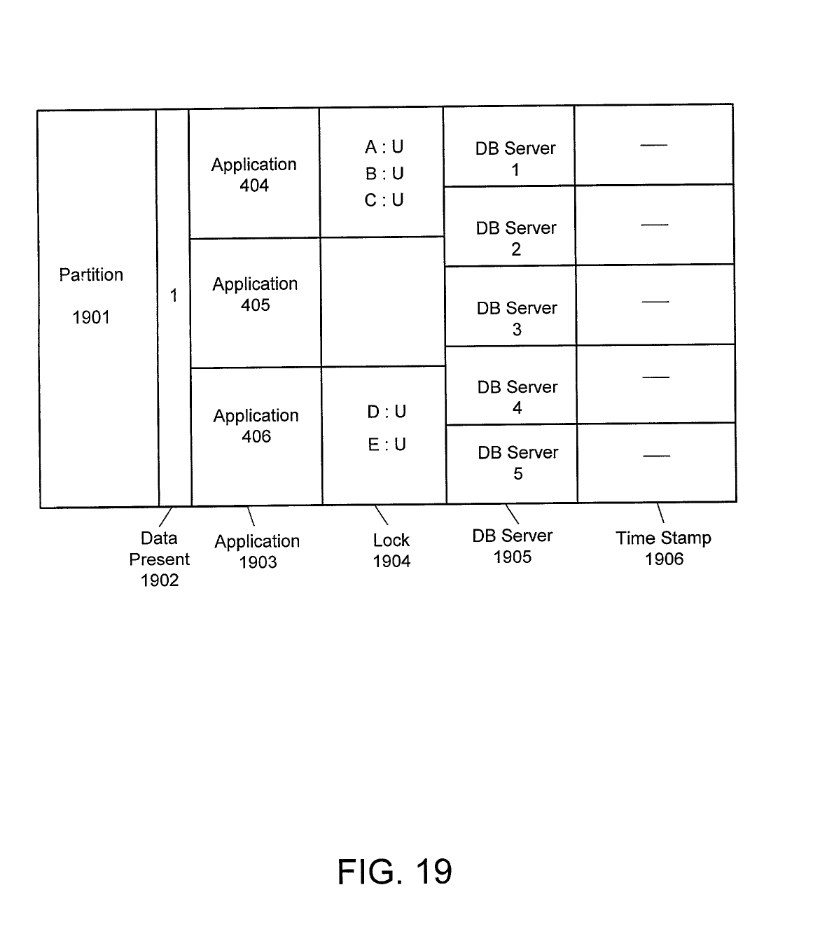

One embodiment of a user-centric partition structure is shown in FIG. 19, which illustrates Partition 1901. This partition is associated with a single user, and is identified by that user's global user ID. Data Present Flag 1902 indicates whether this user's data is present on the local DB server. In one embodiment, each DB server which stores the user's data for any application also stores that data for all applications. In this embodiment, the partition need only include a single data present flag. In a different embodiment, a partition may include data for some but not all applications. In such an embodiment, a separate data present flag would be present for each application.

In addition, as is described above, the data present flag may be omitted in favor of using time stamp information to determine whether a current copy of the user's data is locally present.

Application Column 1903 lists those applications with which the user has entered data.

Lock Column 1904 functions in a manner similar to Lock Column 903. In the user-centric partition structure, however, Lock Column 1904 contains different information for each application. Thus, Application 404 has three different lockable fields: A,. B and C, each of which is unlocked (“U” value). Application 405 has no lockable fields. Application 406 has two lockable fields: D and E, each of which is unlocked.

DB Server Column 1905 and Time Stamp Column 1906 function in the same manner as the corresponding columns in FIG. 9.

The overall file structure illustrated in FIG. 4 would also be somewhat different in a user-centric system. Whereas FIG. 4 shows three partitions, each associated with an application, the user-centric organization would include partitions associated with individual users. User Table Column 407 would not exist in a user-centric system, since it would make no sense to store user table information in partitions each of which is associated with a single user. Instead, in one embodiment a global user table would be used to locate data associated with particular users (see below).

A user-centric system would include locations for the storage of application data, but whereas Application Databases 413 are organized by user, in a user-centric system the data would be organized by application.

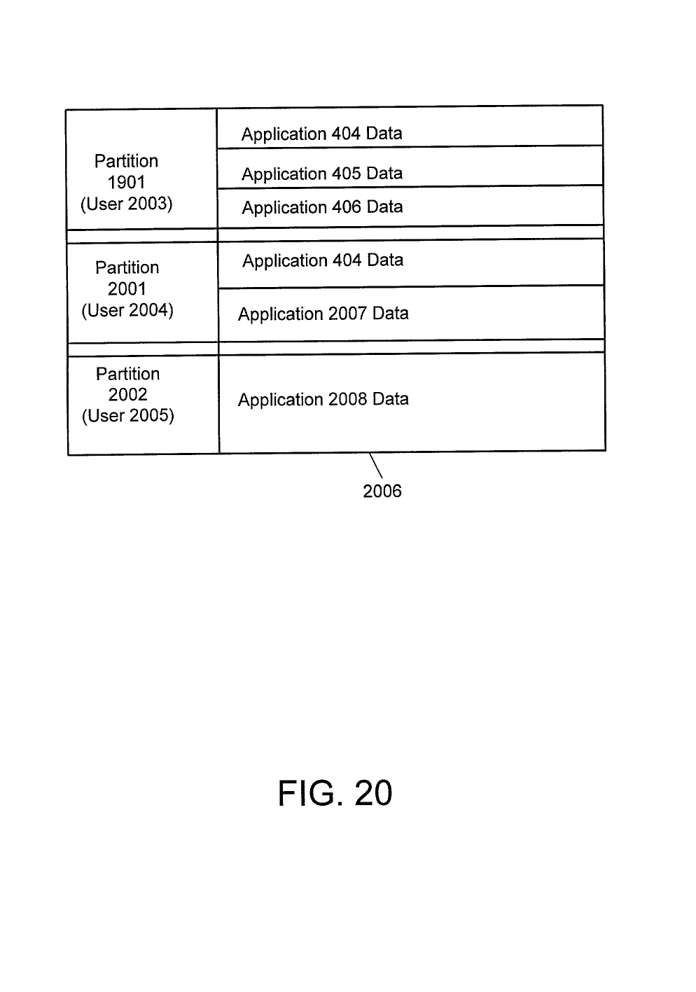

One embodiment of an overall user-centric partition structure is shown in FIG. 20, which shows three partitions: Partition 1901, which is associated with User 2003, Partition 2001, which is associated with User 2004 and Partition 2002, which is associated with User 2005.

Data Area 2006 includes data stored for each application which the user has used to store data. Thus, in Partition 1901, User 2003 has data for Applications 404, 405 and 406; in Partition 2001, User 2004 has data for Applications 404 and 2007, and in Partition 2002, User 2005 has data for Application 2008.

As is described above, the partition structure shown in FIG. 20 does not include user tables. In a different embodiment, each partition could also include a user table such as that shown in FIG. 19.

In the application-centric embodiment described above, applications (including associated data) are strictly segregated through the use of the chroot call, which isolates each application to the partition containing data associated with that application. In a user-centric organization, on the other hand, the chroot call may be used to isolate each user, so that a use may access only the data associated with that user, but the user may use any application to access any of that data, including data not created by that application.

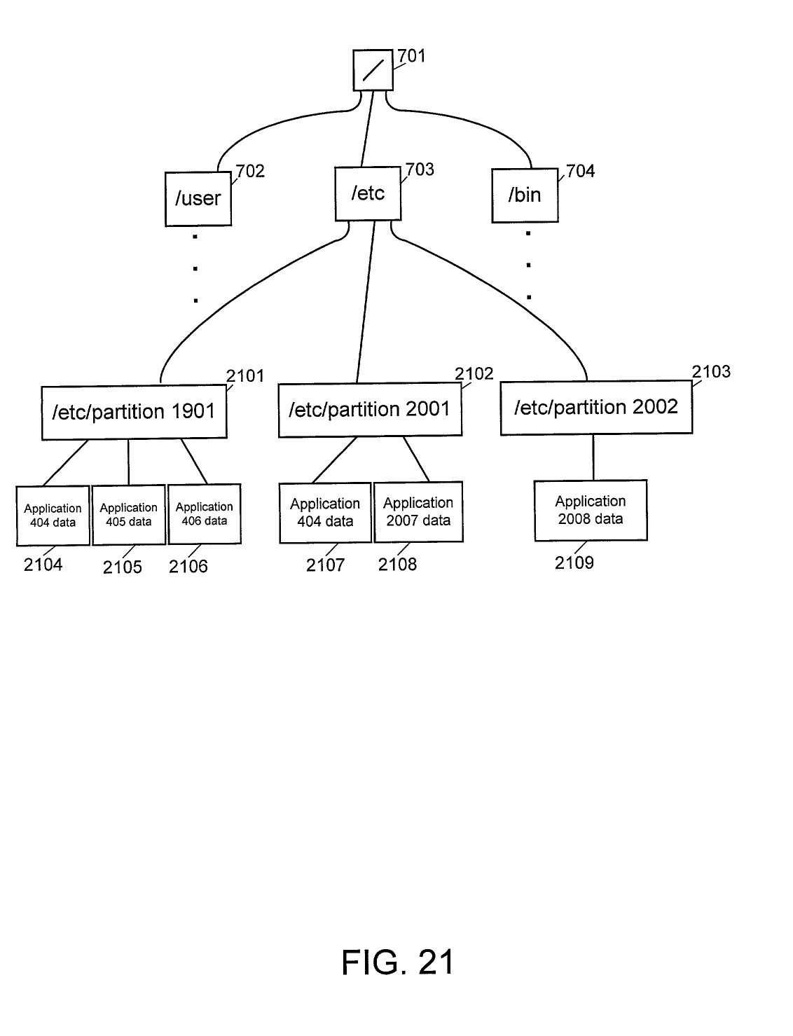

FIG. 21 illustrates a user-oriented directory structure which may be contrasted to the application-oriented structure illustrated in FIG. 7. In FIG. 7, data is organized around applications, with each application being assigned a partition (e.g., Directories 705-707), and user data being stored in subdirectories within each partition (e.g., Directories 708-716), so that all data associated with a particular application is organized in one partition, but data associated with a single user may be spread across multiple partitions (assuming the user has data associated with multiple applications).

The user-centric directory structure shown in FIG. 21 has similarities to the application-centric structure shown in FIG. 7. The top-level directories (Directories 701-704) are the same in both models.

The partitions, however, are different in FIG. 21, since partitions (e.g., Directories 2101-2103) are each associated with a single user, rather than being associated with a single application. FIG. 21 illustrates the same structure as FIG. 20. Thus, Directory 2101 contains Partition 1901, which is associated with User 2003, and holds data for Applications 404-406 (Directories 2104-2106); Directory 2102 contains Partition 2001, which is associated with User 2004, and holds data for Applications 404 and 2007 (Directories 2107-2108); and Directory 2103 contains Partition 2002, which is associated with User 2005 and holds data for Application 2008 (Directory 2109).

In the embodiment described above in connection with FIG. 7, a chroot call is issued when an application is initially invoked. That call changes the root directory for that application to the directory which is dedicated to the application (e.g., changing the root directory to Directory 705).

The chroot call may also be used in connection with the user-oriented directory structure shown in FIG. 21. In this case, however, the call is issued once the user's global user ID is known, and remains in effect throughout the entirety of the user's session, including invocation of multiple applications.

When chroot is used in connection with the user-oriented directory structure shown in FIG. 21, the root directory is changed to the directory associated with the particular global user ID. Thus, if User 2003 has logged-in and entered a global user ID, chroot may change the root directory for that user's processing to Directory 2101.

As is described above, processing which follows the chroot call is required to treat that directory as the root directory for the system, so that only that directory and subdirectories below it are available.

Thus, when chroot is used with the directory structure shown in FIG. 21, applications invoked by the user have the ability to access only the data which is associated with that particular user, so that applications invoked by User 2003 would have the ability to access data in Directories 2104-2106. In theory, a badly-written application, or one subverted by a hacker, could gain access to data generated by other applications, but only insofar as such data is associated with the same user. Data associated with other users would be unavailable, even if that data had been generated by the subverted application.

The model shown in FIG. 21 therefore provides security benefits which are different from those associated with the model shown in FIG. 7. The FIG. 7 model limits an application to data generated by that application, but allows an application to access all such data, including data associated with other users. The FIG. 21 model limits an application to data associated with one user, but allows the application to access all such data, including data generated by other applications.

By allowing an application to access data generated by other applications (as long as the data is associated with a single user), the FIG. 21 model simplifies the task of sharing data among applications. Such data sharing is impossible in the FIG. 7 model, since each application is able to access only those directories associated with that application's data, so that there is no mechanism for an application to export data to another application, or for an application to import data generated by another application.

In the FIG. 21 model, on the other hand, an application may easily share data with another application, since subdirectories containing such data fall within the overall file structure accessible to each application (again noting that such subdirectories are limited to data generated by a single user). A user can, therefore, use one application to open a file created by a second application, through a familiar process of navigating through the directory structure to locate the file generated by the other application. In one example, User 2003 could invoke Application 404, but open a file stored in Directory 2105, even though Directory 2105 is associated with Application 405. This would be possible because Application 404 would recognize the root directory as Directory 2101 (the directory associated with User 2003), thereby allowing Application 404 to access data found in Directories 2104-2106 (assuming, of course, that such data is stored in a format which Application 404 is capable of reading).

This process of using one application to open a data file stored by another application is impossible given the directory structure shown in FIG. 7, since directories containing data from other applications are inaccessible.

In addition, the file structure illustrated in FIG. 21 allows an application to export data directly to a second application. This requires only that the data be formatted in a manner appropriate for the second application and that it be stored in a location accessible to the second application (e.g., the user could cause Application 404 to save a data file in Directory 2105, even though Directory 2105 is associated with Application 405). Again, this is impossible given the FIG. 7 file structure, since it is impossible in that file structure for one application to even access a directory associated with a second application, must less to store data there.

Although the FIG. 21 file structure provides certain advantages to users, it can only be used in cases in which some mechanism exists to identify users across applications (e.g., a global user ID), since such a mechanism is necessary to organize data by user, rather than by application. A system incorporating a global user ID may encounter resistance from users, who may be suspicious of any functionality which tracks users across applications.

Such a system may also encounter resistance from ASP providers. Historically, ASP applications have been designed with an assumption that data will be isolated in a single application, or in a suite of applications which derive from a common source. Vendors may resist a design in which data can be freely moved among applications, since such a design may encourage users to make use of applications which compete with those of the vendor (e.g., it would be easier for a user to share data between a calendar program from one company and an address book application from another company).

Once the difference in overall structure is understood, the user-centric embodiment operates in a manner similar to the application-centric embodiment described above. As is described above, access to data stored on a DB server requires the use of a ticket, which may be generated randomly, and an application may only access that partition which matches the ticket held by the application. Because in the user-centric model each partition is associated with a user, however, rather than with an application, the ticket possessed by an application will enable that application to access any data generated by that user in any application. A user will therefore have the ability to cause an application to open up a file generated by a different application, or to share data between applications.

The methods described in FIGS. 17 and 18 are designed to allow the system to identify each unique user, including identifying users across applications. Once the system has this ability, certain additional functions become possible.

In one embodiment, the ability to identify users across applications allows the system to download a user's data from all applications, whenever a user logs-on from a new leaf. In this embodiment, latency may be significantly reduced when the user invokes a second application from a new leaf.

One embodiment of this functionality is based on the method shown in FIG. 17. As is noted above, FIG. 17 illustrates an embodiment in which the user enters a single global user ID and a single global password, and those serve to log the user in to all applications.

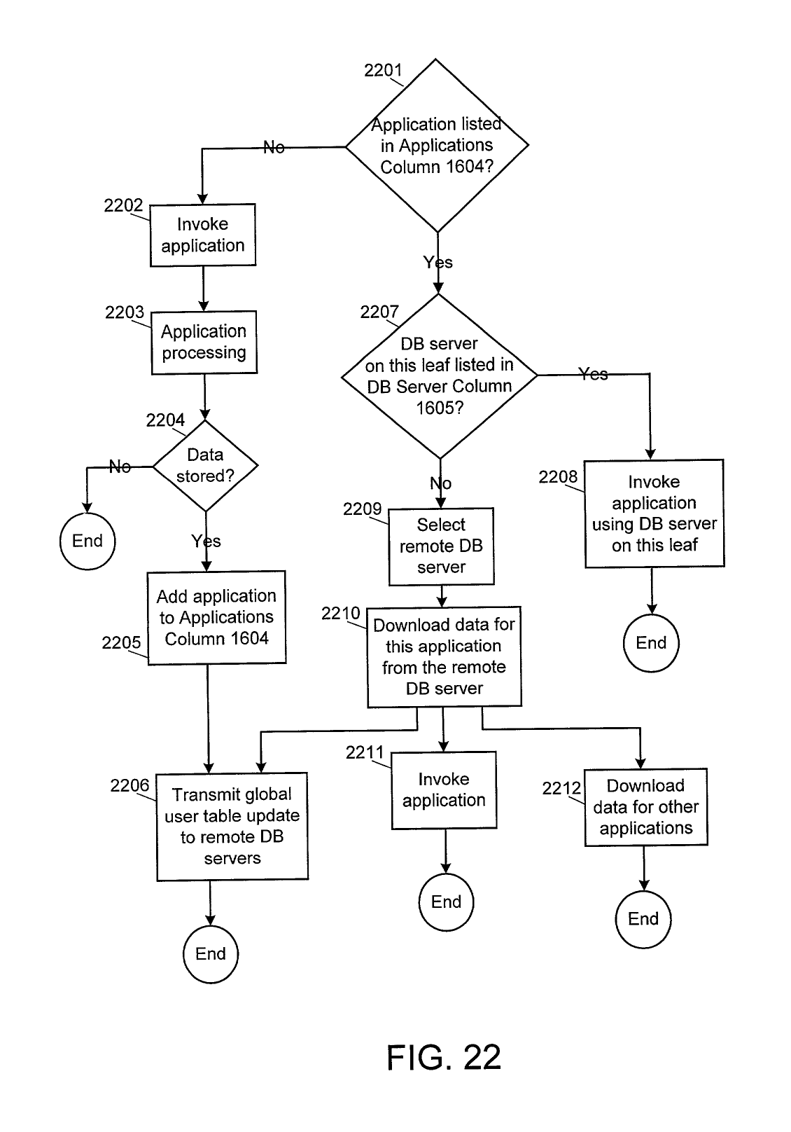

In this embodiment, which is illustrated in the flowchart included in FIG. 22, assuming that the user's data is not present on the leaf the user initially logged-in to, FIG. 17, Step 1713 would lead to FIG. 22, Step 2201. In this step, App. Server 508 checks Application Column 1604 from Global User Table 1601, to determine whether the user has data stored on the system from a previous use of this particular application (note that the application identity is derived from the initial URL entered by the user, or by another suitable mechanism, as is described above).

If the user has no data associated with this application, (“No” path out of Step 2201), App. Server 508 invokes the application (Step 2202). Application processing then proceeds normally (Step 2203) until and unless the user stores data associated with the application on a DB server (Step 2204). If the user does not store any data associated with the application (“No” path out of Step 2204), processing ends with no user table updates required.

If the user stores data (“Yes” path out of Step 2204), App. Server 508 adds the application to the applications listed for this user in Applications Column 1604 of the global user table (Step 2205).

App. Server 508 then causes the update to the global user table to be transmitted to all other leaves (Step 2206). This may be a relatively low priority transmission, and may occur at a low-traffic time, possibly after the user has logged off.

If the user has previously entered data for this application (“Yes” path out of Step 2201), App. Server 508 checks to see if the data are stored on one of the DB servers of the local leaf, by checking DB Server Column 1605. (Step 2207).

If the data are stored locally (“Yes” path out of Step 2207), App. Server 508 invokes the application, using the appropriate local DB server (Step 2208).

If the data are not stored locally (“No” path out of Step 2207), one of the remote DB servers is selected from DB Server Column 1605 as a transmission point for the data (Step 2209). As is described above, the remote DB server may be selected based on proximity, current traffic, random selection, or in any other suitable manner.

Once the remote DB server has been selected, data for the current application are downloaded from the remote server (Step 2210). The application is then invoked, with processing proceeding normally (Step 2211).

In parallel with the invocation of the selected application, the remote DB server may also download data for any other applications listed for this user in Application Column 1604 (Step 2212). Although downloading of the data for the originally chosen application may take precedence, since delays in availability of this application's data translate directly into user-visible latency, the downloading of data for other applications may also proceed at a relatively high priority, since the user may choose to invoke one of those applications at any time.

In one embodiment, the other applications for which data will be downloaded are identified by the remote DB server, which derives this information from Applications Column 1604.

At some point, a global user table update must be transmitted to all other leaves, to inform other leaves that the local DB server must be added to the entries in the DB Server Column 1605 entry associated with this user (Step 2206). This update may constitute a relatively low priority transmission, which may occur after the download of data for other applications (Step 2212).

The process outlined in FIG. 22 minimizes latency involved when a user logs on to a new site, and invokes more than one application. In such a case, the user's data may already be present when the user invokes the second application, thereby avoiding the delay which would otherwise occur as the data from the second application is downloaded.

As should be understood, if an application accesses data from another application (e.g., Application 404 accessing data from Directory 2105) or stores data into a database associated with another application (e.g., Application 404 storing data in Directory 2105), if updated data have not already been received for the other directory (e.g., Directory 2105 data has not yet been received from a remote DB server), processing must be paused while the data are received. This process may be speeded-up in various ways, including identifying the attempt to access the other directory, and causing that to trigger a high-priority download of data from that directory.

FIG. 22 describes processing as if the model illustrated in FIG. 17 had been used, including both a global user ID and a global password. In a different embodiment, the model illustrated in FIG. 18 might be used. This alternate model includes a global user ID, but no global password, and requires the user to log on individually to each application. That alternate embodiment could use the same flowchart as that illustrated in FIG. 22, with the understanding that the user would have to individually log-on to all applications. Downloading of data does not require a log-on to the application. Thus, the system could begin downloading data for all applications while the user was still using the first application, before the user had logged-on to any of the others.

Enterprise Model

The architecture described above, particularly in connection with FIG. 1, assumes that users are individuals with no pre-existing relationships, who are making individualized decisions to log-in to particular applications.

In another embodiment, the described network can be used in an “enterprise model,” in which it can be used as the basis for an enterprise-wide network structure. Such an embodiment may be particularly suited for enterprises which have multiple locations, particularly if employees may travel from one location to another, and if employees require access to data and applications at multiple enterprise locations.

In one embodiment, an enterprise might simply “rent” space on the network described in connection with FIG. 1. In such an embodiment, an enterprise could be provided with its own partitions, in a file structure similar to that illustrated in FIG. 21, except that the partitions (e.g., Directories 2101, 2102 and 2103) would be assigned to enterprises, rather than to individuals.

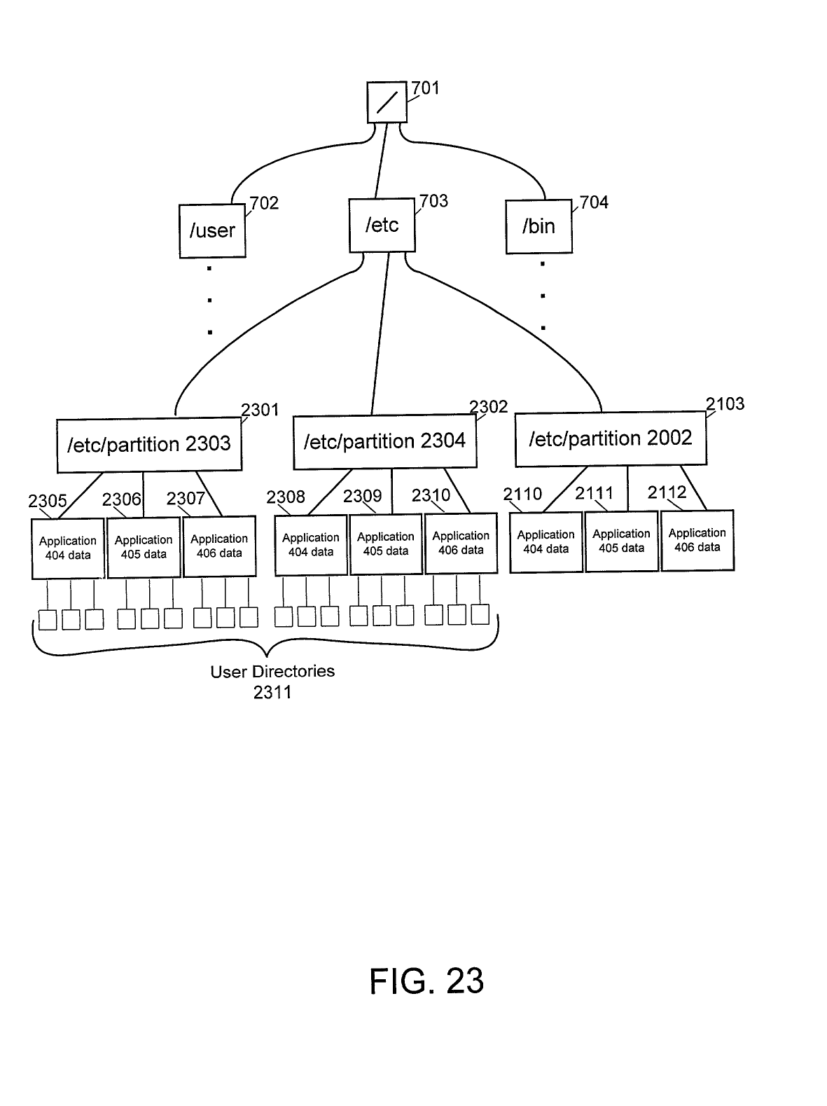

Such an alternative file structure is illustrated in FIG. 23. FIG. 23 incorporates some of the same elements as FIGS. 7 and/or 21 (e.g., Directories 701-7104, 2103 and 2109).

FIG. 23 differs from FIGS. 7 and 21 in the organization and purpose of Directories 2301 and 2302. Whereas in FIG. 7 Directories 705-707 were assigned to applications, and in FIG. 21 Directories 2101-2103 were assigned to individual users, in FIG. 23 Directories 2301 and 2302 are assigned to enterprises, each of which has its own partition (e.g., Partitions 2303 and 2304).

The directory structures below Directories 2301 and 2302 resembles that of FIG. 7, in that there is a layer of subdirectories devoted to application data (Directories 2305-2310), and, below that, subdirectories containing user data (User Directories 2311). In an alternative embodiment, the organization of subdirectories under Directories 2301 and 2302 could more closely resemble the organization shown in FIG. 21, with a layer of user subdirectories further divided into subdirectories for application data. In either case, FIG. 23 inserts a new layer of directories devoted to enterprises.

FIG. 23 also includes Directory 2103, which contains Directory 2109. These represent the same directories as in FIG. 21, so that Directory 2103 contains data for an individual user (e.g., Partition 2002) while Directory 2109 contains data for that user for Application 2008.

As should be understood, the overall file structure contained in FIG. 23 may contain partitions devoted to enterprises (e.g., Directories 2301 and 2302) as well as partitions devoted to users (e.g., Directory 2103). In a different embodiment, partitions devoted to enterprises could be combined with partitions devoted to particular applications (e.g., Directory 707 from FIG. 7).

In the embodiment shown in FIG. 23, the chroot call would be used to isolate a particular user, but the level of isolation would depend on whether the user is associated with an enterprise, with such association possibly being determined based on the global user ID assigned to the user. The chroot call would be used to isolate an enterprise user within a partition associated with that enterprise (e.g., Directory 2301), whereas a user not associated with an enterprise would be isolated within a partition unique to that user (e.g., Directory 2103).

As should be understood, if the chroot call is used to isolate an enterprise-specific partition using the directory structure illustrated in FIG. 23, an application would have access to all of the data for that enterprise's users, including data generated by other applications. (Again, it should be understood that this assumes that the application allows such access, that the application can read data generated by other applications, and that some other mechanism is not used to block such access, such as password protection for certain directories.) Such a file structure could be used in combination with the user-centric file structure described above. In such an embodiment, the global ID assigned to a user could include information regarding the enterprise, if any, to which the user belongs. Users belonging to no enterprise would have their own individual partition, and the chroot call would be used to isolate those users to that partition. Users belonging to an enterprise, on the other hand, would be provided access (through the chroot call) to the partition assigned to the enterprise. In this manner, the same architecture could be used to support individuals and enterprises.

In one embodiment, chroot could be used to isolate particular enterprise users, each within their own directory, whereas an enterprise network administrator could have access to the entire directory associated with the enterprise.

The ability to assign partitions to groups rather than to individuals or applications can be used for any type of group, including ad hoc groups. Thus, a group of consultants working together on a project could be assigned a partition allowing them to share data. The system could bill for that assignment on a periodic basis (e.g., once a month), with the partition being “deassigned” once the project is finished.

The enterprise embodiment described above relies upon assignment of partitions to an enterprise, and does not require any other changes to the user-centric version of the network described above. In another embodiment, a network may be set up within an enterprise, so that the leaves are controlled entirely by the enterprise. In one embodiment, each enterprise location might include one or more leaves.

Such an embodiment could use the Internet for location-to-location communications, in which event the network structure would resemble that illustrated in FIG. 1, except that users would communicate with leaves located at enterprise locations rather than leaves located at ISPs. As should be understood, communications between leaves in such an embodiment could be protected by the VLAN techniques described above.

In an enterprise embodiment, the enterprise's employees could gain access to data from within enterprise locations. In addition, employees could gain access from any location, including hotels, etc. This would be possible since the enterprise would be part of the overall network, though with its own partition, so that a user logging on from a new location would have data downloaded to a leaf near that location.

In one embodiment of a network including enterprises, each enterprise could be assigned one or more leaves. Those leaves could be located within each enterprise, e.g., in network servers located at the enterprise's locations. Each enterprise's users could log-in to the leaf present at the enterprise location at which the user is located, except for users temporarily or permanently located outside such locations. Such users could log in to normal network leaves.

Such an embodiment could closely resemble FIG. 1, with the exception that certain leaves would be located at enterprises. For example, Leaves 113 and 114 could be located at two different locations belonging to a first enterprise, and Leaves 115 and 116 could be located at a single location belonging to a second enterprise. Those enterprise-specific leaves would differ from normal network leaves in that they would only handle data for users associated with the enterprise. This could be enforced through the redirection process described above (e.g., FIG. 12, Step 1202 and accompanying discussion), which could base the redirection at least in part on the user ID, such that only those users associated with an enterprise would ever be directed to that enterprise. In addition, the redirection process could mandate that users logging-in from an enterprise location (this can be derived from the address associated with the log-in attempt) would be routed to a leaf within that location. Enterprise users logging-in from outside an enterprise location could be routed in the normal manner. In an alternative embodiment, enterprise users logging-in from outside an enterprise location could be routed only to enterprise leaves, thereby insuring that enterprise data is never stored at a leaf outside the enterprise's control.

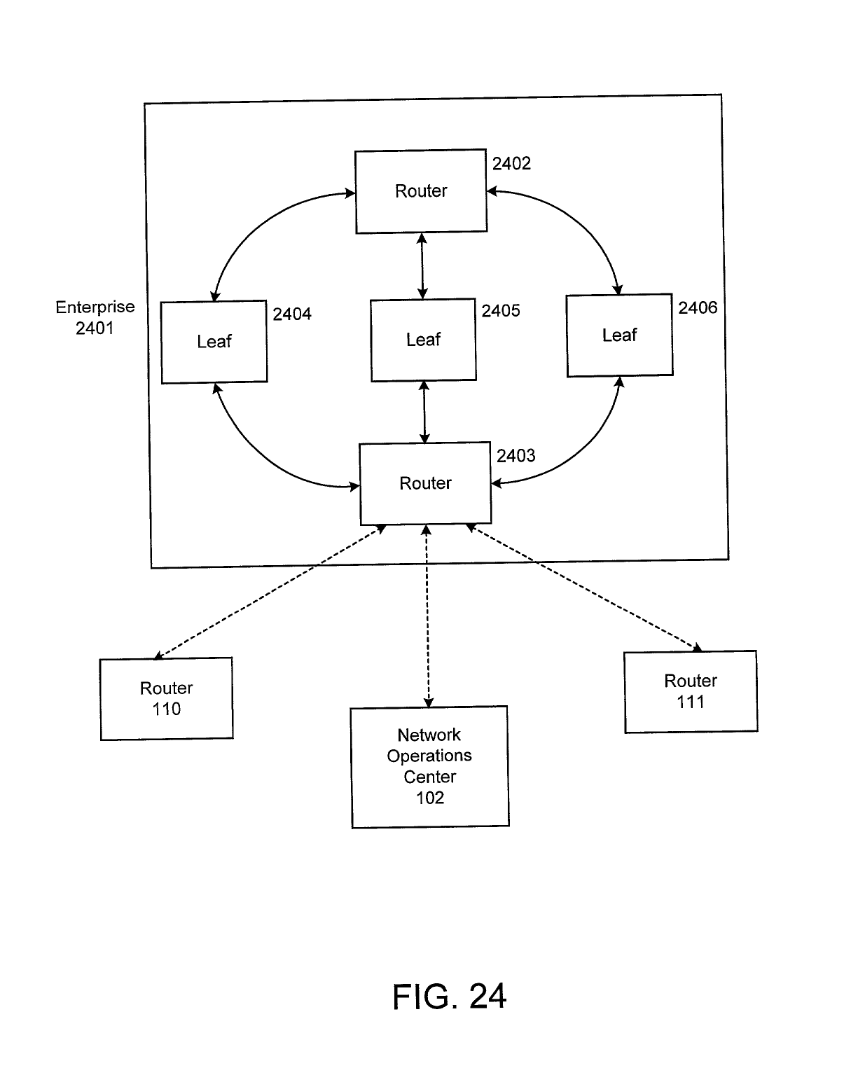

In a second embodiment, an enterprise could include both leaves and dedicated routers. Such an embodiment might include a topology such as that illustrated in FIG. 24. FIG. 24 builds on FIG. 1, and shows NOC 102 and Routers 110 and 111 from that Figure. All of the other elements in FIG. 1 may also be present, but are not shown for the sake of clarity.

FIG. 24 includes Enterprise 2401. As should be understood, Enterprise 2401 may include one site or multiple sites. Within Enterprise 2401 are Routers 2402 and 2403. Each of these routers may function in the same manner as the routers described above in connection with FIG. 1, except that internal communications within Enterprise 2401 do not take place over VPN 117, but take place over the enterprise's internal network (which can be of any type, including a VPN.) As illustrated, Router 2403 communicates with NOC 102, and with Routers 110 and 111 over VPN 117 (shown as dashed lines), but Router 2402 has no direct communications path with any nodes outside the enterprise. Thus, Enterprise 2401 has only a single gateway onto VPN 117. This may serve to isolate Enterprise 2401's internal communications and therefore increase security for those communications. Thus, assuming that Enterprise 2401's network has adequate security, it may be unnecessary to encrypt communications within Enterprise 2401 (e.g., data downloads from Leaf 2404 to Leaf 2405).

Leaves 2404, 2405 and 2406 may serve the same functions as the leaves shown in FIG. 1. In one embodiment, Leaves 2404-06 may support applications which are specific to Enterprise 2401 and are not supported on any of the other leaves within the network. In one embodiment, Leaves 2404-06 may store data from only those users associated with Enterprise 2401.

The embodiment illustrated in FIG. 24 supports downloads of data between leaves within Enterprise 2401 and leaves outside Enterprise 2401. For example, data could be downloaded from Leaf 2401 to Leaf 113 by being routed through Routers 2403 and 110. Such downloads could support enterprise users who are temporarily or permanently located outside of enterprise locations (or an enterprise location which does not have a dedicated leaf). Data downloads could also travel in the other direction (e.g., Leaf 113 to Leaf 2404), though, as is noted above, leaves located at Enterprise 2401 may only support data for that enterprise's users.

In yet another network topology, an enterprise may have its own complete network, with no connections to external leaves or routers. This embodiment could resemble the topology shown in FIG. 24, but with no connections between Router 2403 and Routers 110 and 111. In this embodiment, nodes located in Enterprise 2401 may communicate with NOC 102 (through Router 2403), but may not communicate with any other non-enterprise node. This embodiment may tend to further isolate nodes within Enterprise 2401, and therefore increase security, particularly because, in one embodiment communications with NOC 102 are limited to administrative and maintenance communications, and do not include data downloads. As should be understood, however, this embodiment may limit the usefulness of the network for enterprise users who are logging-in from a location outside the network, since such users would not be able to log-in to non-enterprise nodes, but would have to be routed to the nearest enterprise leaf.

In the case of a network located entirely within an enterprise (i.e., a network with no communications to outside nodes except possible communications to NOC 102), it may be unnecessary to use partitions, since the only users would be those logging-in through the enterprise's computers. The enterprise could, of course, decide to implement its own internal security protocols, including data isolation, but such security measures would be at the discretion of the enterprise, and would not be mandated by the overall network structure.

Usage Data

Under either the application-centric model or the user-centric model, NOC 102 may play a crucial role in aggregating usage data and generating information for ASPs. Usage data may be critically important for ASPs, and providing such information may be an important factor in the success of a network such as that described above.

Each individual leaf may monitor and record various types of usage data, both aggregate and relating to individual users. It should be understood that recording data regarding individual users may create significant privacy concerns, and that there may be a need for some mechanism to address such concerns (e.g., privacy policies regarding the manner in which the information is used, “opt-in” provisions with incentives for those users allowing their data to be recorded, etc.)

Each leaf may record overall usage information, which may be valuable for the system. For example, each time a leaf identifies a new log-in (e.g., a “New Log-In” outcome from Step 1212 of FIG. 12), the leaf may record this information. The leaf may report aggregate log-in information to NOC 102 at regular intervals. Such information may help system administrators balance the overall load among leaves. A leaf which is receiving a disproportionate number of log-ins may be disfavored in terms of selecting the leaf for downloads of data (e.g., Step 1301 of FIG. 13). In one embodiment, this could be handled through a new column in User Table 410 or Global User Table 1601. That new column could contain a value on a scale showing the relative usage of each leaf. For example, the column could contain a value from 1 to 5, with 1 indicating low usage and 5 indicating high usage. NOC 102 could review log-in information from each leaf on a regular basis (e.g., once a day), and assign values from 1 to 5 to each leaf, with those values then being transmitted from NOC 102 to each leaf, for use in updating all user tables.

In Step 1301 of FIG. 13, the selection of the remote leaf could be made based partially or solely on the information in the usage column, with lower-scoring leaves given priority over higher-scoring leaves. This would tend to drive update traffic towards those leaves with fewer log-ins. Such leaves will generally be better able to handle such traffic.

System administrators could also use log-in information to determine whether new routers and leaves are necessary, and where such nodes should be located. If a leaf regularly posts high usage numbers, administrators might consider placing a new leaf relatively close to that leaf, so that some of the log-in traffic travelling to the busy leaf would instead travel to the new leaf. Administrators might also use this information in deciding whether new capacity should be added at an existing leaf.

If administrators were to decide to insert a new leaf, that leaf could be placed so that a significant percentage of the traffic flowing to the existing, high-traffic leaf would instead flow to the new leaf. In addition, the new leaf could be created as a replica of the high-traffic leaf, with all of the same data, on the theory that some percentage of the users of the existing leaf would instead be routed to the new leaf, so that including all of the existing leaf's data would reduce latency for those users, at least for the initial log-in. As should be understood, over time the data present at the two leaves would diverge. It should also be understood that, if the system imposes a maximum number of leaves at which a user's data can be stored, creation of a new leaf which replicates the data on an existing leaf would force deletion of data at some number of leaves.

Other information would also be useful in determining traffic patterns, including information regarding the percentage of capacity in use for each DB server and each app. server. Each leaf could record this information and provide it to NOC 102 on a regular basis. Such information could be used as part of a user table usage column, as is described above, and/or as part of a process of determining where to locate new leaves or routers.

The overall network could also keep track of the number of log-ins to particular applications. As is described above, the system is aware of the application the user wants to use, since such information is used to provide an application log-in screen to the user (e.g., FIG. 12, Steps 1201 and 1205 and accompanying discussion).

The identify of the selected application could be recorded at the time of the user's initial selection (e.g., Step 1201), at the time the application log-in screen is provided (e.g., Step 1205), at the time the leaf determines that the user ID is present in the user table (e.g., FIG. 12, Step 1213), or any other suitable time.

Information regarding the number of log-ins to a particular application can be used to generate billing information. For example, an ASP can be billed based on the number of log-ins which occur to that ASP's applications. If information is used for this purpose, it would make most sense to record that information as late in the process as is possible. Thus, such information may be generated after Step 1213, when it is clear that the user's ID is present in the user table. By this point in the process, it is at least likely that the user log-in will be successful.

The system may obtain more precise information regarding user log-ins by monitoring application-database transactions and identifying those communications which indicate that a successful log-in has been achieved (e.g., at FIG. 12, Step 1215). Note that this may require an understanding of the protocols used by the individual applications, so it may be simpler to use the presence of the user ID in the user table as a proxy for successful log-in information.

The system may record not only the aggregate number of log-ins for each application, but also the time of each log-in. Such information could be used to support a tiered billing system, in which ASPs are billed more for log-ins which occur during peak times. ASPs could use such information to provide tiered billing to their users, thereby encouraging users to shift usage to non-peak hours.

System administrators could also use log-in time information to determine usage patterns so as to identify whether peak usage of particular applications puts pressure on the overall system. Usage of certain types of consumer-oriented applications may, for example, peak during lunch hour and during the evening, with relatively low usage during other parts of the day.

Once system administrators have access to this type of information, they can “tune” the system so that it can more adequately support applications which have high peak usage. For example, if the system only supports storing a user's data at a certain number of sites, that number can be increased for those applications which have high peak usage, thus making it more likely that it will be possible to spread usage requests for that application across a larger number of leaves, thereby avoiding bottlenecks. This could be done by increasing the valid number of sites in DB Server Column 904 or 1605. This increase could be used only for user tables in those partitions which are associated with high peak usage applications.

The overall system may also record and use more detailed usage data. For example, DB administrative modules may include the capability of identifying application-database communications which reflect a successful user log-in. The nature of such communications will depend at least in part on the specific application, but will generally result in the user being provided with an application screen, and being given access to data previously entered by that user.

If the DB administrative modules are capable of identifying a successful log-in, the overall system may keep track of the percentage of attempted log-ins which result in a successful outcome as opposed to those that result in failure. This information could be derived by comparing the number of queries which constitute new log-ins (“New Log-In” path out of Step 1212 from FIG. 12) to the number of log-ins which complete successfully. This information may be valuable to system administrators, since a high level of unsuccessful log-in attempts may reflect user problems with the system interface, necessitating changes to the opening screens, for example.

This information may also be tracked on an application-by-application basis, and reported to ASPs. System administrators could, for example, provide regular reports to each ASP, including the percentage of the ASP's log-in attempts which ended in success, and a comparison of that percentage to aggregate figures for all applications, and for applications in the same category as that ASP's application. Such information may be extremely valuable to an ASP, particularly if it shows that attempts to log-in to the ASP's application are unsuccessful a higher percentage of the time than attempts to log-in to competitors'applications. This may lead the ASP to redesign its procedures to eliminate problems which are frustrating users.

DB administrative modules could also be designed to keep track of the number and type of application-database interactions, and report this to ASPs on a per-user and aggregate basis. Such information could be generated as part of the process of evaluating queries to the database (Step 1210 from FIG. 12). The transactions recorded could be based on generic types (e.g., every application-database interaction which results in data being stored) or an specific transactions identified by an ASP as being of interest. Such information could be transmitted to NOC 102 on a regular basis, and provided to ASPs at different levels of granularity. ASPs could be provided reports, for example, showing the number of identified transactions engaged in on a user-by-user basis or on an aggregate basis, and could also be informed how these numbers compare to those generated by the ASP's competitors. Again, such information could be extremely valuable in allowing an ASP to redesign its product so as to encourage a high level of usage.

The overall system may also be designed to keep track of information regarding the length of time spent by users on applications. The gathering of such information would require that the system have some mechanism for determining when a user has logged-off of an application. In general, the system will have to have some means of deriving this information, since the app. server on which the application is running will have to shut the application down when the user logs-off. (As should be understood, however, certain types of applications treat each user interaction as a new session, with the session terminating once the interaction is complete. Such applications do not require any mechanism for determining when the user session has ended.)

Shutting-down of an application may be triggered by the user taking an action indicating that the session is over (e.g., selecting an “exit” option from a menu). In such a case, the application will terminate.

In some cases, however, a user will exit without formally logging-off of the application (e.g., the user terminates the communications link to the leaf, turns off the computer, etc.) In such cases, the system will have to identify the fact that the user has ceased interacting with the application, and shut the application down. For example, app. servers may monitor the time since the last user interaction with the application, and send an inquiry screen to the user if a certain time has passed, with the application being shut down if the user does not respond.

App. servers may keep track of how long each user session lasts by recording the time elapsed between initial invocation of the application (FIG. 12, Step 1205) and termination of the user session. Such information may be transmitted on a regular basis to NOC 102, and may then be reported to ASPs, both on a per-user and an aggregate basis. The information may be helpful to the ASP in determining improvements to the applications, particularly if aggregate information is also reported regarding other applications. Such information may be combined with information regarding the number of transactions in a user session, thereby allowing the ASP to correlate the number of transactions with the amount of time spent in the session. This may help the ASP determine whether bottlenecks exist which are slowing-down users.

What is claimed is:

1. A network for the distributed storage of data, including:
a network operations center;
a router operatively connected to the network operations center;
a first leaf and a second leaf, each operatively connected to the router, each leaf including:
an applications server including a memory storing an application;
a database server including data for two users;
means for users to enter data to be stored at the database server;
means for data entered at a database server entered at one leaf to be downloaded to the other leaf;
means for at least partially isolating data so that data entered by one user may not be accessed by another user or data entered using one application may not be accessed by another application; and
a user table including information relating to locations at which user data is stored.

2. A method for coordinating user data in a network for the distributed storage of data, including:
at a first database server located at a first leaf, identifying user data to be communicated to a second database server located at a second leaf;
at the first leaf, associating a first header with the data, the first header including information at least in part identifying the second database server;
at the first leaf, associating a second header with the data, the second header including information at least in part identifying a first router;
at the first leaf, encrypting the first header and the data using a first key;
at the first leaf, associating a third header with the data, the third header containing information at least in part identifying the first key;
transmitting the data, the encrypted first header, the second header, the third header and the encrypted data from the first leaf to the first router;
at the first router, using the third header to locate the first key;
at the first router, using the first key to decrypt the first header;
at the first router, using the decrypted first header in a process of identifying the second leaf;
at the first router, associating a fourth header with the data, the fourth header including information at least in part identifying the second leaf;
at the first router, encrypting the first header and the data using a second key;
at the first router, associating a fifth header with the data, the fifth header containing information at least in part identifying the second key;
transmitting the data, the encrypted first header, the fourth header, the fifth header and the encrypted data from the first router to the second leaf;
at the second leaf, using the fifth header to locate the second key;
at the second leaf, using the second key to decrypt the first header;
at the second leaf, using the decrypted first header to identify the second database server as the intended recipient of the data;
at the second leaf, using the second key to decrypt the data;
at the second leaf, storing the decrypted data at the second database server.

3. A distributed database for storage of user-generated data, including the following:
(1) a first partition, a first portion of which is stored at a first site and a second portion of which is stored at a second site, the first portion and the second portion containing at least some overlapping data, the first partition storing:
(a) a first application database containing first application data entered by multiple users,
(b) a first user table identifying users whose data is stored in the first application database, including identifying each site at which each user's data is stored and including time stamps indicating the most recent revision to each user's data;
(2) a second partition, a first portion of which is stored at the first site and a second portion of which is stored at the second site, the first portion and the second portion containing at least some overlapping data, the second partition storing:
(a) a second application database containing second application data entered by multiple users,
(b) a second user table identifying users whose data is stored in the second application database, including identifying each site at which each user's data is stored and including time stamps indicating the most recent revision to each user's data;
(3) means for isolating the first database and the second database such that the first database is not accessible to users of the second application and the second database is not accessible to users of the first application; and
(4) means for synchronizing data among sites such that data entered by a first user in the first database will be copied to other sites identified in the first user table as containing data for the first user.

4. A network node for the distributed storage of user data, including:
a switch controlling a first VLAN and a second VLAN,
a load balancer for distributing user requests among application servers;
a first application server including a first virtual host, the first virtual host including a first application, a first stub program used for initiating communications with a database server and a first ticket used for securing communications with a database server;
a second application server including a second virtual host, the second virtual host including a second application, a second stub program used for initiating communications with a database server and a second ticket used for securing communications with a database server;
a first database server including a first partition storing data associated with the first application, a second partition storing data associated with a second application, a communications manager for managing communications with other database servers and a time stamp counter for associating time stamp information with communications; and
a second database server including the first partition storing data associated with the first application, a third partition storing data associated with a third application, a communications manager for managing communications with other database servers and a time stamp counter for associating time stamp information with communications.

5. A method of providing users access to data and applications stored at remote locations, including the following:
the user selecting an application;
the user being directed to a first site which stores the user's data for that application, the first site being located remotely from the user's site;
the user's selection being communicated to an application server which contains a copy of the application;
the application server invoking the application;
the user logging-in to the application, including entering identification information;
the application generating a log-in query based at least in part on the identification information;
the application routing the log-in query to a database;
an administrative module intercepting the query;
the administrative module determining that the query constitutes an initial log-in and therefore requires intervention;
as a result of the determination, the administrative module delaying transmission of the query to the database while the administrative module uses the identification information to query a user table in order to determine whether the user's data is located at the first site;
if the administrative module determines that the user's data is located at the first site, the administrative module releasing the log-in query to the database and the database returning information to the application that the log-in attempt is authorized;
if the administrative module determines that the user's data is not located at the first site, the administrative module using the user table to locate a second site which contains the user's data, the administrative module then initiating a communication with the second site, the communication causing the second site to download a copy of the user's data to the first site;
once the user's data has downloaded to the first site, the administrative module releasing the log-in query to the database and the database returning information to the application that the log-in attempt is authorized.

6. A method of synchronizing user data among nodes of a network containing a distributed database of user data, including the following:
a user using an application to enter data;
the data being stored at a first network node;
at the first network node, an administrative module detecting the data entry;
at the first network node, the administrative module updating a user table with a time stamp associated with the data change;
in a first set of communications, the first network node communicating the time stamp to a set of nodes identified in the user table as storing application data entered by the user;
each of the nodes in the set of nodes receiving the time stamp communication and using the communication to update user table time stamp information associated with the user;
in a second set of communications, occurring after the first set of communications, the first node communicating the updated user data to each of the nodes in the set of nodes;
each of the nodes in the set of nodes receiving the updated user data and using the updated user data to replace at least a portion of the user's data at each of the nodes.

7. A method of updating user data in a distributed database including the following:
at a first site, identifying a user request to change data in an application database field from a first value to a second value;
at the first site, determining that the first field is a synchronization field;
at the first site, determining whether the first field is locked;
if the first field is not locked, locking the first field at the first site;
at the first site, using a user table to identify other sites which also contain a copy of the database field;
sending a communication to the identified sites containing information regarding the first value of the database field;
at each of the identified sites, determining whether the current value of the database field matches the first value;
at each of the identified sites, initiating an error handling routine if the values do not match;
at each of the identified sites, if the values match, determining whether the database field is locked;
each identified sites at which the database field is locked returning an indication that the field was locked to the first site;
each identified site at which the database field is not locked locking the field and returning an indication that the field was not locked to the first site;
at the first site, determining whether more than half of the identified sites have returned an indication that the field was not locked;
if the determination indicates that more than half of the identified sites have returned an indication that the field was not locked, at the first site, changing the database field from the first value to the second value at the first site, unlocking the database field at the first site and sending a communication from the first site to each of the identified sites instructing them to store information reflecting the change in the database field at the first site;
if the determination indicates that more than half of the identified sites have not returned an indication that the field was not locked, the first site unlocking the database field and returning an error message to the application.
